(19) United States
(12) Patent Application Publication
(10) Pub. No.: US 2013/0330084 A1
(43) Pub. Date: Dec. 12, 2013

(54) Systems and Methods for Remotely Controlling Electronic Devices

(71) Applicant: O2Micro Inc., Santa Clara, CA (US)

(72) Inventors: Sterling DU, Shanghai (CN); Qiang Guan, Shanghai (CN); Weitai Yang, Shanghai (CN); Xiliang Luo, Shanghai (CN); Shusheng Ma, Shanghai (CN); Yating Li, Wuhan (CN); Yang Wang, Wuhan (CN); Xinsheng Peng, Wuhan (CN); Jing Chen, Wuhan (CN); Ming Li, Sichuan (CN)

(73) Assignee: O2Micro Inc., Santa Clara, CA (US)

(21) Appl. No.: 13/954,224

(22) Filed: Jul. 30, 2013

(30) Foreign Application Priority Data
Apr. 12, 2012 (CN) 201310127884.2
Jul. 31, 2012 (CN) 201210268345.6
Aug. 13, 2012 (CN) 201210286522.3
Sep. 14, 2012 (CN) 201210341272.9
Dec. 31, 2012 (CN) 201210590920.4
Dec. 31, 2012 (CN) 201220747691.8
Jan. 7, 2013 (CN) 201310004975.7
Jan. 25, 2013 (CN) 201310030033.6

(51) Int. Cl. G08C 23/04

(52) U.S. Cl. CPC G08C 23/04
USPC 398/106; 340/12.52

(57) ABSTRACT

Methods and systems for remotely controlling a device are provided. A first input is received from a user at a portable device. The first input specifies a first time and a first mode associated with the device. At the first time, a first command is remotely sent from the portable device to the device to activate the device in the first mode.

### RELATED APPLICATIONS

This application claims priority to Chinese Patent Application No. 201210286522.3, filed on Aug. 13, 2012, Chinese Patent Application No. 201210341272.9, filed on Sep. 14, 2012, Chinese Patent Application No. 201220747691.8, filed on Dec. 31, 2012, Chinese Patent Application No. 201210590920.4, filed on Dec. 31, 2012, Chinese Patent Application No. 201310127884.2, filed on Apr. 12, 2013, 201310004975.7, filed on Jan. 7, 2013, Chinese Patent Application No. 201310030033.6, filed on Jan. 25, 2013, Chinese Patent Application No. 201210268345.6, filed on Jul. 31, 2012, with the State Intellectual Property Office of the People's Republic of China, all of which are hereby incorporated by reference in its entirety herein.

### FIELD OF THE PRESENT TEACHING

The present teaching relates generally to remote control technologies.

### BACKGROUND

Remote controls are widely used in many fields, including electronics and industrial-production. Remote controls are regularly used in daily life to control household appliances such as televisions, DVD players, set-top boxes, air conditioning units, projectors, audio-visual equipment, and a number of other common devices. As portable electronic devices, such as smart phones and tablets, become increasingly popular, these devices are equipped for expanded functionality. For example, a smart phone can be used as a remote control to household appliances, including televisions or air conditioning units. However, existing technologies directed to controlling a device using a portable device have significant drawbacks.

For example, where multiple remote controllers are present at the same locale and each is programmed to control a different device, a user may be confused as to which one is directed to which device. In addition, when a remote controller is lost, the user must purchase a new one. Similarly, when a remote controller is broken, the user must fix the broken device or hire a third party to make the repairs. In either scenario, a lost or broken remote controller costs the user time and expense.

In another example, whereas a mobile device, such as a smart phone, can be configured to act as a remote controller for a certain appliance, existing technologies require a user to manually enter information about the appliance, such as the type and serial number of the appliance, before the mobile device may be used to remotely control the appliance. This is inconvenient to the user.

In still another example, when a conventional learning remote controller is used to learn how to control an appliance from a common remote controller, this process requires a user to press a learning key of the learning remote controller and usually does not inform the user as to whether the learning remote controller has successfully learned how to control the appliance in question until the end of the learning session. If the user is located too far away from the common remote controller, or if there is an obstacle between the learning remote controller and the common remote controller, the learning remote controller may fail to learn to control the appliance altogether.

In yet another example, infrared technology is often used in remote controllers for electronic devices such as televisions and air conditioners. In these applications, the electronic device is typically controlled via an infrared signal transmitted through infrared ports.

Because infrared remote controls use light to control a corresponding device, these controllers require a line of sight with the device being controlled in order to operate. Depending on the physical orientation of the device, a user may have to employ physically awkward gestures in order to effectively control a device using an infrared remote control. Although infrared extended technologies (e.g., those that include a receiver picking up an infrared signal and relaying the signal to a remote device via radio waves) are available where no line of sight is possible, these technologies introduce additional expense and hassle to install. Further, infrared receivers are also known to have a limited operating angle, depending on the optical characteristics of the device. For these reasons, the relative locations and orientations of the emitting and receiving devices can be quite limited.

In yet another example, when a smart phone or other mobile device is used to remote control an appliance such as a television, a user may need to match the type of the appliance being controlled and the operational procedures specific to that appliance. If the user has not had any experience controlling an appliance with a mobile device, the device may be used improperly or the device may not be aimed correctly at the controlled appliance. In addition, a user's lack of familiarity with the appropriate operational steps may also cause difficulty in operating the mobile device to control the appliance, which leads to an unpleasant user experience.

In yet another example, a user of a conventional remote controller, such as an infrared remote controller of a television, can use the remote controller to switch channels or adjust volume of the television. In this case, each time a user presses a button for switching channels, the television channel is adjusted by a single increment. Similarly, the volume of the television can be increased or decreased by pressing a button corresponding to volume control. Each time the button is pressed, the volume level is changed one level. Using a conventional remote controller in this manner, each button has a designated use (e.g., for channel switch or for volume change) and some can adjust only a designated parameter one level at a time. It can be a time-consuming and arduous task to sequentially adjust the volume one level at a time if there are a great number of volume levels.

In yet another example, when a smart phone or other mobile device is used as a television remote control, the user is required to first turn on the television before switching to a desired channel. Thus, if a user wishes to watch a particular channel at a particular time, the user has to remember when to turn on the television and then switch to the appropriate channel. This is not convenient to the user. Furthermore, TV channel designations sometimes change, which makes it more difficult for a user to know or remember which channel provides desired programs.

Therefore, there exists a need for a method and apparatus for controlling an appliance using a portable device without the drawbacks described above.

### SUMMARY

The teachings disclosed herein relate to methods, systems, and programming for remote control. More particularly, the present teaching relates to methods, systems, and programming for controlling a controlled device using a portable device.

In one example, a method for remotely controlling a device is provided. A first input is received from a user at a portable device. The first input specifies a first time and a first mode associated with the device. At the first time, a first command is remotely sent from the portable device to the device to activate the device in the first mode.

In another example, a portable device is provided for remotely controlling a device. The portable device comprises a setting module and a transmitting module. The setting module is configured for receiving a first input form a user. The first input specifies a first time and a first mode associated with the device. The transmitting module is coupled to the setting module and configured for sending remotely a first command to the device at the first time to activate the device in the first mode.

Other concepts relate to software for implementing the method for remotely controlling a device. A software product, in accordance with this concept, includes at least one machine-readable non-transitory medium and information carried by the medium. The information carried by the medium may be executable program code data regarding parameters in association with a user input or operational parameters.

In one example, a machine-readable tangible and non-transitory medium having information for controlling a device is provided. The information, when read by a portable device, causes the portable device to receive a first input from a user specifying a first time and a first mode associated with the device, and remotely send a first command to the device at the first time to activate the device in the first mode.

### BRIEF DESCRIPTION OF THE DRAWINGS

Features and benefits of embodiments of the claimed subject matter will become apparent as the following detailed description proceeds with exemplary embodiments. These exemplary embodiments are described in detail with reference to the drawings. These embodiments are non-limiting exemplary embodiments, in which like reference numerals represent similar structures throughout the several views of the drawings.

FIG. 1 illustrates an exemplary remote control system, in accordance with one embodiment of the present teaching;

FIG. 2 illustrates an exemplary block diagram of a remote control system, in accordance with one embodiment of the present teaching;

FIG. 3 is a flowchart illustrating an exemplary method for correlating a user-predefined instruction with a remote control signal, in accordance with one embodiment of the present teaching;

FIG. 4 is a flowchart illustrating an exemplary method for transferring a current user instruction to a remote control device, in accordance with one embodiment of the present teaching;

FIG. 5 is a flowchart illustrating an exemplary method for remotely controlling an electronic device based on a current user instruction, in accordance with one embodiment of the present teaching;

FIG. 6 is a flowchart illustrating exemplary operations performed by a remote control system, in accordance with one embodiment of the present teaching;

FIG. 7 illustrates an exemplary block diagram of a remote control learning system, in accordance with an embodiment of the present teaching;

FIG. 8 is a flowchart illustrating an exemplary method for using a terminal device to remotely control a specific device, in accordance with an embodiment of the present teaching;

FIG. 9 illustrates an exemplary block diagram of a remote control learning device, in accordance with an embodiment of the present teaching;

FIG. 10 illustrates another exemplary block diagram of a remote control learning device, in accordance with an embodiment of the present teaching;

FIG. 11 illustrates an exemplary block diagram of a learning remote control apparatus, in accordance with an embodiment of the present teaching;

FIG. 12 is a flowchart illustrating exemplary operations performed by a learning remote control apparatus, in accordance with an embodiment of the present teaching;

FIG. 13A and FIG. 13B illustrate exemplary block diagrams of an infrared apparatus, in accordance with an embodiment of the present teaching;

FIG. 14A and FIG. 14B illustrate exemplary block diagrams of an infrared transceiving unit of an infrared apparatus, in accordance with an embodiment of the present teaching;

FIG. 15 illustrates an exemplary block diagram of an infrared apparatus, in accordance with an embodiment of the present teaching;

FIG. 16A and FIG. 16B illustrate exemplary block diagrams s of an infrared apparatus attached to a mobile phone, in accordance with an embodiment of the present teaching;

FIG. 17A illustrates an exemplary block diagram of a circuit in an infrared apparatus, in accordance with an embodiment of the present teaching;

FIG. 17B illustrates an exemplary block diagram of a circuit in an infrared apparatus, in accordance with an embodiment of the present teaching;

FIG. 18 illustrates an exemplary block diagram of an infrared apparatus, in accordance with an embodiment of the present teaching;

FIG. 19 illustrates an exemplary block diagram of an infrared apparatus, in accordance with an embodiment of the present teaching;

FIG. 20 illustrates an exemplary block diagram of an emitting unit of an infrared apparatus, in accordance with an embodiment of the present teaching;

FIG. 21 illustrates an exemplary block diagram of an infrared apparatus attached to a mobile phone, in accordance with an embodiment of the present teaching;

FIG. 22 illustrates an exemplary block diagram of a remote control system using an end device to control a controlled device, in accordance with an embodiment of the present teaching;

FIG. 23 illustrates an exemplary block diagram of an end device in FIG. 22, in accordance with an embodiment of the present teaching;

FIG. 24 illustrates an exemplary block diagram of an end device in FIG. 22, in accordance with an embodiment of the present teaching;

FIG. 25 is a flowchart illustrating exemplary operations performed by an end device for controlling a controlled device, in accordance with an embodiment of the present teaching;

FIG. 26 is a flowchart illustrating an exemplary method for acquiring the type of a controlled device, in accordance with an embodiment of the present teaching;

FIG. 27 is a flowchart illustrating exemplary operations performed by an end device for controlling a controlled device, in accordance with an embodiment of the present teaching;

FIG. 28 is a flowchart illustrating exemplary operations performed by an end device for controlling a controlled device, in accordance with an embodiment of the present teaching;

FIG. 29 is a flowchart illustrating exemplary operations performed by an end device for controlling a controlled device, in accordance with an embodiment of the present teaching;

FIG. 30 is a flowchart illustrating exemplary operations performed by an end device for controlling a controlled device, in accordance with an embodiment of the present teaching;

FIG. 31 illustrates an exemplary block diagram of an acquiring interface on an end device when the end device obtains the type of a controlled device, in accordance with an embodiment of the present teaching;

FIG. 32 illustrates an exemplary block diagram of an information processing equipment for acquiring the type of a controlled device, in accordance with an embodiment of the present teaching;

FIG. 33 illustrates an exemplary block diagram of an infrared emission control device, in accordance with an embodiment of the present teaching;

FIG. 34 illustrates an exemplary block diagram of an infrared emission control device, in accordance with an embodiment of the present teaching;

FIG. 35 illustrates an exemplary block diagram of an infrared emission control device, in accordance with an embodiment of the present teaching;

FIG. 36 illustrates an exemplary block diagram of an infrared emission control device, in accordance with an embodiment of the present teaching;

FIG. 37 is a flowchart illustrating an exemplary method for controlling an infrared emission control device, in accordance with an embodiment of the present teaching;

FIG. 38 is a flowchart illustrating an exemplary method for controlling an infrared emission control device, in accordance with an embodiment of the present teaching;

FIG. 39 is a flowchart illustrating an exemplary method for controlling an infrared emission control device, in accordance with an embodiment of the present teaching;

FIG. 40 illustrates an exemplary block diagram of a remote control system using a portable device to control a device at certain times, in accordance with an embodiment of the present teaching;

FIG. 41 illustrates an exemplary block diagram of a portable device in FIG. 1, in accordance with an embodiment of the present teaching;

FIG. 42 illustrates another exemplary block diagram of a portable device in FIG. 1, in accordance with an embodiment of the present teaching;

FIG. 43 is a flowchart illustrating exemplary operations performed by a portable device for controlling a device at certain times, in accordance with an embodiment of the present teaching;

FIG. 44 is a flowchart illustrating exemplary operations performed by a portable device for sending a command to a device, in accordance with an embodiment of the present teaching;

FIG. 45 illustrates an exemplary block diagram of an information processing device, in accordance with an embodiment of the present teaching;

FIG. 46 illustrates an exemplary block diagram of a timing control device, in accordance with an embodiment of the present teaching;

FIG. 47 illustrates an exemplary block diagram of a selection module in FIG. 46, in accordance with an embodiment of the present teaching;

FIG. 48 illustrates an exemplary block diagram of a processing module in FIG. 46, in accordance with an embodiment of the present teaching;

FIG. 49 illustrates an exemplary block diagram of a processing module in FIG. 46, in accordance with an embodiment of the present teaching;

FIG. 50 illustrates an exemplary block diagram of a processing module in FIG. 46, in accordance with an embodiment of the present teaching;

FIG. 51 illustrates an exemplary block diagram of a processing module in FIG. 46, in accordance with an embodiment of the present teaching;

FIG. 52 illustrates an exemplary block diagram of a sampling module in FIG. 51, in accordance with an embodiment of the present teaching;

FIG. 53 illustrates an exemplary block diagram of a processing module in FIG. 46, in accordance with an embodiment of the present teaching;

FIG. 54 illustrates an exemplary block diagram of a processing module in FIG. 46, in accordance with an embodiment of the present teaching;

FIG. 55 is a flowchart illustrating an exemplary method for timing control, in accordance with an embodiment of the present teaching; and

FIG. 56 illustrates a block diagram of an exemplary timing control device, in accordance with an embodiment of the present teaching.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth. However, it will be recognized by one of ordinary skill in the art that the present teaching may be practiced without these specific details. In other instances, well known methods, procedures, components, and circuit have not been described in detail for not obscuring aspects of the present teaching.

Some of the following portions of the detailed descriptions are presented in terms of procedures, logic blocks, processing and other symbolic representations of operations on data bits within a computer memory. These descriptions and representations are commonly used by those skilled in the data processing arts to convey the substance of their work to others skilled in the art. In the present application, a procedure, logic block, process, or the like, is conceived to be a self-consistent sequence of operations or instructions leading to a result. The operations are those requiring manipulations of components and/or data of quantities and/or qualities. Usually, although not necessarily, data take the form of electrical or magnetic signals capable of being stored, transferred, combined, compared, and otherwise manipulated in a computer system.

It should be noted that all of these and similar terms are merely convenient labels applied to the components and/or data associated therewith. Unless specifically stated otherwise as apparent from the following discussions, it is appreciated that throughout the present application, discussions utilizing the terms such as “obtaining,” “analyzing,” “searching,” “generating,” “updating,” “saving,” “enabling,” “recognizing,” “discarding” or the like, refer to the actions and processes of a machine, e.g., a computer system, or a similar electronic computing device, that manipulates and transforms data represented as physical (electronic) and/or non-physical quantities within the computer system's registers and memories into other data similarly represented as physical quantities within the computer system memories or registers or other such information storage, transmission or display devices.

For example, machine-readable media may comprise storage media and communication media. Storage media includes, but is not limited to, volatile and nonvolatile, removable and non-removable media implemented in any method or technology for storage of information such as machine-readable instructions, data structures, program modules or other data. Storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody machine-readable instructions, data structures, program modules or other data and include any information delivery media. For example, and not limitation, communication media includes wired media such as a wired network or direct-wired connection, and wireless media such as acoustic, radio frequency (RF), infrared and other wireless media. Combinations of any of the above should also be included within the scope of machine-readable media.

Some embodiments according to the present teaching provide a remote control system that remotely controls one or more devices. In one embodiment, the remote control system incorporates a remote control device and a computing device, e.g., a smartphone, a tablet computer, a laptop, or the like, so that a user can control one or more devices by providing instructions to the computing device. Thus, an embodiment of the present teaching provides a simplified and efficient control system and method for controlling multiple devices.

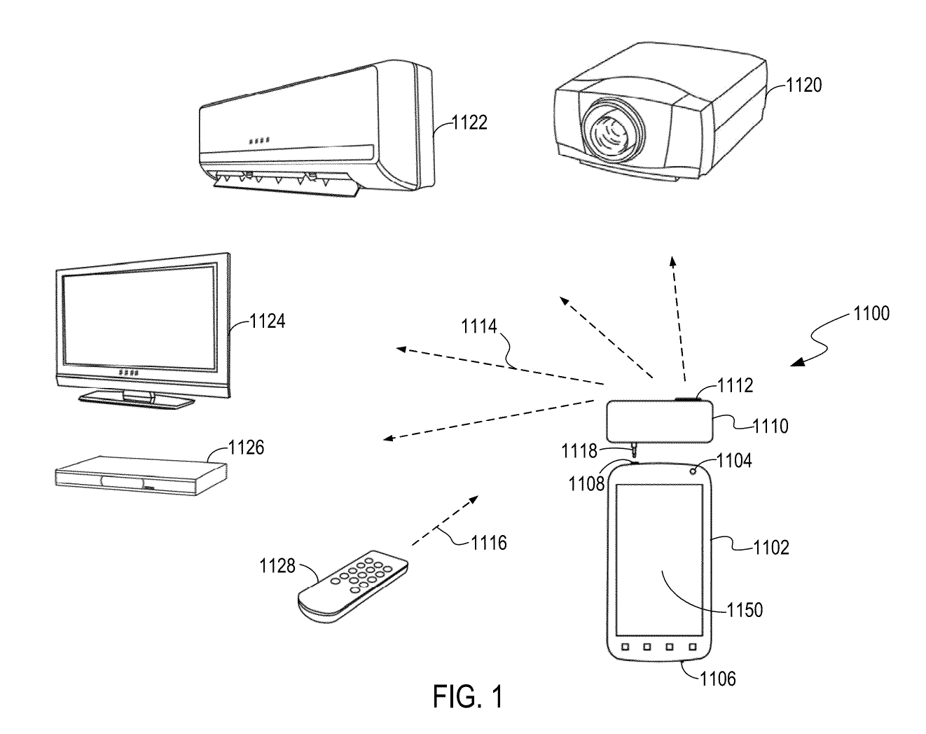

FIG. 1 illustrates an example of a remote control system 1100, in accordance with one embodiment of the present teaching. The remote control system 1100 includes a computing device 1102 and a remote control device 1110. The remote control device 1110 in conjunction with the computing device 1102 convert a user input to a remote control signal 1114 for a user to control an electronic device, such as a projector 1120, an air-conditioner 1122, a television 1124, a set-top box 1126, etc.

The computing device 1102 may include an operating system (OS) that manages computer hardware resources and provide common services for computer programs. The computing device 1102 includes, but is not limited to, a smartphone, a tablet computer, a laptop, a desktop, a palmtop, a portable media player, or the like. The computing device 1102 can include user-interface modules such as a camera 1104, a microphone 1106, a touch screen 1150, and a motion sensor (not shown). The computing device 1102 can also include an audio communication socket 1108. In addition, the remote control device 1110 can include an audio communication pin 1118 and an infrared communication module 1112.

In one embodiment, the computing device 1102 in operation recognizes a user instruction via the user-interface module. For example, a user can give an instruction to the computing device in various way, including, s for example, voice command through the microphone 1106, input through the touch screen 1150, moving the computing device 1102, or making a gesture in front of the camera 1104. The microphone 1106, e.g., an acoustic-to-electric transducer, can receive a voice instruction from the user and generate machine-readable data indicative of the voice instruction. The touch screen 1150 can sense a location of a touch on the touch screen 1150 or a slide performed on the touch screen 1150 and generate machine-readable data indicative of the location of the touch or indicative of pattern of the slide. The motion sensor, e.g., including a gravitational sensor, a three-axis acceleration transducer, and/or an electronic compass, can sense a motion of the computing device 1102, e.g., moving up, moving down, shaking, etc., and generate machine-readable data indicative of the motion. The camera 1104 can capture a set of images for a gesture (e.g., eye blink, mouth open, etc.) performed by the user and generate machine-readable data indicative of the gesture. Thus, the computing device 1102 can analyze the above mentioned machine-readable data to recognize the user instruction, and provide the recognized instruction to the remote control device 1110 based on the machine-readable data. In one example, the computing device 1102 generates an audio signal, e.g., an analog electrical signal, according to the machine-readable data and provides the audio signal to the remote control device 1110 via the audio communication socket 1108. The remote control device 1110 receives the audio signal via the audio communication pin 1118, generates a remote control signal 1114, e.g., an infrared signal, according to the audio signal. The remote control device 1110 then transmits the remote control signal 1114 via the infrared communication module 1112 to remotely control a corresponding electronic device.

In one embodiment, instructions can be predefined by a user. For example, the user can provide a predefined instruction to the computing device 1102 via the user-interface module. The remote control device 1110 receives the predefined instruction from the computing device 1102 and stores a first predefined instruction code C_{INST} (hereinafter, first code C_{INST}) indicative of the predefined instruction in a storage unit (details will be discussed below). In one embodiment, “code” used herein means machine readable code including, e.g., a set of binary code strings, hexadecimal code strings, or the like. The predefined instruction received by the remote control device 1110 from the computing device 1102 can be represented in various forms, e.g., audio signals. The first predefined instruction code can be read by the remote control device 1110.

On the other hand, the remote control device 1110 can sample a remote control signal 1116, e.g., an infrared signal, from a remote controller 1128, and store sampled remote control-signal data D_{SMP} (hereinafter, sampled data D_{SMP}) indicative of the sampled remote control signal 1116 (hereinafter, sampled signal 1116) in the storage unit. The remote control device 1110 may further correlate the first code C_{INST} with the sampled data D_{SMP}. That is, the remote control device 1110 can correlate the predefined instruction with the sampled signal 1116. Similarly, the remote control device 1110 can correlate multiple predefined instructions (e.g., defined by a user) with multiple sampled signals 1116 respectively.

Thus, the remote control system 1100, including the computing device 1102 and the remote control device 1110, can sample remote control signals from various remote controllers. The remote control system 1100 can also receive user-predefined instructions and correlate the instructions with the sampled remote control signals. As such, the user can control different electronic devices through the remote control system 1100 in a simple manner.

The devices and modules disclosed in FIG. 1 are for illustration purpose only and are not intended to limit the teaching. In the example of FIG. 1, the computing device 1102 communicates with the remote control device 1110 via audio communication. In another embodiment, the computing device 1102 communicates with the remote control device 1110 via Wi-Fi communication, BLUETOOTH communication, universal serial bus (USB) communication, or the like. In yet another embodiment, a central processing unit (CPU) of the computing device 1102 communicates with a microcontroller unit (MCU) of the remote control device 1110 via, e.g., a communication bus. In the example of FIG. 1, the remote control device 1110 receives the sampled signal 1116 and transmits the remote control signal 1114 via the infrared communication module 1112. However, in another embodiment, the remote control device 1110 receives the sampled signal 1116 and transmits the remote control signal 1114 via a Wi-Fi communication module, a BLUETOOTH communication module, or the like.

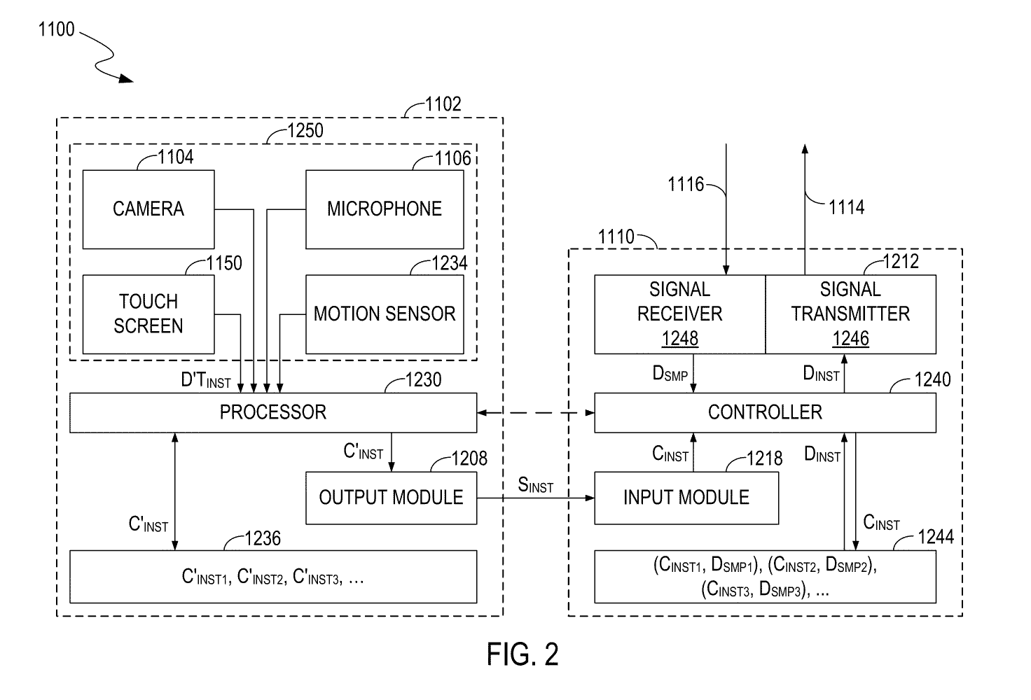

FIG. 2 illustrates a block diagram of an example of a remote control system 1100 including the computing device 1102 and the remote control device 1110, in accordance with one embodiment of the present teaching. FIG. 2 may be described in combination with FIG. 1. As shown in FIG. 2, the computing device 1102 includes user-interface modules 1250, including a camera 1104, a microphone 1106, a touch screen 1150, and a motion sensor 1234. The computing device 1102 also includes a processor 1230, e.g., a central processing unit (CPU), storage medium 1236, and an output module 1208. The computing device 1102 also includes an operating system that manages the operations of the user-interface modules 1250, the processor 1230, and the output module 1208. The remote control device 1110 includes an input module 1218, a storage unit 1244, a controller 1240, e.g., an MCU, and a front-end module 1212 that includes a signal transmitter 1246 and a signal receiver 1248. The storage medium 1236 and the storage unit 1244 are non-transitory machine-readable storage medium, in one embodiment.

In one embodiment, the storage medium 1236 of the computing device 1102 stores a predefined instruction database for user-predefined instructions. The predefined instruction database includes multiple second predefined instruction codes (C′_{INST1}, C′_{INST2}, C′_{INST3} . . . ) pre-stored therein. The second predefined instruction code C′_{INST} (e.g., C′_{INST1}, or C′_{INST2}, or C′_{INST3} . . . ) may be machine-readable instruction code. Each pre-stored second predefined instruction code C′_{INST} (e.g., C′_{INST1}, C′_{INST2}, C′_{INST3} . . . ) may be correlated with a predefined instruction, e.g., defined by a user. For example, as described above in accordance with FIG. 1, instructions can be predefined by a user. Each pre-stored second predefined instruction code C′_{INST} (hereinafter, second code C′_{INST}) in the predefined instruction database can be generated in response to a predefined instruction received at the user-interface module 1250 of the computing device 1102. In addition, each pre-stored second code C′_{INST} in the predefined instruction database may also be correlated with sampled data D_{SMP} of a sampled signal 1116 received from a remote controller, e.g., a conventional remote controller 1128.

In one embodiment, the storage unit 1244 of the remote control device 1110 includes multiple pairs of data ((C_{INST1}, D_{SMP1}), (C_{INST2}, D_{SMP2}), (C_{INST3}, D_{SMP3}) . . . ). Each pair of data includes sampled data D_{SMP} and a first code C_{INST1} correlated with the sampled data D_{SMP}. For instance, sampled data D_{SMP1} is correlated with the first code C_{INST1}, and sampled data D_{SMP2} is correlated with the first code C_{INST2}, etc. The data control D_{SMP} in each pair of data represents a sampled signal 1116 received from a remote controller. The first code C_{INST1} in each pair of data represents a user-predefined instruction. In addition, the storage unit 1244 may include a look-up table TB₁ indicative of correlation between the sampled data D_{SMP} in each pair of data and the first code C_{INST} in the each pair of data. The input module 1218 can receive, from the computing device 1102, a predefined instruction signal S_{INST} indicative of a user-predefined instruction, and convert the instruction signal S_{INST} to a corresponding first code C_{INST}. Moreover, the signal receiver 1248 of the front-end module 1212 may receive a sampled signal 1116 from a remote controller and convert the sampled signal 1116 to corresponding sampled data D_{SMP}. The corresponding first code C_{INST} and sampled data D_{SMP} are stored in the storage unit 1244. Thus, the remote control device 1110 can correlate the corresponding first code C_{INST} with the corresponding sampled data D_{SMP} by updating the look-up table TB₁, e.g., writing the corresponding first code C_{INST} and sampled data D_{SMP} in the look-up table TB₁, or writing the addresses, where the corresponding first code C_{INST} and sampled data D_{SMP} are stored, in the look-up table TB₁. As such, as described above in accordance with FIG. 1, the remote control device 1110 can establish correlation between multiple user-predefined instructions and multiple sampled signals 1116, respectively.

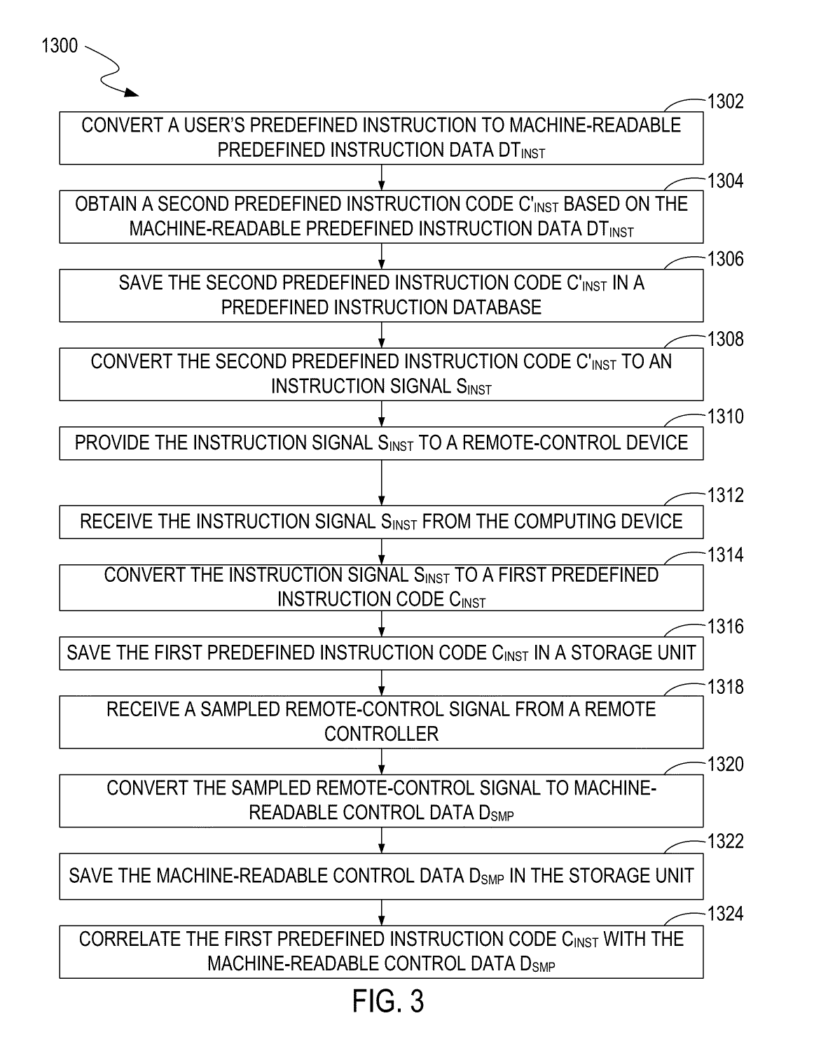

FIG. 3 is a flowchart 1300 illustrating a method for correlating a user-predefined instruction with a sampled signal 1116, in accordance with one embodiment of the present teaching. Although specific operations are disclosed in FIG. 3, these operations are illustrative of an embodiment of the present teaching. That is, the present teaching is well suited to performing various other operations or variations of the operations recited in FIG. 3. FIG. 3 may be described in combination with FIG. 1 and FIG. 2.

In one embodiment, the flowchart 1300 is implemented as machine-readable instructions stored in non-transitory machine-readable medium. For example, the processor 1230 can execute instructions stored in the storage medium 1236, such that circuits and modules of the computing device 1102 can perform the following 1302, 1304, 1306, 1308 and 1310 under the control of the processor 1230. The controller 1240 can execute instructions stored in the storage unit 1244, such that circuits and modules of the remote control device 1110 can perform the following 1312, 1314, 1316, 1318, 1320, 1322 and 1324 under the control of the controller 1240.

At 1302, the user-interface module 1250 of the computing device 1102 receives a predefined instruction from a user and converts the predefined instruction to machine-readable predefined instruction data D′T_{INST} (hereinafter, instruction data D′T_{INST}).

At 1304, the computing device 1102 obtains a second code C′_{INST} indicative of the predefined instruction based on the instruction data D′T_{INST}. In one embodiment, the second code C′_{INST} is stored in the storage medium 1236 and includes, e.g., a set of binary code strings, hexadecimal code strings, or the like. In one example, the computing device 1102 includes an existing database (e.g., an image database, a voice database, a touch-input database, or a motion database) that stores information data codes corresponding to different information, e.g., gesture, voice, touch-input, or motion information. Based on an algorithm, e.g., a modulation and demodulation algorithm and/or a fuzzy algorithm, the processor 1230 can abstract characteristic data from the instruction data D′T_{INST} and search the corresponding database for an information data code that corresponds to the characteristic data from the instruction data D′T_{INST}. The obtained information data code can be considered as an above mentioned second code C′_{INST} indicative of the predefined instruction. For example, a user may say “turn on the television” to the microphone 1106. The computing device 1102 can analyze the voice instruction “turn on the television”, and obtain an information data code representative of the instruction “turn on the television”. The information data code can be considered as a second code C′_{INST}.

At 1306, the processor 1230 saves the second code C′_{INST} in the predefined instruction database of the storage medium 1236. In other words, the predefined instruction database can store the second code C′_{INST} corresponding to the predefined instruction. In one embodiment, the predefined instruction database can be included in or separated from the above mentioned database.

At 1308, the output module 1208 receives the second code C′_{INST} from the processor 1230 and converts the second code C′_{INST} to an instruction signal S_{INST}. The instruction signal S_{INST} can be, e.g., an analog electrical instruction signal compatible with the remote control device 1110. In one example, the output module 1208 includes an audio communication module that performs digital-to-analog (D/A) conversion to convert the second code C′_{INST} to an audio instruction signal S_{INST}. In another example, the output module 1208 includes a communication module, e.g., a Wi-Fi communication module, a BLUETOOTH communication module, or a USB communication module, which converts the second code C′_{INST} to one or more data packs S_{INST}.

At 1310, the output module 1208 provides the instruction signal S_{INST} to the remote control device 1110. At 1312, the input module 1218 of the remote control device 1110 receives, from the computing device 1102, the instruction signal S_{INST} indicative of the predefined instruction.

At 1314, the input module 1218 converts the instruction signal S_{INST} to a first code C_{INST}. In one embodiment, the first code C_{INST} is read by the remote control device 1110 and represents the predefined instruction. In one example, the input module 1218 includes an audio communication module that performs analog-to-digital (ND) conversion to convert an audio instruction signal S_{INST}, e.g., an analog electrical signal, to a first code C_{INST}. In another example, the input module 1218 includes a communication module, e.g., a Wi-Fi communication module, a BLUETOOTH communication module, or a USB communication module, which abstracts payload data from one or more data packets S_{INST}. For example, the first code C_{INST} includes the abstracted payload data.

At 1316, the controller 1240 saves the first code C_{INST} in the storage unit 1244. At 1318, the controller 1240 enables the signal receiver 1248 to receive a sampled signal 1116 from a remote controller, e.g., the remote controller 1128 shown in FIG. 1. At 1320, the signal receiver 1248 converts the sampled signal 1116 to machine readable sampled data D_{SMP}. At 1322, the controller 1240 saves the sampled data D_{SMP} in the storage unit 1244. At 1324, the controller 1240 updates the look-up table TB₁ to correlate the first code C_{INST} with the sampled data D_{SMP}.

In one embodiment, by repeating the operations in the flowchart 1300 according to different user-predefined instructions, the predefined instruction database in the storage medium 1236 stores multiple second codes (C′_{INST1}, C′_{INST2}, C′_{INST3} . . . ) indicative of multiple user-predefined instructions. In addition, by repeating the operations in the flowchart 1300, the storage unit 1244 can also store multiple first codes (C_{INST1}, C_{INST2}, C_{INST3} . . . ) and correlated sampled data (D_{SMP1}, D_{SMP2}, D_{SMP3} . . . ). The multiple first codes (C_{INST1}, C_{INST2}, C_{INST3} . . . ) may represent different user-predefined instructions. The sampled data (D_{SMP1}, D_{SMP2}, D_{SMP3} . . . ) may represent the sampled signals 1116 correlated with the predefined instructions.

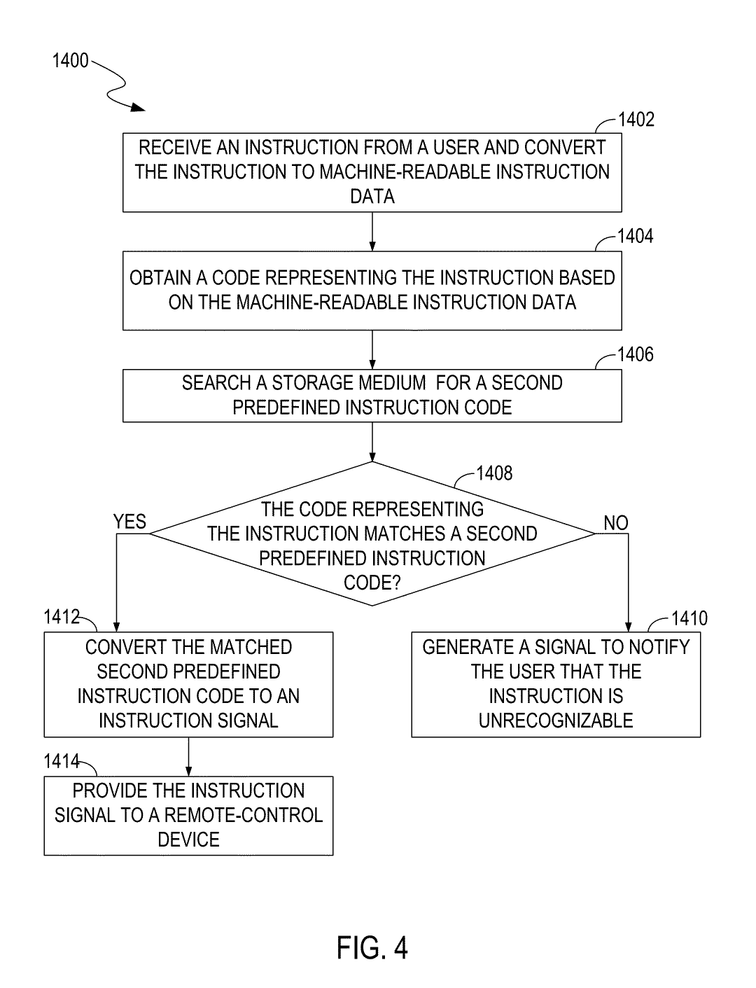

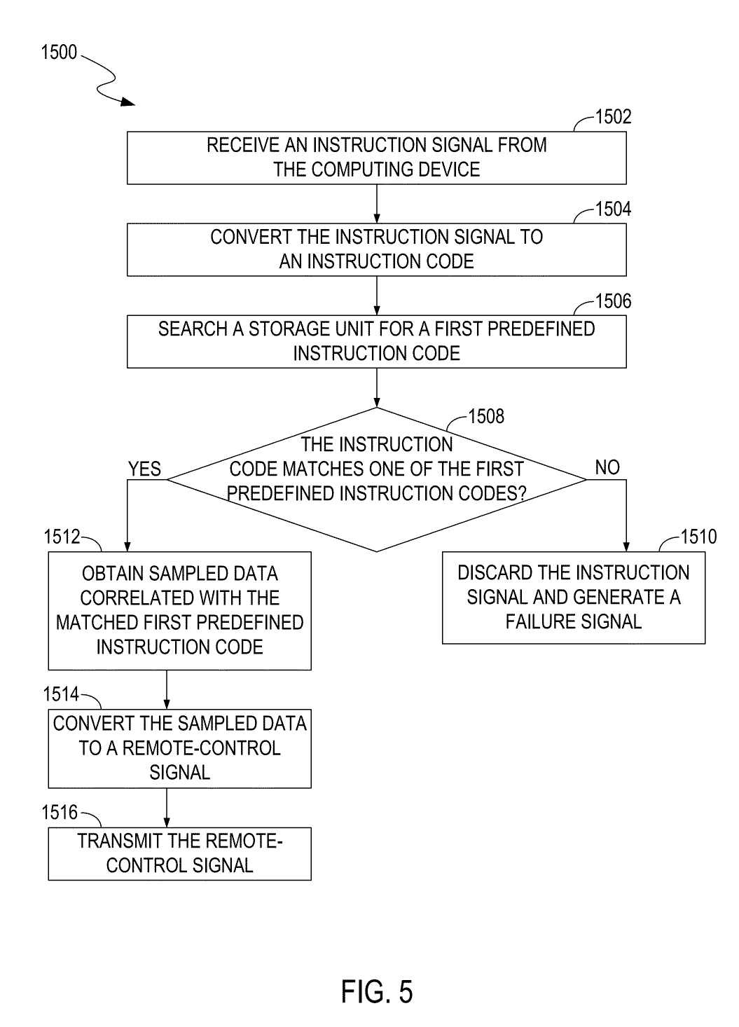

In one embodiment, when a user wants to control a device, the user gives an instruction to the computing device 1102. Based on the predefined instruction database in the computing device 1102 and the look-up table TB₁ in the remote control device 1110, the instruction from the user is transferred to a remote control signal 1114 to control the device. Examples of the operations are shown in FIG. 4 and FIG. 5.

FIG. 4 is a flowchart 1400 illustrating a method for transferring a user instruction to the remote control device 1110, in accordance with one embodiment of the present teaching. Although specific operations are disclosed in FIG. 4, such operations are examples for illustrative purposes. That is, the present teaching is well suited to performing various other operations or variations of the operations recited in FIG. 4. FIG. 4 may be described in combination with FIG. 1 and FIG. 2. Process in the flowchart 1400 can be performed by the computing device 1102.

In one embodiment, the flowchart 1400 is implemented as machine-readable instructions stored in a non-transitory machine-readable medium. For example, the processor 1230 can execute instructions stored in the storage medium 1236, such that circuits and modules of the computing device 1102 can perform the following operations under the control of the processor 1230.

At 1402, the user-interface module 1250 of the computing device 1102 receives an instruction from a user and converts the instruction to machine-readable instruction data. At 1404, the processor 1230 obtains a code representing the instruction based on the machine-readable instruction data. For example, according to a modulation and demodulation algorithm and/or a fuzzy algorithm, the processor 1230 can abstract characteristic data from the machine-readable instruction data and search the aforementioned database (e.g., an image database, a voice database, a touch-input database, or a motion database) for a code corresponding to the characteristic data and representing the instruction.

At 1406, the processor 1230 searches the aforementioned second codes (C′_{INST1}, C′_{INST2}, C′_{INST3} . . . ) in the storage medium 1236 for a second code C_{INST1} that matches the code representing the instruction. For example, the processor 1230 compares the code representing the instruction with each of the second codes (C′_{INST1}, C′_{INST2}, C′_{INST3} . . . ) in the predefined instruction database. In this embodiment, if the code representing the instruction matches a code (referred to as a “matched second predefined instruction code” or a “matched second code”) in the second codes (C′_{INST1}, C′_{INST2}, C′_{INST3} . . . ), e.g., the code representing the instruction is found in the predefined instruction database, the instruction is determined to be “recognizable.” If the code representing the instruction does not match any of the second codes (C′_{INST1}, C′_{INST2}, C′_{INST3} . . . ), the instruction is determined to be “unrecognizable.”

The output module 1208 converts the matched second code C′_{INST} to an instruction signal (S_{INST}) according to the search result. At 1408, if the code representing the instruction matches a second code, the process in flowchart 1400 goes to 1412; otherwise, the process goes to 1410.

At 1410, the processor 1230 generates a signal to notify the user (e.g., by displaying text on the screen) that the instruction is unrecognizable. At 1412, the output module 1208 converts the matched second code C′_{INST} to an instruction signal (S_{INST}). At 1414, the output module 1208 provides the instruction signal (S_{INST}) to the remote control device 1110 to cause the remote control device 1110 to transmit a control signal to remotely control an electronic device, as will be described in detail later. The control signal may be correlated with the first code C_{INST} that is corresponding to the instruction signal (S_{INST}).

FIG. 5 is a flowchart 1500 illustrating a method for remotely controlling an electronic device based on a user instruction, in accordance with one embodiment of the present teaching. Although specific operations are disclosed in FIG. 5, such operations are examples for illustrative purposes. That is, the present teaching is well suited to performing various other operations or variations of the operations recited in FIG. 5. FIG. 5 may be described in combination with FIG. 1 and FIG. 2. Process in the flowchart 1500 can be performed by the remote control device 1110.

In one embodiment, the flowchart 1500 is implemented as machine-readable instructions stored in a non-transitory machine-readable medium. For example, the controller 1240 can execute instructions stored in the storage unit 1244, such that circuits and modules of the remote control device 1110 can perform the following process under the control of the controller 1240.

At 1502, the input module 1218 receives an instruction signal (S_{INST}) from the computing device 1102. The instruction signal (S_{INST}) may represent an instruction received from the user through the user-interface module 1250 of the computing device 1102. At 1504, the input module 1218 converts the instruction signal (S_{INST}) to an instruction code (C_{INST}), and provides the instruction code (C_{INST}) to the controller 1240. At 1506, the controller 1240 searches the first codes (C_{INST1}, C_{INST2}, C_{INST3} . . . ) of the pairs of data ((C_{INST1}, D_{SMP1}), (C_{INST2}, D_{SMP2}), (C_{INST3}, D_{SMP3}) . . . ) in the storage unit 1244 for a first code C_{INST} that matches the instruction code (C_{INST}). For example, the controller 1240 compares the instruction code (C_{INST}) with the each of the first codes (C_{INST1}, C_{INST2}, C_{INST3} . . . ) in the storage unit 1244.

At 1508, if the instruction code (C_{INST}) matches one (referred to as a “matched first predefined instruction code’ or a “matched first code”) of the first codes (C_{INST1}, C_{INST2}, C_{INST3} . . . ) in the storage unit 1244, the process in flowchart 1500 goes to 1512; otherwise, the process goes to 1510. In one example, the output module 1208 of the computing device 1102 and the input module 1218 of the remote control device 1110 can be audio communication modules. An audio conversion, e.g., the above mentioned A/D conversion performed by the input module 1218 is usually not ideal, in response to the same user instruction (e.g., an instruction or a predefined instruction). Therefore, the instruction code (C_{INST}) converted from the instruction signal (S_{INST}) may deviate from the first code C_{INST} converted from the predefined instruction signal S_{INST} discussed before with respect to FIG. 3. Hence, an exact match between a first code C_{INST} and the instruction code (C_{INST}) may not be found in the storage unit 1244. In this situation, the controller 1240 can search the instruction codes in the storage unit 1244 for the instruction code (C_{INST}) using a fuzzy algorithm instead. For instance, if a difference between a first code C_{INST} in the storage unit 1244 and the instruction code (C_{INST}) is within an acceptable margin of error set by the fuzzy algorithm, then the instruction code (C_{INST}) would still be considered as matching the first code C_{INST}.

At 1510, the instruction code (C_{INST}) does not match any instruction code in the storage unit 1244. Therefore the controller 1240 may discard the instruction signal (S_{INST}) and generate a failure signal. For example, the remote control device 1110 has a light indicator. The light indicator can flash at a predetermined frequency or emit a predetermined color in response to the failure signal.

At 1512, the instruction code (C_{INST}) matches a first code C_{INST} in the storage unit 1244. Therefore the controller 1240 may obtain, from the pairs of data ((C_{INST1}, D_{SMP1}), (C_{INST2}, D_{SMP2}), (C_{INST3}, D_{SMP3}) . . . ) in the storage unit 1244, sampled remote control-signal data D_{INST} (i.e., sampled data D_{SMP}) correlated with the matched first code C_{INST}. The controller 1240 provides the sampled remote control-signal data D_{INST} (hereinafter, sampled data D_{INST}) to the front-end module 1212.

At 1514, the signal transmitter 1246 of the front-end module 1212 converts the sampled remote control-signal data D_{INST} to a remote control signal 1114, e.g., an infrared signal.

At 1516, the signal transmitter 1246 transmits the remote control signal 1114 to remotely control the electronic device. In one example, the front-end module 1212 includes an infrared communication module that transmits an infrared signal as the remote control signal 1114 to control the electronic device. In other examples, the front-end module 1212 includes an infrared communication module, a BLUETOOTH communication module, and a Wi-Fi communication module.

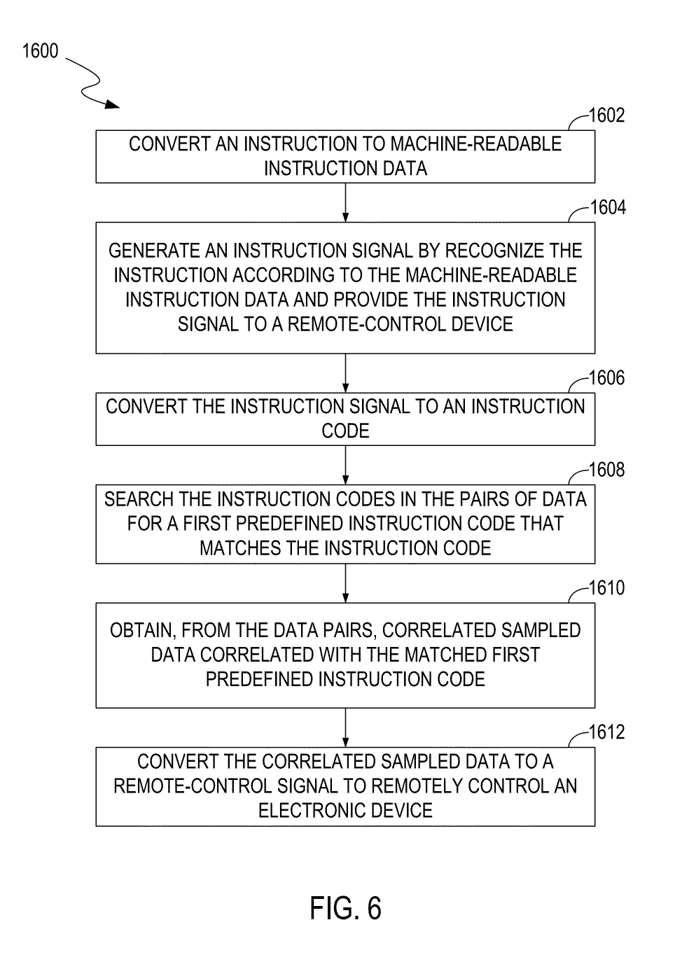

FIG. 6 is a flowchart 1600 illustrating operations performed at a remote control system 1100, in accordance with one embodiment of the present teaching. FIG. 6 may be described in combination with FIG. 1, FIG. 2, FIG. 3, FIG. 4 and FIG. 5.

At 1602, a user-interface module 1250, e.g., the camera 1104, the microphone 1106, the touch screen 1150, or the motion sensor 1234, of the computing device 1102 converts a user's instruction to machine-readable instruction data. At 1604, the computing device 1102 generates an instruction signal (S_{INST}) by recognizing the user's instruction according to the machine-readable instruction data, and provides the instruction signal (S_{INST}) to the remote control device 1110. At 1606, the input module 1218 of the remote control device 1110 converts the instruction signal (S_{INST}) to an instruction code (C_{INST}). At 1608, the controller 1240 of the remote control device 1110 searches instruction codes in the aforementioned pairs of data ((C_{INST1}, D_{SMP1}), (C_{INST2}, D_{SMP2}), (C_{INST3}, D_{SMP3}) . . . ) in the storage unit 1244 for a first code C_{INST} that matches the instruction code (C_{INST}). At 1610, the controller 1240 obtains, from the pairs of data ((C_{INST1}, D_{SMP1}), (C_{INST2}, D_{SMP2}), (C_{INST3}, D_{SMP3}) . . . ), correlated sampled remote control-signal data D_{INST} that is correlated with the matched first code C_{INST}. At 1612, the front-end module 1212 of the remote control device 1110 converts the correlated sampled remote control-signal data D_{INST} to a remote control signal 1114 to remotely control an electronic device.

Accordingly, some embodiments according to the present teaching provide a remote control system (including a remote control device and a computing device) and method for remotely controlling multiple electronic devices. In one embodiment, the remote control system utilizes an interface module, such as a camera, a microphone, a touch screen, or a motion sensor of a computing device, to receive user-predefined instructions, and utilizes a remote control device to sample remote control signals that are used to control the electronic devices. The remote control system may further correlate the user-predefined instructions with the sampled remote control signals respectively. Consequently, a user can control multiple electronic devices by giving instructions to the remote control system in a simple manner.

Some embodiments according to the present teaching also provide a remote control learning device that is configured to act as a remote controller for an electronic device, e.g., a home appliance. As portable devices have become ubiquitous, it is beneficial to expand the functionality of such devices to serve other needs such as remote control. In one embodiment, portable devices, such as a smart phone or a tablet, can be configured to act as a remote controller to control an electronic device. In one embodiment, the portable device can receive an infrared signal from the remote controller and use the infrared signal to check whether digital control files of the remote controller are stored in a server. Thus, the portable device can be configured to act as the remote controller by converting the infrared signal to a digital control file and then converting the digital control file to another infrared signal. In other examples, digital control files of the remote controller may be automatically downloaded by the portable device from the server.

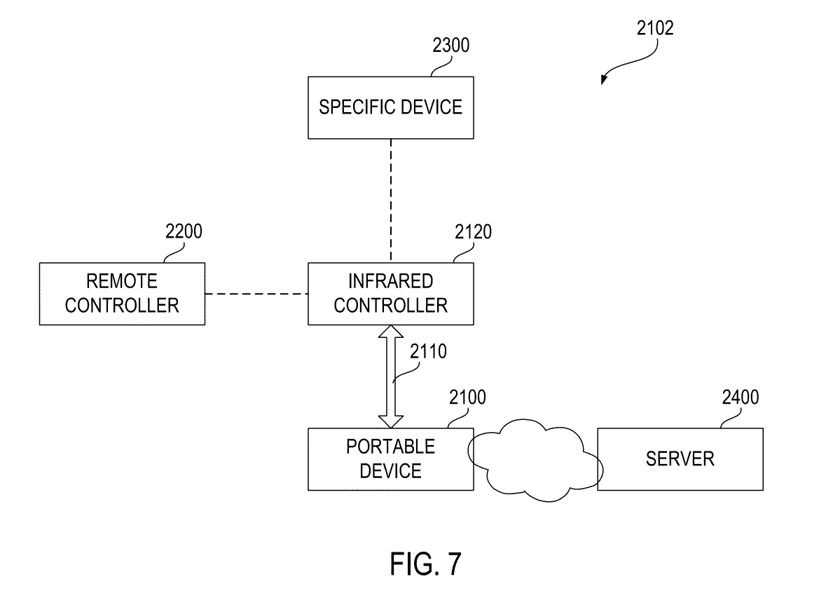

FIG. 7 illustrates an exemplary block diagram of a remote control learning system 2102, of which a portable device 2100 is configured to remotely control a specific device 2300, in accordance with an embodiment of the present teaching.

As shown in FIG. 7, the remote control learning system 2102 includes a portable device 2100, a remote controller 2200, a specific device 2300, and a server 2400. The portable device 2100 includes, e.g., a smart phone, a PDA (Personal Digital Assistant), a tablet PC, or the like. The specific device 2300, e.g., an electrical appliance such as a television or an air-conditioner, is controlled by a user using the remote controller 2200. Once the learning succeeds, the specific device 2300 can be controlled by a user using the portable device 2100 as well. The server 2400 includes a database for storing digital control files of the remote controller 2200 and can communicate with the portable device 2100 via a network to provide database service to the portable device 2100.

For example, the database in the server 2400 stores the digital control files and device information, e.g., the type of the device and the device number, etc., of the remote controller 2200, in a correlated manner. The digital control files of the remote controller 2200 can be the infrared wave digital files of the keys on the remote controller 2200. In other words, the infrared wave digital files of the keys on the remote controller 2200 and the relationship between the remote controller 2200 and the specific device 2300 may be stored in the database in the server 2400. In one embodiment, the database of the server 2400 includes multiple digital control files and multiple pieces of device information. In this embodiment, each digital control file is correlated with a corresponding piece (or pack) of device information, and each piece of device information can be correlated with a group of digital control files. A “correlated manner”, as used herein, means a manner in which a database stores one or more digital control files and one or more pieces of device information. In such a manner, a piece of device information can be obtained (e.g., read from the database) according to the digital control file correlated with such device information, and/or one or more digital control files can be obtained from the database according to the device information correlated with the one or more digital control files.

In one embodiment, in the aforementioned remote control learning system 2102 as shown in FIG. 7, the portable device 2100 can establish a connection between the remote controller 2200 and the specific device 2300 via the infrared controller 2120 so as to receive a first infrared signal from the remote controller 2200 and transmit a second infrared signal as an operational instruction to the specific device 2300. In one embodiment, the infrared controller 2120 can be implemented as a component of the portable device 2100. In another embodiment, the infrared controller 2120 can be implemented as a separate device, which can be attached to the portable device 2100.

In one embodiment, the portable device 2100 can have an audio jack, e.g., a phone jack. The infrared controller 2120 is coupled to the phone jack of the portable device 2100 such that the infrared controller 2120 can establish signal connection with the portable device 2100 via an audio channel 2110. The infrared controller 2120 converts the first infrared signal provided by the remote controller 2200 to a first control signal as an analog electrical signal and then inputs the first control signal to the portable device 2100 via the audio channel 2110. In another embodiment, the portable device 2100 outputs a second control signal as an analog electrical signal via the left/right sound track of the audio channel 2110. The infrared controller 2120 converts the second control signal to the second infrared signal that is to be sent or transmitted to the specific device 2300.

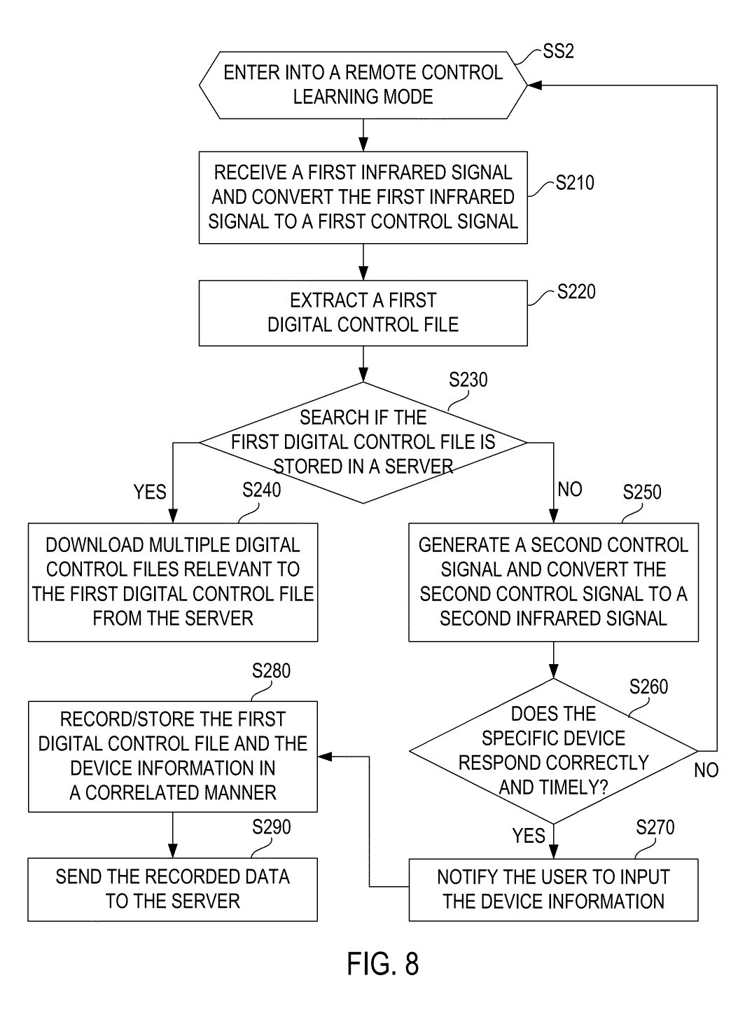

FIG. 8 is a flowchart illustrating an example of a method for using a portable device to remotely control a specific device, in accordance with an embodiment of the present teaching. FIG. 8 may be described in combination with FIG. 7.

As shown in FIG. 8, at SS2, the portable device 2100 enters into a remote control learning mode according to a user's input. The user's operation performed on a remote controller (e.g., the remote controller 2200 of the specific device 2300) includes, but is not limited to, pressing a certain key, e.g., a volume-up key, on the remote controller 2200. In one embodiment, in the remote control learning mode, the distance between the portable device 2100 and the remote controller 2200 is less than 10 cm.

At S210, the portable device 2100 works in the remote control learning mode. If the infrared controller 2120 receives a first infrared signal that is generated by the user operating the remote controller 2200, then the infrared controller 2120 converts the first infrared signal to a first control signal. Then, the process goes to S220.

At S220, the portable device 2100 extracts a first digital control file from the first control signal provided from the infrared controller 2120. The first digital control file may describe an operation corresponding to the operating on the remote controller 2200 performed by the user. For example, the first digital control file can describe the content of the current operation. Then, the process goes to S230.

At S230, the portable device 2100 searches a database of a server 2400 and determines whether the first digital control file is stored in the server 2400. In one embodiment, if a file identical to the first digital control file is found in the database of the server 2400, it is determined that the first digital control file is stored in the server 2400. In that case, the process goes to S240; otherwise the process goes to S250.

If a file identical to the first digital control file is found in the database of the server 2400, it is determined that the database of the server 2400 has stored all the digital control files relevant to the remote controller 2200. That is, the database of the server 2400 has stored all the digital control files relevant to, the specific device 2300. Therefore, at S240, the portable device 2100 can automatically download multiple digital control files, e.g., part or all of the digital control files, which are relevant to the first digital control file, from the server 2400 to the portable device 2100, to skip the learning processes of other keys on the remote controller 2200. For example, when a user presses a volume-up key on the remote controller 2200 of a television, if the portable device 2100 searches out a corresponding digital control file of the volume-up key in the database of the server 2400, the portable device 2100 can automatically download the digital control files of other keys on the remote controller 2200, e.g., a power on/off key, a channel switching key, a volume-down key, etc., for controlling the same type of television from the server 2400.

If no identical first digital control file in the database of the server 2400, it is determined that the remote controller 2200 has not been learnt by a user using the portable device 2100. Thus, the portable device 2100 may perform the following to check the validity of the first digital control file and to record the current learning result.

At step S250, the portable device 2100 generates a corresponding second control signal based on the first digital control file and transfers the second control signal to the infrared controller 2120. The infrared controller 2120 converts the second control signal to a second infrared signal and transmits the second infrared signal to the specific device 2300. The process then advances to S260.

At S260, the portable device 2100 determines if the specific device 2300 responds to the second infrared signal correctly and timely. In one embodiment, the portable device 2100 determines if a reply is received from the specific device 2300 in response to the second infrared signal, within a predetermined time since the transmission of the second infrared signal. In one embodiment, the predetermined time can be set by the user. For example, the predetermined time can be set to be 2 seconds or 4 seconds. If the specific device 2300 responds correctly (e.g., the volume of the specific device 2300 is increased as expected) and timely (e.g., within the predetermined time), then the currently learnt digital control file is considered correct. Then, the process goes to S270; otherwise, the process goes back to SS2.

At S270, the portable device 2100 notifies the user to input the device information, e.g., the type of the device and the device serial number of the remote controller 2200. Then, the process goes to S280. At S280, the portable device 2100 records/stores the first digital control file being learned and the device information input by the user in a correlated manner. Then, the process goes to step S290. In one embodiment, similar to the above mentioned database of the server 2400, a database of the portable device 2100 can include multiple digital control files and multiple pieces of device information. Each digital control file is correlated with a corresponding piece of device information, and each piece of device information can be correlated with a group of digital control files. At S290, the portable device 2100 sends the recorded data to the server 2400 to update the database of the server 2400 in real time.

Through the learning process in the flowchart as described above, the portable device 2100 can be configured to act as a remote controller for controlling various electronic devices, such as televisions, DVD players, and air-conditioners. By automatically downloading relevant digital control files from the database of the server 2400, the time required for configuring the portable device 2100 can be reduced Moreover, as the device information of the remote controller 2200 can also be downloaded from the server 2400, the user does not need to manually check the device information in order to configure the portable device 2100. Thus, the above-mentioned remote control learning process can simplify user's operations in configuring the portable device 2100 to act as the remote controller 2200.

In one embodiment, the portable device 2100 can have an audio channel, e.g., a phone jack. The first and second control signals can be analog electrical signals transferred via the audio channel. For example, at S210, the first infrared signal is converted to a corresponding first control signal in the form of an analog electrical signal so that the first control signal can be input to the portable device 2100 via the audio jack, e.g., a phone jack, of the portable device 2100. Moreover, at S220, the first control signal may be converted to a digital audio signal by an audio card of the portable device 2100. Then, the first digital control file that describes the content of the current operation on the remote controller 2200 can be obtained by analyzing and decoding the digital audio signal.

In another embodiment, at S250, the portable device 2100 converts the digital control file to a digital audio signal and then converts the digital audio signal to a second control signal in the form of an analog electrical signal. The portable device 2100 inputs the second control signal to the infrared controller 2120 via the phone jack. Thus, the infrared controller 2120 converts the second control signal to a second infrared signal and send it to the specific device 2300.

Furthermore, after the step S240, the portable device 2100 can convert all the digital control files downloaded from the server 2400 to audio files (e.g., digital audio signals) and store the audio files. By converting the digital control files to audio files, which can be output through the phone jack, and by storing the audio files in the portable device 2100 in advance, the signal processing time required for each remote control procedure can be reduced compared to a method that includes converting a digital control file to an audio file each time when the portable device 2100 is used in a remote control procedure.

Accordingly, by using existing components, e.g., the audio jack and the audio card, of the portable device, the cost for configuring the portable device to act as a remote controller is further reduced.

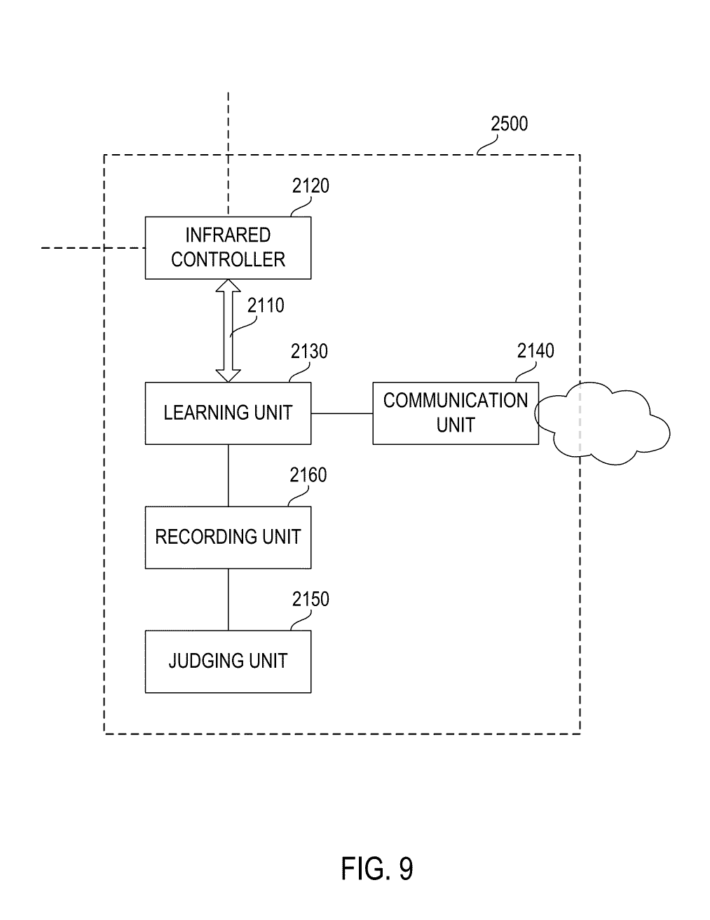

FIG. 9 illustrates a block diagram of an example of a remote control learning device 2500, of which a portable device 2100 is configured to remotely control a specific device 2300, in accordance with an embodiment of the present teaching. FIG. 9 may be described in combination with FIG. 7.

As shown in FIG. 9, the remote control learning device 2500 includes an infrared controller 2120, a learning unit 2130, and a communication unit 2140. The infrared controller 2120 receives a first infrared signal generated by a remote controller 2200 of a specific device 2300 when a user operates the remote controller 2200. The infrared controller 2120 converts the first infrared signal to a first control signal in a specific form, e.g., an analog electrical signal. The learning unit 2130 is coupled to the infrared controller 2120, and extracts a first digital control file from the first control signal provided from the infrared controller 2120. The first digital control file can describe the content of the current operation on the remote controller 2200. The communication unit 2140 communicates with the server 2400 to determine if the first digital control file is stored in a database of the server 2400. If the communication unit 2140 determines that the first digital control file is stored in the database of the server 2400, the communication unit 2140 can download multiple digital control files relevant to the first digital control file from the database of the server 2400 to the portable device 2100.

In one embodiment, as shown in FIG. 9, the remote control learning device 2500 can also include a judging unit 2150 and a recording unit 2160. Thus, if the communication unit 2140 determines that the first digital control file is not stored in the database of the server 2400, the learning unit 2130 can generate a corresponding second control signal based on the first digital control file. The infrared controller 2120 converts the second control signal provided from the learning unit 2130 to a second infrared signal, and transmits it to the specific device 2300. Then, the judging unit 2150 may determine if the specific device 2300 responds to the second infrared signal correctly and timely. For example, the judging unit 2150 can determine if a reply, provided from the specific device 2300 in response to the second infrared signal, is received within a predetermined time since the transmitting of the second infrared signal. If the judging unit 2150 determines that the specific device 2300 responds to the second infrared signal correctly and timely (e.g., the judging unit 2150 determines that the reply provided from the specific device 2300 in response to the second infrared signal is received within the predetermined time), the recording unit 2160 can notify the user to input the device information of the remote controller 2200, and can record/store the input device information and the first digital control file into the portable device 2100 in a correlated manner. In addition, the communication unit 2140 can send the input device information and the first digital control file to the server 2400 in an associated manner to update the database of the server 2400 in real time. As used herein, “in an associated manner” means that device information and a digital control file associated with (or correlated with) the device information are sent to a server in such a manner that a database of the server can store the device information and the digital control file in the above mentioned “correlated manner”.

In one embodiment, the portable device 2100 can have an audio jack, e.g., a phone jack, and the infrared controller 2120 can transfer the first and second control signals via an audio channel 2110 and the learning unit 2130. The first and second control signals can be analog electrical signals transferred via the audio channel 2110. Thus, the cost for configuring the portable device to act as a remote controller can be reduced.

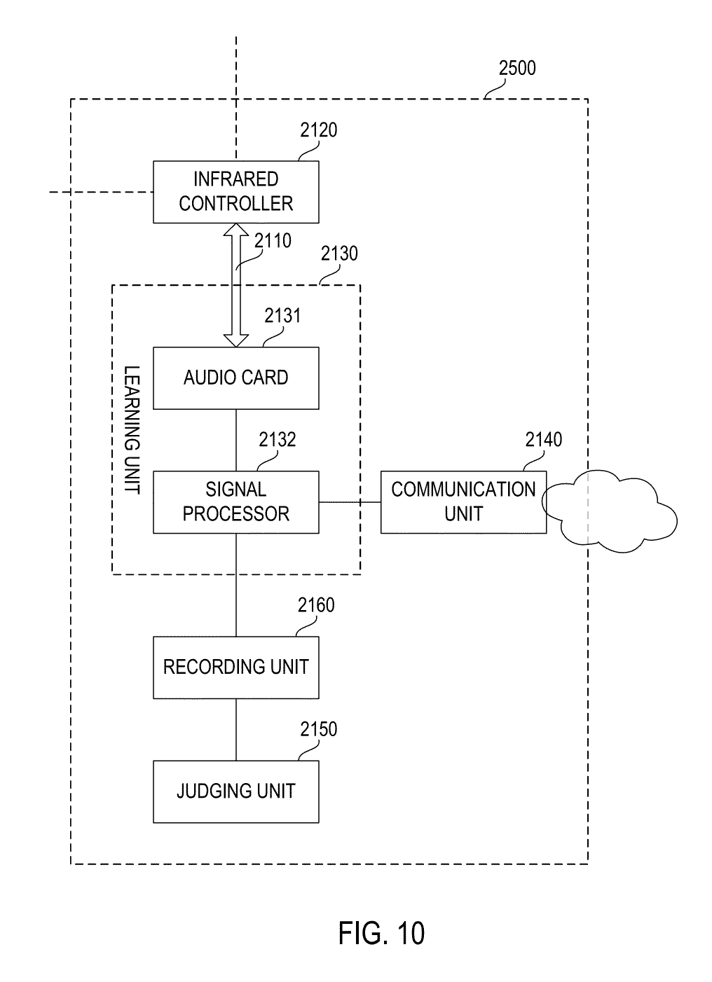

FIG. 10 illustrates a block diagram of an example of a remote control learning device 2500, of which a portable device 2100 is configured to remotely control a specific device 2300, in accordance with an embodiment of the present teaching. FIG. 10 may be described in combination with FIG. 7 and FIG. 9.

As shown in FIG. 10, the learning unit 2130 includes an audio card 2131 and a signal processor 2132. In one embodiment, the audio card 2131 converts a first control signal, in the form of an analog electrical signal, to a digital audio signal. The signal processor 2132 may analyze and decode the digital audio signal to obtain a first digital control file including information of the current operation made by the remote controller 2200. In another embodiment, the signal processor 2132 encodes the first digital control file to obtain a corresponding digital audio signal, and the audio card 2131 converts the digital audio signal to a second control signal to be transferred to an infrared controller 2120 via an audio channel 2110. In addition, the recording unit 2160 may store digital audio signals in the portable device 2100, where the digital audio signals are generated by the signal processor 2132. The signal processor 2132 may encode all the digital control files that are downloaded by the communication unit 2140 from a server 2400.

In some embodiments, the functional modules of the above-mentioned remote control learning device 2500, e.g., the learning unit 2130, the communication unit 2140, the judging unit 2150, the recording unit 2160, and the infrared controller 2120 etc., can be implemented as software modules, hardware modules or their combinations. Moreover, the existing functional modules of the portable device 2100 can also be used in the implementation. For example, an audio card inside the portable device 2100 can be implemented to be the audio card 2131 in the learning unit 2130; a processor inside the portable device 2100 can be implemented to be the judging unit 2150; the signal processor 2132 of the learning unit 2130 and/or a network communication module inside the portable device 2100 can be implemented to be the communication unit 2140.

One of ordinary skill in the art will understand that the whole or part of the flowchart in FIG. 8 can be implemented by relevant hardware under the instruction of computer programs. The computer programs can be stored in a non-transitory machine-readable storage medium such as magnetic disc, optical disc, or Read-Only Memory (ROM). When the programs are executed, the procedures in the embodiments mentioned above can be executed.

Some embodiments according to the present teaching also provide a learning remote control apparatus that can determine whether the learning remote control apparatus is located within a proper learning area. The learning remote control apparatus includes a receiving unit, a monitoring unit, a prompt output unit, and a decoding unit. The receiving unit receives a first infrared signal from a target device in a learning mode, and converts the first infrared signal to an electrical signal. The monitoring unit monitors the strength of the electrical signal. The prompt output unit outputs a first prompt signal to indicate that the learning remote control apparatus is located within a proper learning area if the strength of the electrical signal is greater than or equal to a predetermined threshold. The decoding unit decodes the electrical signal to obtain an encoding rule of the first infrared signal if the strength of the electrical signal is greater than or equal to the predetermined threshold.

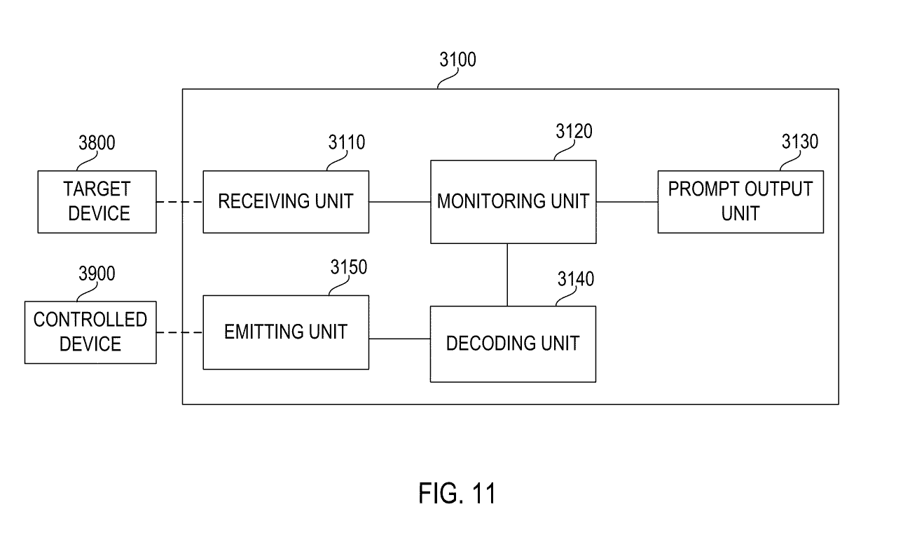

FIG. 11 illustrates a block diagram of an example of a learning remote control apparatus 3100, in accordance with an embodiment of the present teaching.

As shown in FIG. 11, the learning remote control apparatus 3100 includes a receiving unit 3110, a monitoring unit 3120, a prompt output unit 3130, a decoding unit 3140, and an emitting unit 3150.

In one embodiment, the learning remote control apparatus 3100 selectively operates in a learning mode or a control mode. The receiving unit 3110, the monitoring unit 3120, the prompt output unit 3130, and the decoding unit 3140 all operate in the learning mode. The emitting unit 3150 operates in the control mode.

The learning remote control apparatus 3100 may include at least one predetermined key which is similar to a key of a common remote controller. In one embodiment, the predetermined key of the learning remote control apparatus 3100 can be a physical key mounted on the learning remote control apparatus 3100 or a virtual key displayed on a touch screen of the learning remote control apparatus 3100. When the learning remote control apparatus 3100 is in the learning mode, a predetermined key of the learning remote control apparatus 3100 can be configured to act as a corresponding key of the common remote controller based on a learning process if the predetermined key is pressed. After the learning process, the predetermined key of the learning remote control apparatus 3100 can have a learned function of, e.g., turning on or off a specific controlled object or switching channels of the specific controlled object. Therefore, in the control mode, if the predetermined key is pressed after the learning, the predetermined key can generate and emit an infrared signal by utilizing a result of the learning, so as to control the controlled object accordingly.

In one embodiment, when the learning remote control apparatus 3100 is in the learning mode, a predetermined key A is pressed to await a first infrared signal from a target device 3800. The target device 3800 can be a common remote controller such as an infrared remote controller for a television, an air-conditioner, or the like.

After receiving the first infrared signal, the receiving unit 3110 can convert the first infrared signal to a corresponding electrical signal by photoelectric conversion. Then, the monitoring unit 3120 can monitor the strength of the electrical signal.

If the strength of the electrical signal is greater than or equal to a predetermined threshold, the prompt output unit 3130 may output a first prompt signal. The first prompt signal can indicate that the learning remote control apparatus 3100 is located in a proper learning area, because the electrical signal is strong enough to make the learning successful. The first prompt signal can also notify the user to finish the learning in the current position, because with the current position, the user can have the learning remote control apparatus 3100 located in a proper learning area.

In one embodiment, if the strength of the electrical signal is greater than or equal to the predetermined threshold, the decoding unit 3140 can decode the electrical signal correctly.

For example, if the strength of the electrical signal is greater than or equal to a strength reference P_{T}, the electrical signal can be correctly decoded, e.g., the electrical signal can be decoded and a result of the decoding is correct. If the strength of the electrical signal is less than the strength reference P_{T}, the electrical signal cannot be correctly decoded, e.g., the electrical signal cannot be decoded or the electrical signal can be decoded but a result of the decoding is wrong. In one embodiment, the predetermined threshold can have an arbitrary value that is greater than or equal to the strength reference P_{T}. In one embodiment, the predetermined threshold is set to be the strength reference P_{T}.

In one embodiment, the predetermined threshold is set to be −50 dpm (disintegrations per minute). If the strength of the electrical signal is greater than or equal to −50 dpm, the electrical signal can be correctly decoded.

In one embodiment, the first prompt signal includes at least one signal of a first audio signal and a first visual signal. The first visual signal can be an optical signal, e.g., a continuous light signal and/or a green light signal, emitted from an LED (light-emitting diode). The first visual signal can also be a picture and/or a text message, e.g., a smile image and/or a “correct” message, displayed on a screen of the learning remote control apparatus 3100.

In one embodiment, the first audio signal can be a prompt tone that lasts for a first predetermined time interval, e.g., a “beep” tone that lasts for three seconds.

Furthermore, if the strength of the electrical signal in this embodiment is greater than or equal to the predetermined threshold, the decoding unit 3140 may decode the electrical signal so as to obtain an encoding rule of the electrical signal. Thus, the learning for the predetermined key A may be finished by associating the obtained encoding rule with the predetermined key A. As to other keys of the learning remote control apparatus 3100, learning methods for the other keys may be similar to the learning method for the predetermined key A.

As shown in FIG. 11, the emitting unit 3150 is configured for emitting an infrared signal in the control mode based on the learning result, e.g., the learned encoding rule obtained in the learning mode. The infrared signal can be used to control a corresponding controlled device 3900. The controlled device 3900 can be a household appliance, e.g., a television, an air-conditioner, etc. The target device 3800 can be a common infrared remote controller that is used to control the controlled device 3900. In one embodiment, the emitting unit 3150 of the learning remote control apparatus 3100 as shown in FIG. 11 has a similar structure and similar functions to an emitting unit of a regular learning remote controller, and can obtain a similar technical effect.

In one embodiment, if the strength of the electrical signal monitored by the monitoring unit 3120 is less than the predetermined threshold, the prompt output unit 3130 outputs a second prompt signal indicating that the learning remote control apparatus 3100 is located outside the above mentioned proper area. The second prompt signal can notify a user that the current position is not suitable or not easy for learning, and that the user should change the position. The user can change to another position according to the prompt signal, and press the predetermined key A to repeat the learning process. The user can adjust the position of the learning remote control apparatus 3100 until the strength of the electrical signal is greater than or equal to the predetermined threshold.

The second prompt signal can include at least one signal of a second audio signal and a second visual signal. Similar to the first visual signal, the second visual signal can be an optical signal, e.g., a flashing signal and/or a red light signal, emitted from a common LED. The second visual signal can also be a picture and/or a text message, e.g., a sad expression image and/or a “wrong” message, displayed on the above mentioned screen of the learning remote control apparatus 3100.

In one embodiment, the second audio signal can be a prompt tone that continues for a second predetermined time interval. The second predetermined time interval can be greater than the first predetermined time interval, or less than the first predetermined time interval. In one embodiment, the second predetermined time interval is less than the first predetermined time interval. For example, the first prompt signal can be a “beep” tone that lasts for three seconds, and the second prompt signal can be a “beep” tone that lasts for half second.

In one embodiment, a user uses the learning remote control apparatus 3100 comprising the receiving unit 3110, the monitoring unit 3120, the prompt output unit 3130, and the decoding unit 3140 to perform a learning process with regard to a key of the target device 3800, such that a predetermined key A of the learning remote control apparatus 3100 is configured for controlling the controlled device 3900, e.g., a predetermined television. When the learning remote control apparatus 3100 is in the control mode, if the predetermined key A is pressed, the emitting unit 3150 can generate a second infrared signal based on the encoding rule associated with the predetermined key A and emit the second infrared signal to control, e.g., turn on, the predetermined television.

If a user uses a conventional learning remote controller to learn from a common remote controller, when the conventional learning remote controller receives an infrared signal to be learned, the conventional learning remote controller converts the infrared signal to an electrical signal, decodes the electrical signal, and determines whether the decoding is correct so as to determine whether the learning is successful. Thus, if there is a problem of the learning, e.g., a long distance or an obstacle between the conventional learning remote controller and the common remote controller, the user cannot be aware of the problem until the electrical signal is decoded. However, if the user uses a learning remote control apparatus according to the present teaching to perform the learning process, after converting the infrared signal to the electrical signal, the learning remote control apparatus may monitor the strength of the electrical signal to determine whether the electrical signal can be correctly decoded before decoding the electrical signal, so as to determine whether the learning is likely to be successful in a current learning position. Thus, the user can determine whether the learning remote control apparatus is located in a proper learning area by checking whether the remote control apparatus outputs a first prompt signal, and can quickly find a proper learning position if the current learning position is outside the proper learning area, so as to finish the learning process more quickly than a user using a conventional learning remote controller. Therefore, compared to the conventional learning remote controller, the learning remote control apparatus according to the present teaching can make the learning more efficient and more accurate.

An embodiment according to the present teaching also provides an electronic system that includes the above mentioned learning remote control apparatus. Therefore, the electronic system may have similar functions to the learning remote control apparatus.

In one embodiment, the electronic system or the learning remote control apparatus can be an electric device e.g., a cell phone, a tablet PC (personal computer), a multimedia playback device, a personal digital assistant, a game console, a computer, an electronic paper book, or the like.

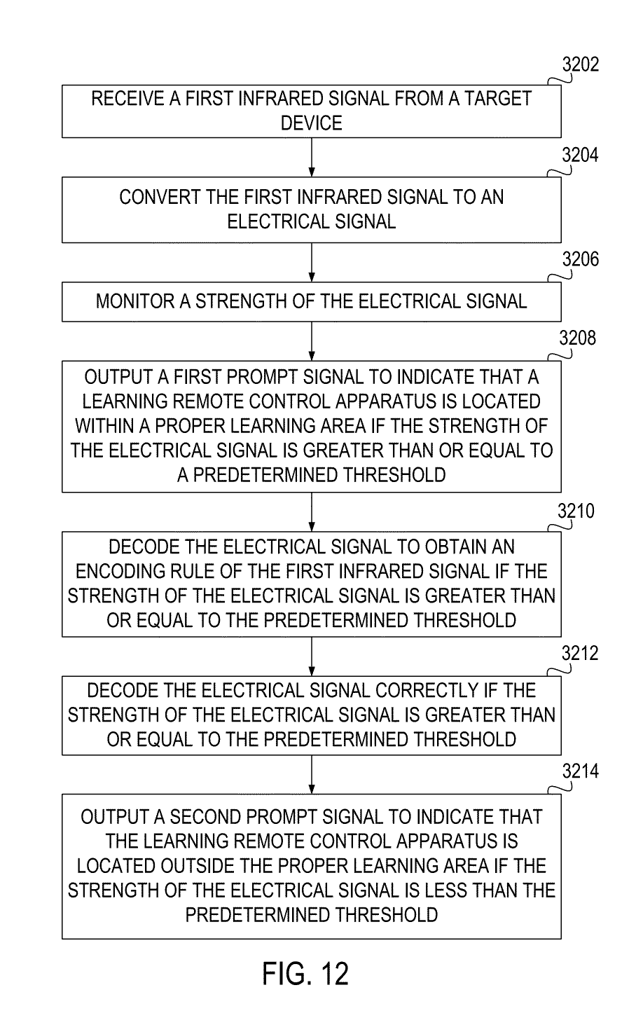

FIG. 12 is a flowchart illustrating examples of operations performed by a learning remote control apparatus 3100, in accordance with an embodiment of the present teaching. FIG. 12 may be described in combination with FIG. 11.

At 3202, the receiving unit 3110 of the learning remote control apparatus 3100 receives a first infrared signal from the target device 3800. At 3204, the receiving unit 3110 converts the first infrared signal to an electrical signal. At 3206, the monitoring unit 3120 of the learning remote control apparatus 3100 monitors the strength of the electrical signal. At 3208, if the strength of the electrical signal is greater than or equal to a predetermined threshold, the prompt output unit 3130 of the learning remote control apparatus 3100 outputs a first prompt signal (e.g., the above mentioned first prompt signal) to indicate that the learning remote control apparatus 3100 is located within a proper learning area. At 3210, if the strength of the electrical signal is greater than or equal to the predetermined threshold, the decoding unit 3140 of the learning remote control apparatus 3100 decodes the electrical signal to obtain an encoding rule of the first infrared signal.

In one embodiment, as depicted at 3212, the decoding unit 3140 decodes the electrical signal correctly if the strength of the electrical signal is greater than or equal to the predetermined threshold.

In addition, as depicted at 3214, if the strength of the electrical signal is less than the predetermined threshold, the prompt output unit 3130 of the learning remote control apparatus 3100 outputs a second prompt signal (e.g., the above mentioned second prompt signal) to indicate that the learning remote control apparatus 3100 is located outside the proper learning area.

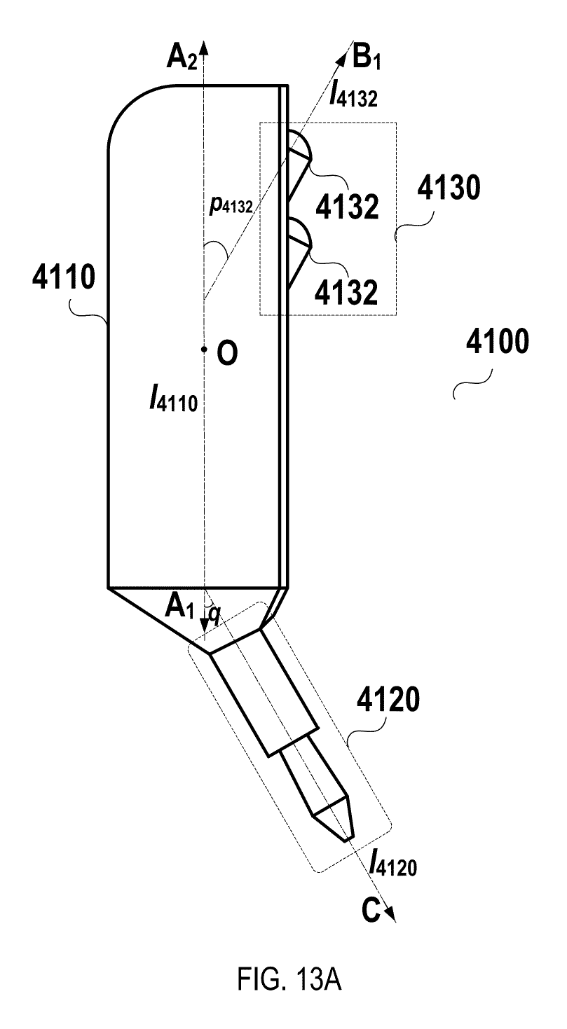

Some embodiments according to the present teaching provide an apparatus for infrared control. The apparatus can adapt to different user locations and/or gestures. FIG. 13A and FIG. 13B illustrate structure diagrams of an infrared apparatus 4100 which can be attached to a first electronic device (not shown in FIGS. 13A and 13B), in accordance with an embodiment of the present teaching. The infrared apparatus 4100 can control a second electronic device in response to commands from the first electronic device. As shown in FIG. 13A, the infrared apparatus 4100 includes a body 4110, an inserting portion 4120, and an infrared transceiving unit 4130. The inserting portion 4120 is located at one end of the body 4110. The infrared transceiving unit 4130 is on the body 4110 and located at the other end of the body 4110.

In one embodiment, the body 4110 includes a circuit coupled to the inserting portion 4120. In the example of FIG. 13A, the infrared transceiving unit 4130 includes an emitting unit 4132 coupled to the circuit. The emitting unit is configured for emitting infrared signals.

The inserting portion 4120 can be inserted into a socket of the first electronic device (not shown in FIGS. 13A and 13B) for physically and electrically coupling the infrared apparatus to the first electronic device. As such, the circuit can receive a first electrical signal from the first electronic device via the inserting portion and accordingly the emitting unit 4132 can emit a first infrared signal in response to the first electrical signal. In one embodiment, in response to the same first electrical signal, the first infrared signal can be different depending on different applications for controlling different electronic devices, such as televisions or air conditioners.

The socket of the first electronic device in one embodiment can have an interface with any suitable shapes, such as a round shape. For example, the socket can be a 3.5 mm headphone jack. If the socket has an interface with a round shape, the infrared transceiving unit 4130 can rotate along a first axis if the inserting portion 4120 is inserted into the socket of the first electronic device. The inserting portion 4120 can be a rotating body which is formed by rotating a two-dimensional shape along an axis. The rotating body can be, but not limited to, a cone or a cylinder. In one embodiment, the inserting portion 4120 is fixed at the body 4110. Therefore, the rotation of the inserting portion 4120 in the socket can cause the rotation of the body 4110 and can further cause the rotation of the infrared transceiving unit 4130. As such, the infrared transceiving unit 4130 can rotate along the first axis (e.g., the axis of the inserting portion 4120). The size of the inserting portion 4120 can be determined, based on the inner diameter of the socket, such that the socket can hold the inserting portion 4120 and the inserting portion 4120 can rotate in the socket.

Sometimes the first electronic device may be physically confined so that it is difficult or even impossible to change its position or orientation. Furthermore, sometimes, due to device locations, it may be physically awkward for a user to adjust the gesture in order to effectively control a device using an infrared remote control. In such situations, the user can rotate the insertion portion 4120 to change the emitting direction of an emitted infrared signal of the emitting unit 4132, such that the emitting direction can be aligned with a receiving direction by which an infrared port of the target device (e.g., a television) receives the infrared signal. Alternatively, the user can rotate the insertion portion 4120 to change the emitting direction, such that an angle between the emitting direction and the receiving direction can be maintained within a predetermined range. Therefore, the infrared communication can be successfully performed without changing the gesture of the user or the position of first electronic device.

In the example of FIG. 13A, the inserting direction C of the inserting portion 4120 can coincide with the axis I₄₁₂₀ of the inserting portion 4120. In other words, the inserting direction C is an extending direction of the axis I₄₁₂₀. The axis I₄₁₁₀ of the body 4110 has a first extending direction A₁ and a second extending direction A₂. The first extending direction A₁ is a direction from a center point O of the axis I₄₁₁₀ to the end of the body 4110 that is close to the inserting portion 4120. The second extending direction A₂ is a direction from the center point O of the axis I₄₁₁₀ to the other end of the body 4110 that is away from the inserting portion 4120. In other words, the first direction A₁ is opposite to the second direction A₂.

In one embodiment, the angle q between the first direction A₁ and the inserting direction C can be within 0°˜90°, for example, within 0°˜30°. The angle q can be set based on user preference or empirical value. If the angle q is set with a specific value qₓ, the axis I₄₁₂₀ of the inserting portion 4120 can have multiple possible positions. The axis I₄₁₂₀ can coincide with any generatrix of a conical surface which has the axis I₄₁₁₀ as the center line and the angle between a generatrix and the center line is qₓ. FIG. 13B shows a possible position of the axis I₄₁₂₀.

In one embodiment, the emitting unit 4132 may emit infrared signals to an emission direction B₁, for example, the direction of the optical axis I₁₃₂ of the emitting unit 4132. An angle p₄₁₃₂ between the direction B₁ and A₂ can be within 30°˜120° or about 60°.

In one embodiment, the angle q and the angle p₄₁₃₂ can be set that the infrared apparatus 4100 can successfully communicate with the target device (e.g., a television). In other words, the user can adjust the angle q and the angle p₄₁₃₂ associated with the infrared apparatus 4100, such that the emitting direction of an emitted infrared signal of the emitting unit 4132 can be aligned with a receiving direction by which an infrared port of the target device (e.g., a television) receives the infrared signal, or an angle between the emitting direction and the receiving direction can be maintained within a predetermined range. Therefore, the infrared communication can be successfully performed without changing the position and/or orientation of the first electronic device.

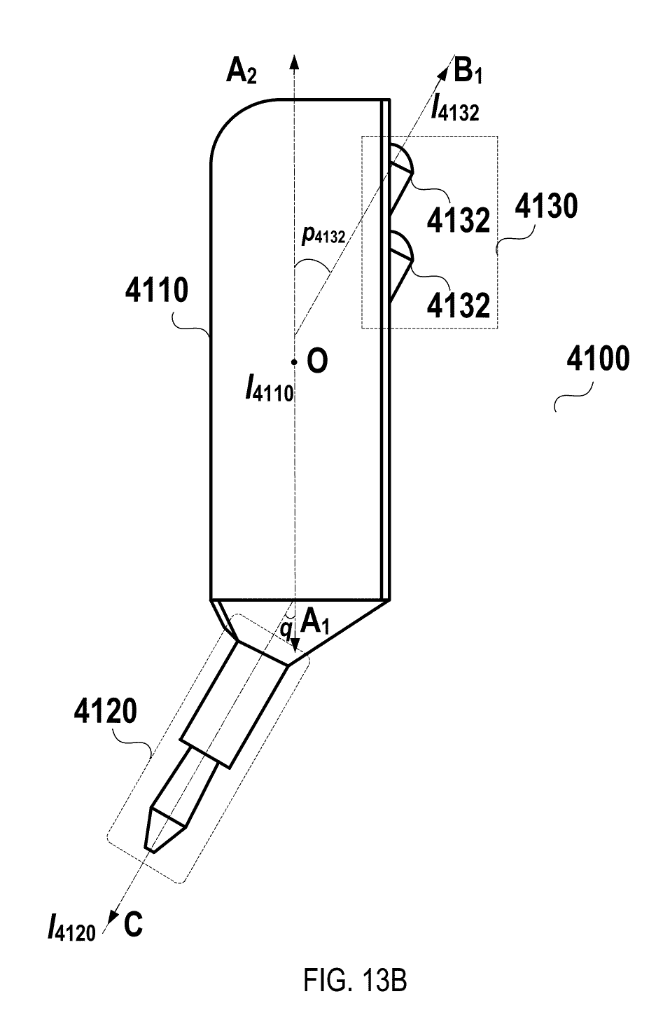

Furthermore, in one embodiment, the angle p₄₁₃₂ is adjustable. For example, the emitting unit 4132 can be coupled to the body 4110 in a detached manner (e.g., coupled by screw bolt) and the emitting unit 4132 can rotate near the surface of the body 4110 along an axis to adjust the angle p₄₁₃₂. FIG. 14A and FIG. 14B illustrate schematic diagrams of an infrared transceiving unit of an infrared apparatus, in accordance with an embodiment of the present teaching. For example, in FIG. 14A, the angle p₄₁₃₂ is 30°. The user can rotate the emitting unit 4132 along an axis to adjust the angle p₄₁₃₂ to 120°, as shown in FIG. 14B. The examples in FIG. 14A and FIG. 14B are for illustrative purpose rather than for limitation. The angle, position, and size of each component of the infrared apparatus 4100 can be different in different applications.

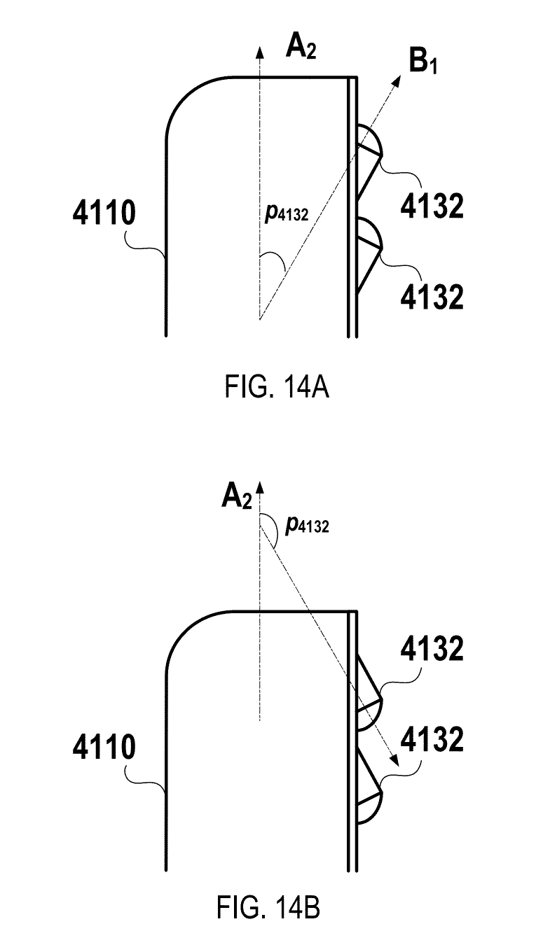

FIG. 15 illustrates a structure diagram of an infrared apparatus 4300, in accordance with an embodiment of the present teaching. Elements that are labeled with the same numerals in FIGS. 13A, 13B, and 15 may have similar functions. In addition to the emitting unit 4132, the infrared transceiving unit 4130 of the infrared apparatus 4300 may further include a receiving unit 4134 that is configured for receiving a second infrared signal remotely from a second electronic device (e.g., a television or an air conditioner). The circuit may be configured for generating a second electrical signal in response to the second infrared signal. The second electrical signal can be transmitted to the first electronic device (e.g., a mobile phone) via the inserting portion 4120. In operation, the user can rotate the inserting portion 4120 to adjust a receiving direction of the receiving unit 4134. For example, the receiving direction of the receiving unit 4134 (e.g., a normal direction of a surface of the receiving unit 4134) is B₂. In one embodiment, the receiving direction B₂ is the same as the direction of the axis I₄₁₃₄ of the receiving unit 4134. An angle p₄₁₃₄ between the direction B₂ and A₂ can be adjustable. The angle p₄₁₃₄ can be within 30°˜120°, for example, about 60°.

In one example, the angle q and the angle p₄₁₃₄ can be set so that the infrared apparatus 4100 can successfully receive the second infrared signal from the second electronic device. In other words, the user can adjust the angle q and the angle p₄₁₃₄ associated with the infrared apparatus 4100 such that a receiving direction by which the receiving unit 4134 receives an infrared signal can be aligned with an emitting direction of an infrared signal emitted from an infrared port of the second electronic device or an angle between the receiving direction and the emitting direction can be maintained with a predetermined range. Therefore, the infrared communication can be successfully performed without changing the position and/or orientation of the first electronic device. In one embodiment, similar to the angle p₄₁₃₂, the angle p₄₁₃₄ is adjustable.

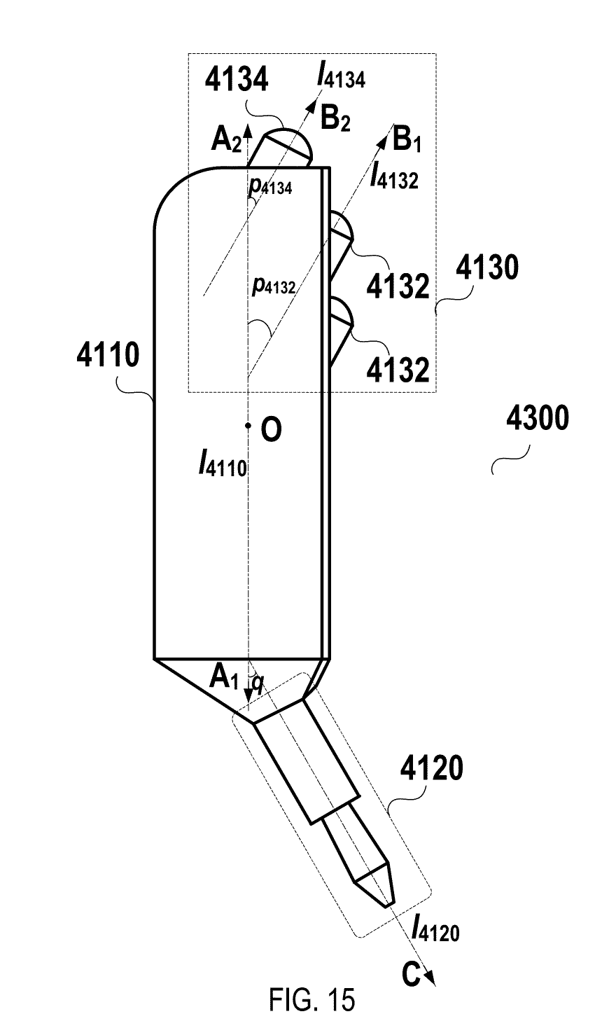

FIG. 16A and FIG. 16B are illustrative diagrams showing the infrared apparatus in FIG. 15 attached to a mobile phone 4900, in accordance with an embodiment of the present teaching. In the examples of FIGS. 16A and 16B, the inserting portion 4120 (shown in FIG. 15) is inserted into a headphone jack located on the top of the mobile phone 4900. The axis I₄₁₂₀ of the inserting portion 4120 is shown by a dashed line. As described above, if the inserting portion 4120 is inserted into the headphone jack, the circuit in the body 4110 may be electrically coupled to the headphone jack to establish signal transmission between the infrared apparatus 4300 and the mobile phone 4900. If the user rotates the body 4110 along the axis I₄₁₂₀ of the inserting portion 4120, the infrared transceiving unit 4130 may also rotate along the axis I₄₁₂₀. According to one embodiment of the present teaching, the emitting unit 4132 (shown in FIG. 15) can include at least one infrared light emitting diode (infrared LED) and the receiving unit 4134 (shown in FIG. 15) can include at least one infrared photodiode.

As shown in FIGS. 14A, 14B, 16A and 16B, if the angle p₄₁₃₂ is adjustable, the emitting direction of the emitting unit 4132 can have two degrees of freedom. For example, the emitting unit 4132 can rotate along the axis I₄₁₂₀ of the inserting portion 4120. On the other hand, the emitting unit 4132 can rotate along an axis through a joint point of the emitting unit 4132 and the body 4110. The first infrared signal emitted by the emitting unit 4132 can cover a relatively large space. The axis I₄₁₂₀ of the inserting portion 4120 and the axis I₄₁₃₂ of the emitting unit 4132 can be on a same plane or two different planes. In other words, if the axis I₄₁₂₀ and the axis I₄₁₁₀ determine a plain S1, and if the axis I₄₁₃₂ and the axis I₄₁₁₀ determine a plain S2, then the plain S1 can be parallel to the plain S2 or intersect with the plain S2.

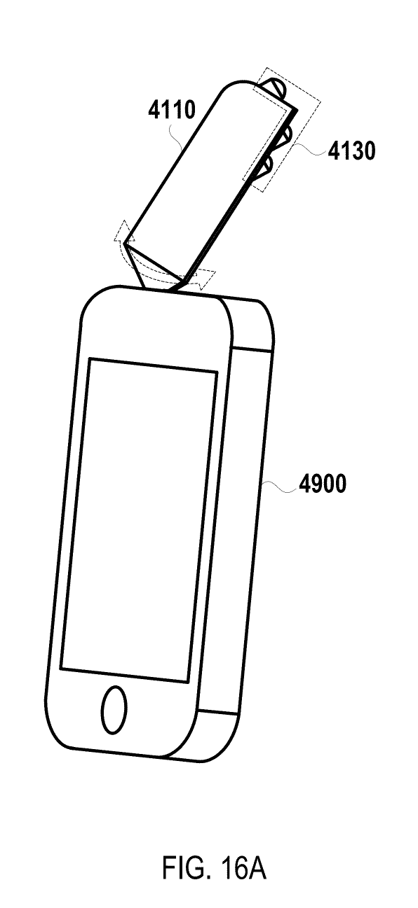

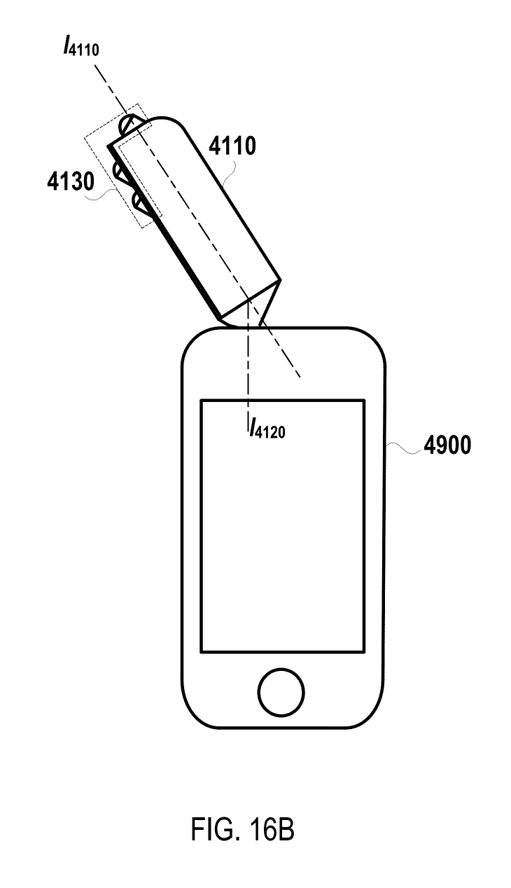

FIG. 17A is a schematic diagram of a circuit 4500 in an infrared apparatus, e.g., the infrared apparatus 4300 in FIG. 15, in accordance with an embodiment of the present teaching. The emitting unit 4132 in FIG. 15 can include a first infrared LED Led₁ and a second infrared LED Led₂. The receiving unit 4134 in FIG. 15 can include an infrared photodiode Led₃. In one example, the socket is a headphone jack of a mobile phone. The anode of the first infrared LED Led₁ is coupled to a left sound channel output terminal Lₒᵤₜ of the headphone jack. The cathode of the first infrared LED Led₁ is coupled to a right sound channel output terminal Rₒᵤₜ of the headphone jack. The anode of the second infrared LED Led₂ is coupled to the right sound channel output terminal Rₒᵤₜ of the headphone jack. The cathode of the second infrared LED Led₂ is coupled to the left sound channel output terminal Lₒᵤₜ of the headphone jack. The cathode of the infrared photodiode Led₃ is coupled to a microphone input terminal Mᵢₙ of the headphone jack. The anode of the infrared photodiode Led₃ is coupled to ground. The circuit 4500 can further include a first resistor R₁, a second resistor R₂, and a third resistor R₃. The first resister R₁ is coupled in series between the first infrared LED Led₁ and the left sound channel output terminal Lₒᵤₜ. The second resistor R₂ is coupled in series between the second infrared LED Led₂ and the right sound channel output terminal Rₒᵤₜ. The third resistor R₃ is coupled in parallel with the infrared photodiode Led₃. The ground terminal G of the headphone jack is coupled to ground.

In operation, the first infrared LED Led₁ can be driven by an audio signal output by the left sound channel output terminal Lₒᵤₜ. The second infrared LED Led₂ can be driven by an audio signal output by the right sound channel output terminal Rₒᵤₜ. The left sound channel output terminal Lout and the right sound channel output terminal Rₒᵤₜ can alternately output an audio signal. Accordingly, the first infrared LED Led₁ and the second infrared LED Led₂ can be lightened alternately. In one embodiment, the maximum frequency of the audio signal in one sound channel is 20 KHz. Through the alternately output method, the total output frequency for the two sound channels combined is 40 KHz. Therefore the first infrared signal generated by the circuit 500 can have a frequency of 40 KHz. The infrared photodiode Led₃ can receive a second infrared signal and convert the second infrared signal to a second electrical signal. The second electrical signal may be transmitted to the mobile phone through the microphone input terminal Mᵢₙ.

The circuit 4500 in FIG. 17A may have different configurations in other embodiments. For example, in one embodiment, the circuit 4500 can include a third and a fourth infrared LEDs that are coupled in parallel with the first infrared LED Led₁ and the second infrared LED Led₂, respectively. In another embodiment, the first infrared LED Led₁, the second infrared LED Led₂ and the infrared photodiode Led₃ are located within the body 4110 while other components of the circuit 4500 are located out of the body 4110.

FIG. 17B is a block diagram of a circuit 4500 in an infrared apparatus, in accordance with an embodiment of the present teaching. In the example of FIG. 17B, the circuit 4500 includes an auxiliary power source 4520 and an amplifier 4510. The amplifier 4510 is powered by the auxiliary power source 4520 and amplifies a first electrical signal received from a first electronic device. As a result, the first infrared signal generated by the emitting unit 4132 based on the first electrical signal is amplified. Even if the efficiency of the infrared LEDs in the emitting 4132 is relatively low, the auxiliary power source 4520 and the amplifier 4510 can increase the power of the infrared signal such that the infrared communication can be performed successfully.

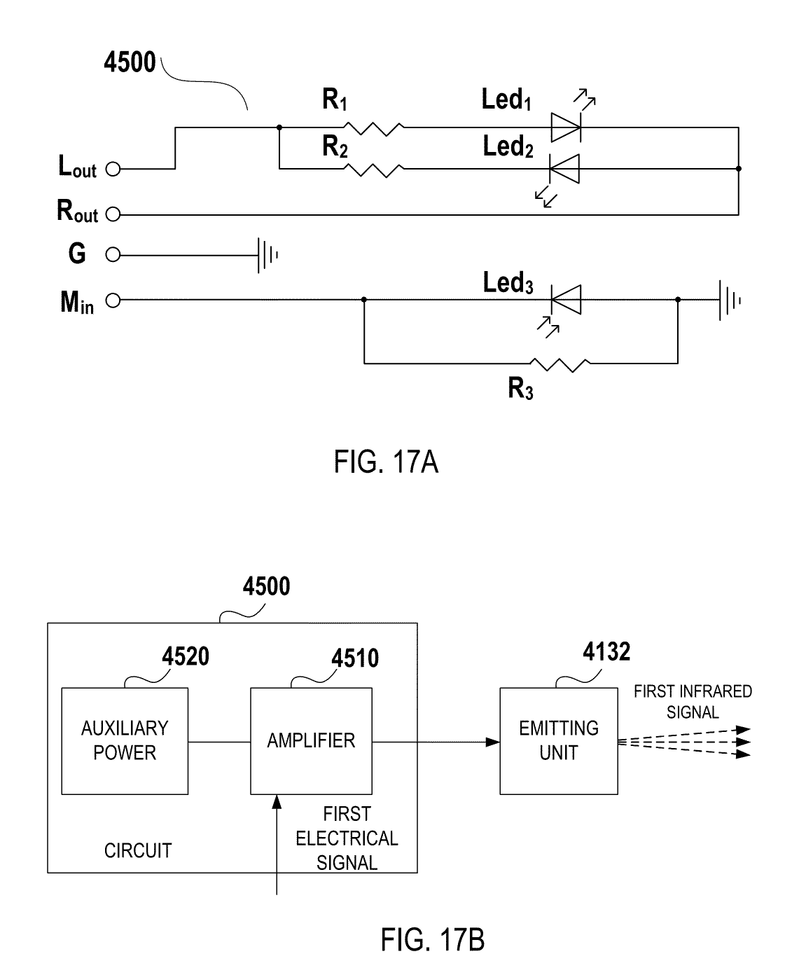

FIG. 18 is a structure diagram of an infrared apparatus 4600, in accordance with an embodiment of the present teaching. Elements that are labeled with the same numerals in FIGS. 15 and 18 may have similar functions. The infrared apparatus 4600 may further include a cover 4140 that covers the infrared transceiving unit 4130 (shown in FIG. 15). In one embodiment, the cover 4140 is configured for having a relatively high transmittance for the infrared light whose wavelength is within a predetermined range (e.g., 0.76˜1.5 μm). The cover 4140 is also configured for having a relatively low transmittance (e.g., near zero transmittance) for the infrared light whose wavelength is beyond the predetermined range. In other words, the cover 4140 can selectively pass through infrared light whose wavelength is within the predetermined range. The predetermined range can correspond to the wavelength of the infrared signals that are transmitted or received by the infrared transceiving unit 4130.

In an example that the infrared transceiving unit 4130 includes both an emitting unit 4132 (shown in FIG. 15) and a receiving unit 4134 (shown in FIG. 15), the cover 4140 can include two individual portions. A first portion Ls₁ of the cover 4140 covers the emitting unit 4132 and is configured for selectively passing through the first infrared signal having a wavelength W₁ emitted by the emitting unit 4132. A second portion Ls₂ of the cover 4140 covers the receiving unit 4132 and is configured for selectively passing through the second infrared signal having a wavelength W₂ received by the receiving unit 4134. The cover 4140 can filter undesired light which may interrupt the operation of the emitting unit 4132 and the receiving unit 4134.

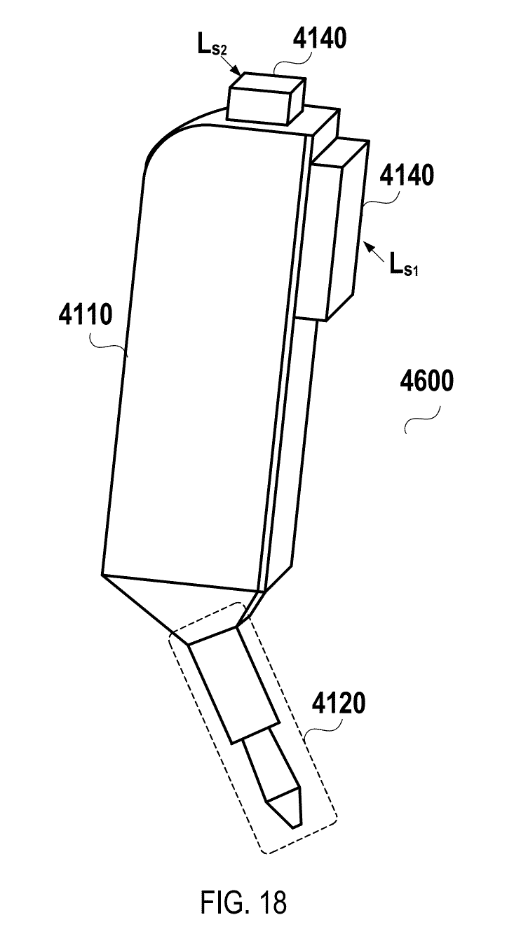

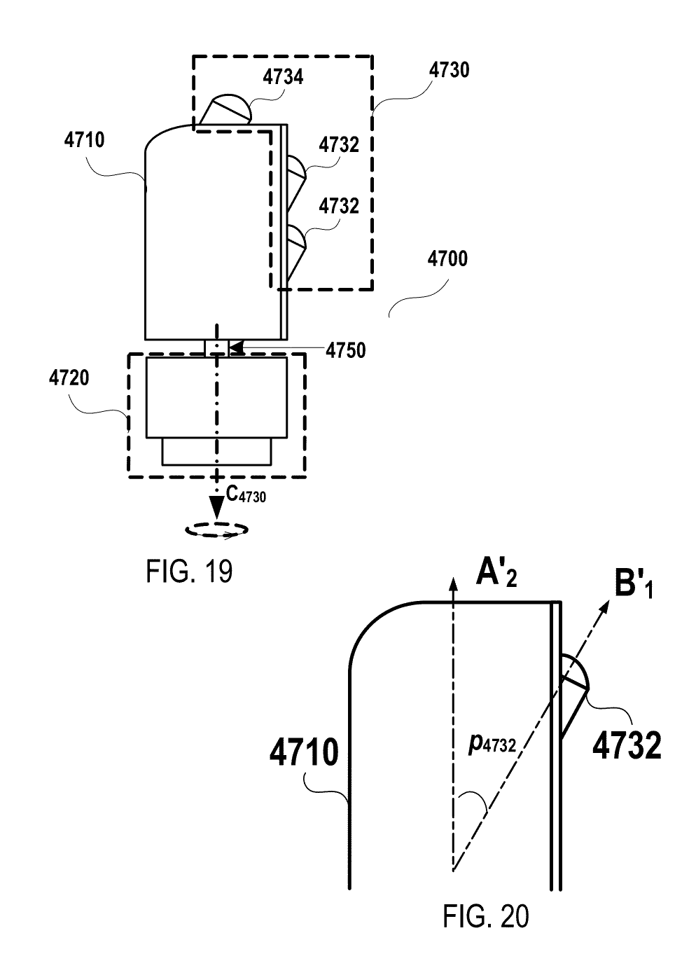

FIG. 19 is a structure diagram of an infrared apparatus 4700, in accordance with an embodiment of the present teaching. FIG. 20 is a schematic diagram of an emitting unit of an infrared apparatus, in accordance with an embodiment of the present teaching.

As shown in FIG. 19, the infrared apparatus 4700 includes a body 4710, an inserting portion 4720 and an infrared transceiving unit 4730. Different from the infrared apparatus in FIG. 13A to FIG. 16B that is designed to match a socket having an interface with a round shape, the infrared apparatus 4700 in FIG. 19 is designed to match a socket having an interface with a non-round shape. The inserting portion 4720 can be inserted into such a socket having an interface with a non-round shape (e.g., a USB receptacle or a dock interface of a mobile phone). The infrared apparatus 4700 may further include a connector 4750 that can connect the body 4710 and the inserting portion 4720 and can enable the body 4710 to rotate along a second axis with respect to the inserting portion 4720. The second axis can be an inserting direction C₄₇₃₀ of the inserting portion 4720. Accordingly, the infrared transceiving unit 4730 can also rotate along the second axis. In one embodiment, the infrared transceiving unit 4730 can only include an emitting unit 4732. In another embodiment, in addition to the emitting unit 4732, the infrared transceiving unit 4730 can further include a receiving unit 4734. The emitting unit 4132 may emit infrared signals to a direction B′₁. The axis of the body 4710 may have an extending direction A′₂. An angle p₄₇₃₂ between the direction B′₁ and A′₂ can be within 0°˜180° and is adjustable. If the infrared transceiving unit 4730 includes the receiving unit 4734, an angle between a receiving direction by which the receiving unit 4734 receives an infrared signal (e.g., a normal direction of a surface of the receiving unit 4734) and the direction A′₂ is adjustable.

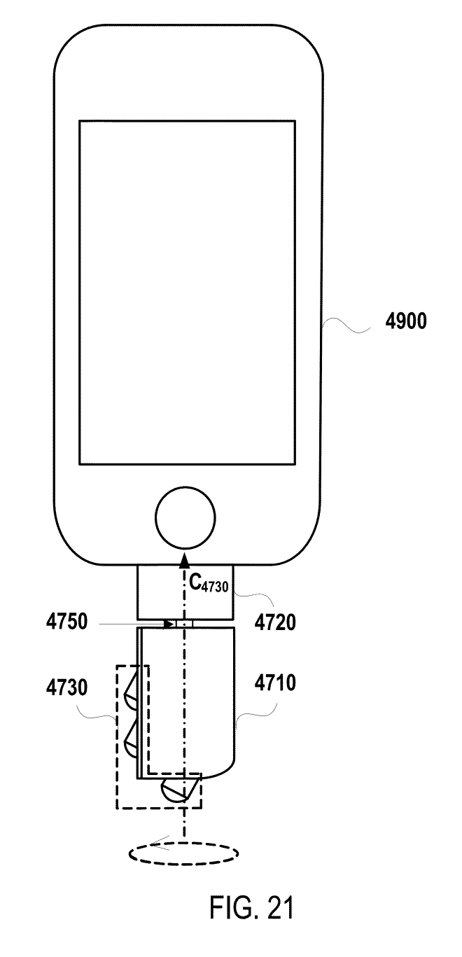

FIG. 21 is an illustrative diagram showing an infrared apparatus attached to an electronic device (e.g., a mobile phone 4900), in accordance with an embodiment of the present teaching. Elements that are labeled with the same numerals in FIGS. 19-21 may have similar functions. In the example of FIG. 21, the infrared apparatus is attached to the mobile phone 4900 through a socket having an interface with a non-round shape. As shown in FIG. 21, even though the inserting portion 4720 cannot rotate in the socket, the connector 4750 can enable the body 4710 of the infrared apparatus to rotate along an axis (e.g., the inserting direction C₄₇₃₀). Accordingly, the infrared transceiving unit 4730 can also rotate along the axis. As such, the emitting/receiving direction of the infrared transceiving unit 4730 can be aligned with a receiving/emitting direction of an infrared port of the target device (e.g., a television). Therefore, the infrared communication can be successfully performed without changing the position and/or orientation of the electronic device.

Some embodiments of the present teaching provide infrared apparatus for infrared remote control. The infrared apparatus can be attached to an electronic device. The infrared apparatus or at least a portion of the infrared apparatus can rotate along an axis such that the emitting/receiving direction can be adjusted in a relatively large range. Therefore, the infrared communication is more likely to succeed.

Some embodiments according to the present teaching provide systems and methods for remotely controlling an appliance and identifying a type of the appliance.

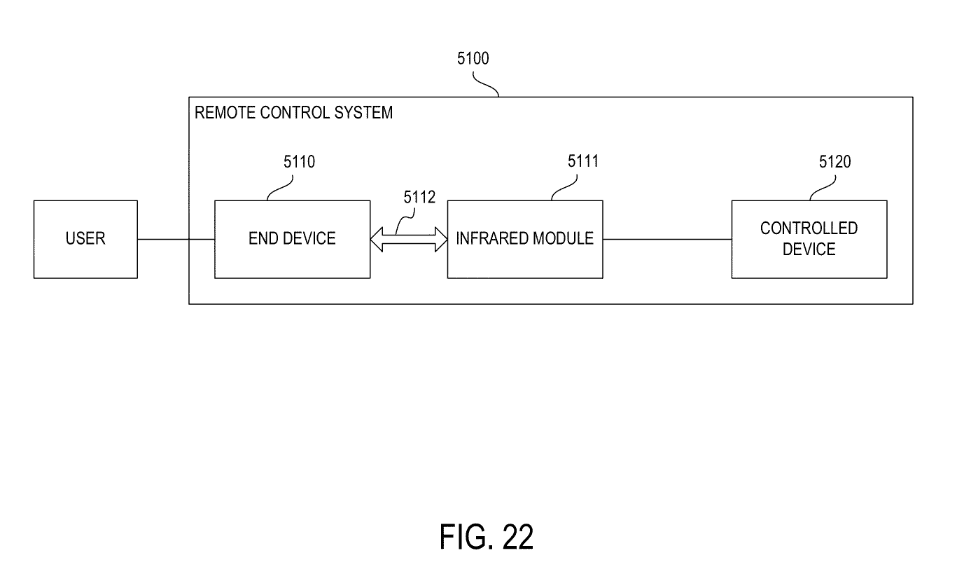

FIG. 22 illustrates a structure diagram of a remote control system 5100 using an end device 5110 to control a controlled device 5120, in accordance with an embodiment of the present teaching.

As shown in FIG. 22, one embodiment of the remote control system 5100 includes the end device 110 and the controlled device 5120. The end device 5110, as a remote controlling subject, may include, but not limited to, a smart phone, a personal digital assistant (PDA), or a tablet computer. The controlled device 5120, as a remote controlling object for the end device 5110, may include, but not limited to, a television, an air-conditioner or other home appliances.

In the remote control system 5100, the end device 5110 establishes a signal connection with the controlled device 5120 via an infrared module 5111, and transmits an infrared signal as a command to the controlled device 5120, as shown in FIG. 22. In one embodiment, the infrared module 5111 operates as a component of the end device 5110. That is, the end device 5110 includes the infrared module 5111. In another embodiment, the infrared module 5111 can be a separate device installed on the end device 5110. That is, the end device 110 and the infrared module 5111 are two separate devices.

In one embodiment, as the end device 5110 generally includes an audio channel, e.g., a headphone jack, the infrared module 5111 is connected to the headphone jack of the end device 5110 so as to establish the signal connection with the end device 5110 via an audio channel 5112. Thus, the infrared module 5111 converts the control signal, which is an analog signal and transferred through the audio channel 5112, to the infrared signal. The infrared module 5111 may then send the infrared signal to the controlled device 5120. However, it can be understood by a person skilled in the art that such description of the infrared module 5111 connecting to the headphone jack of the end device 5110 is for illustrative purpose only and does not intend to limit the scope of the present teaching. It is understood that the infrared module 5111 may be connected to other components of the end device 5110, which can be used to transfer the analog signal in the present teaching, such as but not limited to, a charging jack.

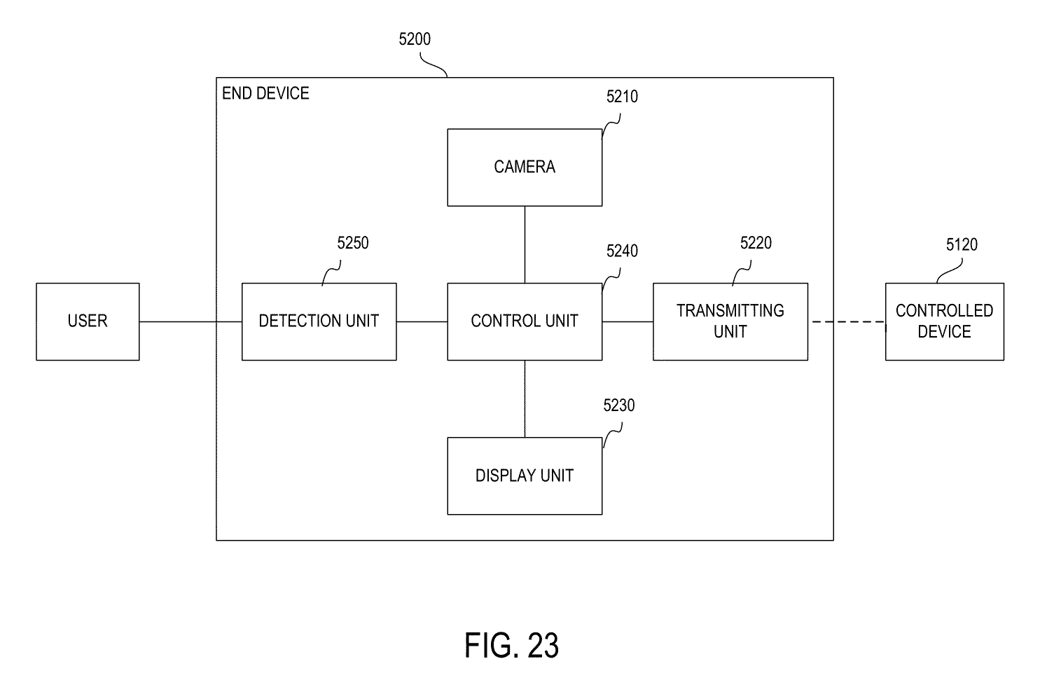

FIG. 23 illustrates a block diagram of an end device 5200, in accordance with an embodiment of the present teaching. Elements that are labeled with the same numerals in FIGS. 22-23 may have similar functions. As shown in FIG. 23, the end device 5200 includes a camera 5210, a transmitting unit 5220, a display unit 5230, a control unit 5240, and a detection unit 5250.

The camera 5210 can be a camera built in the end device 5200, which is configured for taking images. The camera 5210, coupled to the control unit 5240, takes images and provides the taken images to the control unit 5240 for processing. For example, the control unit 5240 sets a taken image as a background image of an interface.

The transmitting unit 5220, coupled to controlled device 5120 and the control unit 5240, is configured for transmitting the control signal to the controlled device 5120 according to the control unit 5240. For example, the transmitting unit 5220 converts an operating instruction for the controlled device 5120 from the control unit 5240 into the control signal, which are transmitted, e.g., wirelessly, to the controlled device 5120. The controlled device 5120 makes an expected response once the control signal is received. Thus, the end device 5200 can be configured for controlling the controlled device 5120 remotely.

The display unit 5230, coupled to the control unit 5240, is configured for displaying images (e.g., user interface) under control of the control unit 5240. For example, at the initialization of the remote controlling, the display unit 5230 displays a type acquiring interface, which helps the end device 5200 to acquire the type of the controlled device 5120. Thus, the end device 5200 can transmit the control signal. The controlled device 5120 can receive the control signal and respond according to the type of the controlled device 5120. In one embodiment, the display unit 5230 is a touch display.

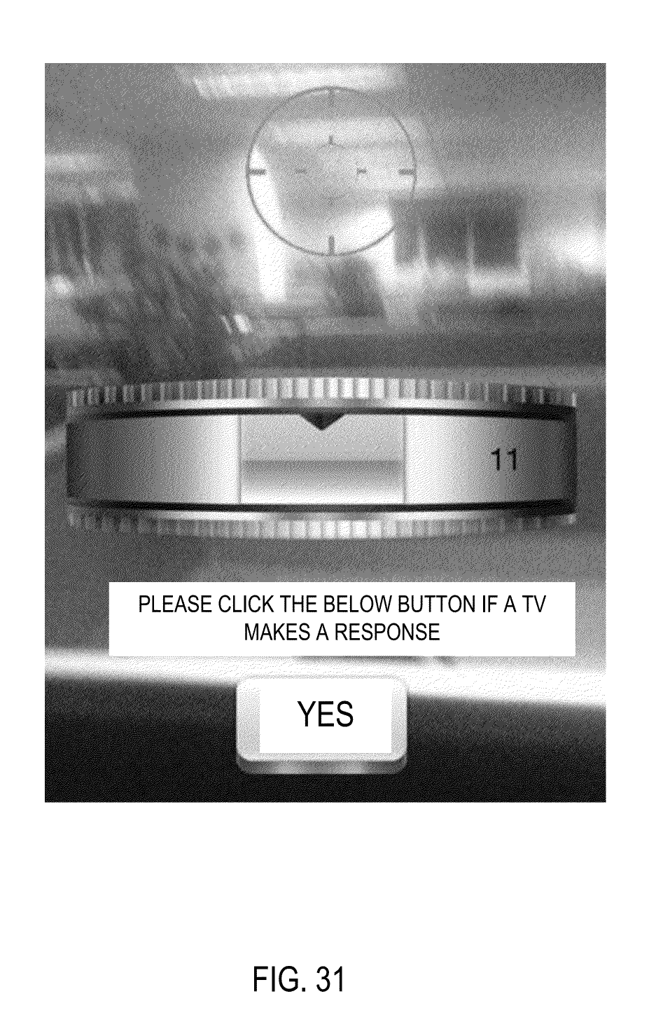

The control unit 5240, coupled to the camera 5210, the transmitting unit 5220, the display unit 5230 and the detection unit 5250, is a control centre of the end device 5200 for controlling the controlled device 5120. For example, at the initialization stage of the remote controlling, if the display unit 5230 displays the type acquiring interface, the control unit 5240 turns on the camera 5210, such that the display unit 5230 sets the image taken by the camera 5210 as the background of the type acquiring interface. The display unit 5230 may further display a crosshair icon on the type acquiring interface. In one embodiment, the crosshair icon can be a pattern of a bulls eye as shown in FIG. 31, which is configured for helping the end device 5200 aim at the controlled device 5120.

As such, since the user can aim the end device 5200 at the controlled device 5120 with the help of the crosshair icon and the image taken by the camera 5210 rather than by experience or feeling as described in prior art, the time for the user aiming the end device 5200 at the controlled device 5120 is reduced and the success rate of operation is effectively improved.

The detection unit 5250, coupled to the control unit 5240, is configured for detecting an operation made by the user on a screen (e.g., the type acquiring interface) of the end device 5200, and informing the control unit 5240 of the detected operation. As such the control unit 5240 makes processing in response to the detected operation. For example, if a type acquiring operation on the type acquiring interface is detected, the detection unit 5250 informs the control unit 5240 of the type acquiring operation. Thus the control unit 5240 may register the current displayed candidate type on the type acquiring interface as the type of the controlled device 5120 accordingly. In one embodiment, the type acquiring operation is performed when the user identifies that the controlled device 5120 responds to the control signal transmitted by the transmitting unit 5220.

In one embodiment, the display unit 5230 is configured to display a selection box on the type acquiring interface. The selection box can be a thumbwheel as shown in FIG. 31. The user can dial the thumbwheel. A candidate type is displayed in the selection box. In one embodiment, if a dialing operation on the thumbwheel is detected, the detection unit 5250 informs the control unit 5240 of this dialing operation. Thus the control unit 5240 is configured for controlling the display unit 5230 to change the candidate type displayed in the selection box according to the dialing operation. The transmitting unit 5220 may transmit the control signal to the controlled device 5120 according to the changed candidate type (e.g., current displayed type shown on the display unit 5230), so that the control unit 5240 can test whether the changed candidate type matches the type of the controlled device 5120.

In one embodiment, the selection box for displaying the candidate type is a thumbwheel which is more intuitionistic and more convenient. The user can change the candidate type by simple dialing operations, which can reduce a probability of the misoperation when the user is acquiring the type of the controlled device and can thus improve the user's experience.

In one embodiment, the user can dial the selection box to the left or to the right. For example, when the detection unit 5250 informs the control unit 5240 of a dialing operation to the left, the control unit 5240 controls the display unit 5230 to display a previous displayed candidate type in the selection box. When the detection unit 5250 informs the control unit 5240 of a dialing operation to the right, the control unit 5240 controls the display unit 5230 to display a new candidate type which has not been displayed in the selection box. As such, the selection box in the form of a thumbwheel is convenient for the user to operate as it can be dialed to the left or to the right.

In one embodiment, the display unit 5230 further displays a button on the type acquiring interface. The button as shown in FIG. 31 can be clicked by the user. In this embodiment, the detection unit 5250 informs the control unit 5240 when a clicking operation is detected. The control unit 5240 may regard the clicking operation as the type acquiring operation and register the current displayed candidate type as the type of the controlled device 5120 accordingly.

In one embodiment, the display unit 5230 further displays a text box on the type acquiring interface as shown in FIG. 31. For example, the text box displays using instructions for the selection box and the button, which improves the user's experience.

In one embodiment, a transparent layer is overlaid on the type acquiring interface of the display unit 5230. The transparent layer divides the type acquiring interface into an operation region and a non-operation region, and displays the operation region of the type acquiring interface prominently. In one embodiment, the operation region includes a region for displaying the selection box and the button, and the non-operation region includes a region for displaying the crosshair icon.

The above embodiments take the end device 5200 acquiring the type of the controlled device 5120 as an example to describe how to guide the user to aim the end device 5200 at the controlled device 5120 for controlling the controlled device 5120 effectively by the end device 5200. It can be understood by a person skilled in the art that this teaching is suitable for other conditions in which the end device 5200 can be aimed at the controlled device 5120, for example, in a situation that the end device 200 turns on or off the controlled device 5120.

For example, in one embodiment, the control unit 5240 can operate at a shaking control mode to realize the guiding function according to the crosshair icon in combination with the taken image. For example, when the end device 5200 is under the shaking control mode (e.g., the display unit 5230 displays a shaking control interface), the detection unit 5250 informs the control unit 5240 of a shaking operation. In response, the control unit 5240 turns on the camera 5210 automatically, and the display unit 5230 is configured to display the image taken by the camera 5210 as a background of the shaking control interface and further display the crosshair icon on the shaking control interface. Thus, the user can easily aim the end device 5200 at the controlled device 5120 under the guide of the crosshair icon and the image taken by the camera 5210. The controlled device 5120 can be controlled by shaking the end device 5200. For example, the controlled device 5120 can be controlled to be turned on and/or off by shaking the end device 5200.

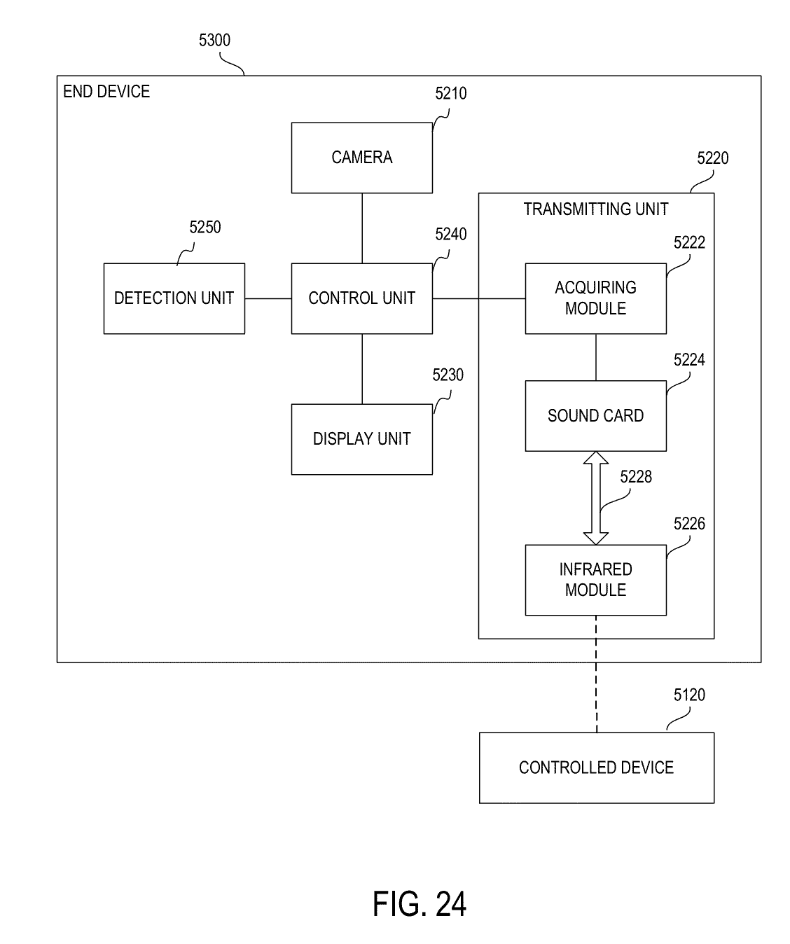

FIG. 24 illustrates a block diagram of an end device 5300, in accordance with another embodiment of the present teaching. Elements that are labeled with the same numerals in FIGS. 23-24 may have similar functions.

In one embodiment, since the end device 5300 generally has an audio channel (e.g., a headset jack), the control signal can be transmitted to the controlled device 5120 through the audio channel.

As shown in FIG. 24, the transmitting unit 5220 of the end device 5300 includes an acquiring module 5222, a sound card 5224, and an infrared module 5226. The acquiring module 5222, coupled to the control unit 5240, is configured for acquiring a digital audio signal. The digital audio signal may correspond to an operation instruction, which is identified by the control unit 5240 based on the candidate type. In one embodiment, the digital audio signal is stored in a built-in memory of the end device 5300, and the acquiring module 5222 acquires the digital audio signal by accessing the built-in memory. In another embodiment, the digital audio signal is stored in a specific server, and the acquiring module 5222 acquires the digital audio signal by network communications with the specific server. The sound card 5224, coupled to the acquiring module 5222 and the infrared module 5226, is configured for converting the digital audio signal to the corresponding control signal which is an analog electronic signal, and is configured for transmitting the control signal to the headset jack 5228 of the end device 5300. The infrared module 5226, coupled to the headset jack 5228 of the end device 5300, is configured for converting the control signal to the infrared signal and transmitting the converted infrared signal to the controlled device 5120.

The hardware cost of the end device 5300 for controlling the controlled device 5120 can be reduced by using the headset jack and the sound card of the end device 5300.

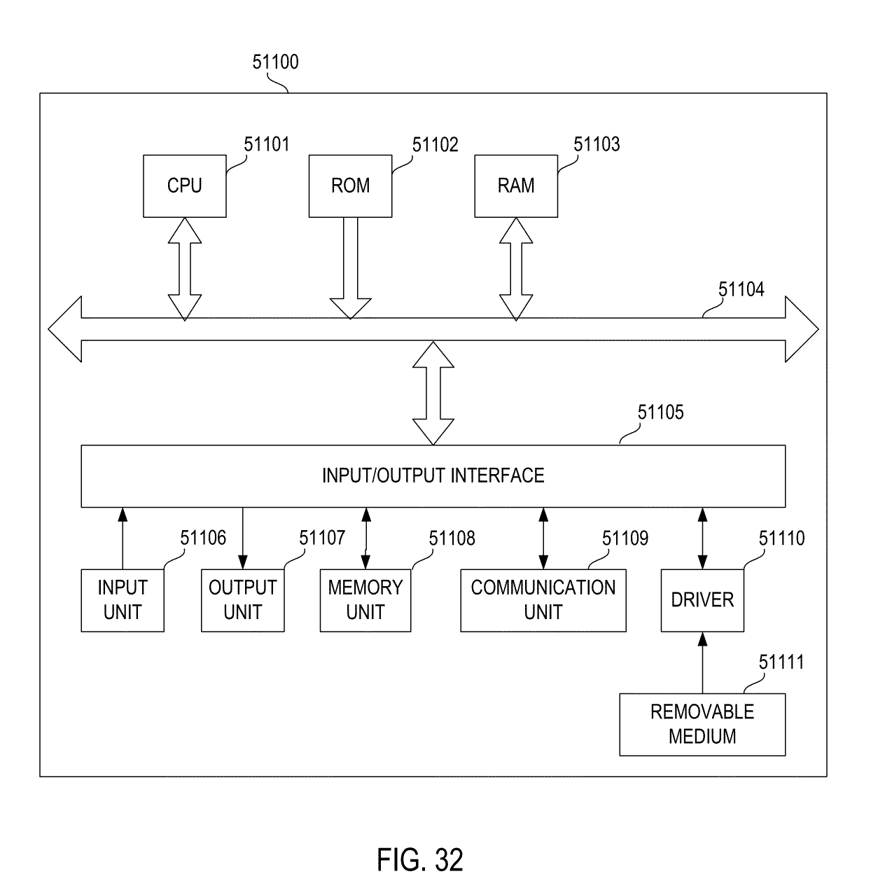

It is understood that, for the end device 5200 and the end device 5300 described above, the functional modules such as the transmitting unit 5220, the acquiring module 5222, the infrared module 5226, the display unit 5230, the control unit 5240 and the detection unit 5250 can be implemented by software, firmware, hardware or any combination thereof. To implement by software or firmware, a program composing software or firmware is installed, from a storage medium or the Internet, on a machine having specific hardware structure (e.g., a general machine 51100 as shown in FIG. 32). Thus, the machine installed with multiple programs can execute multiple functions of the above-described modules and sub-modules.

Furthermore, the above-described modules and sub-modules can be implemented by existing functional modules in the end device 5200 or 5300. For example, an existing sound card in the end device 5300 can be used to implement the function of the sound card 5224 of the transmitting unit 5220, and an existing processor in the end device 5300 can be used to implement the function of the control unit 5240 and the detection unit 5250. If the digital audio signal indicating an operation instruction is stored in the server, an existing network communication module in the end device 5300 is used to implement the function of the acquiring module 5222 of the transmitting unit 5220.

In one embodiment, the infrared module 5226 is a component of the end device 5300. That is, the end device 5300 includes the infrared module 5226. In another embodiment, the infrared module 5226 is a separate device installed on the end device 5300. That is, the end device 5300 and the infrared module 5226 are two separate devices.

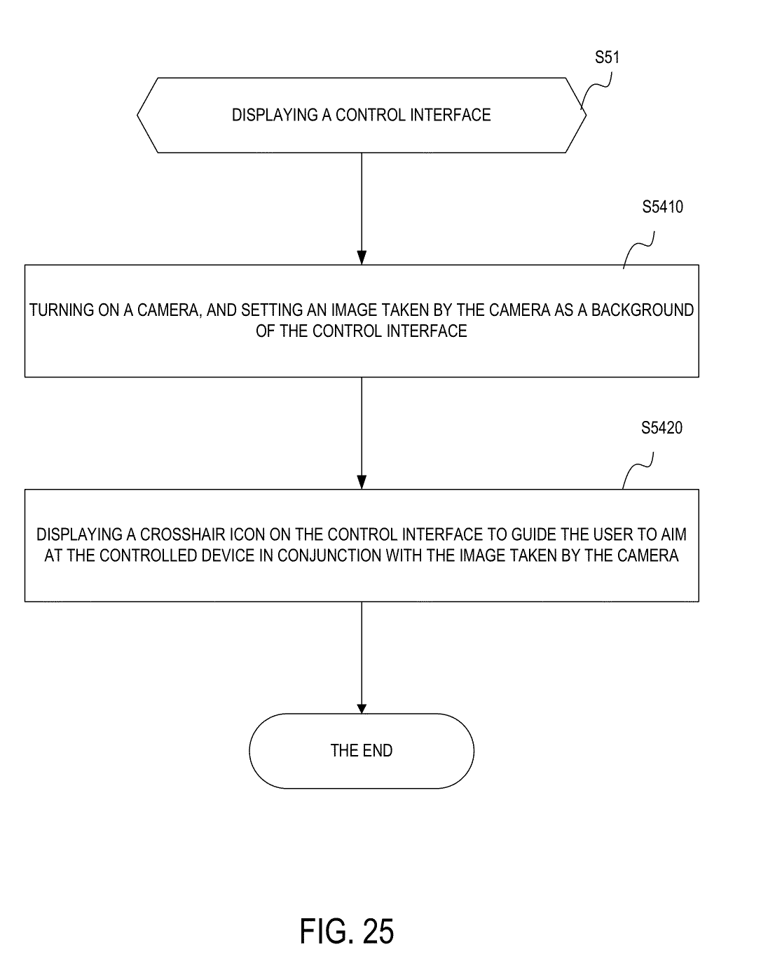

FIG. 25 is a flowchart illustrating examples of operations by an end device for controlling a controlled device, in accordance with an embodiment of the present teaching. FIG. 25 will be described in combination with FIG. 22, FIG. 23 and FIG. 24. At S51, the display unit 5230 of the end device 5200 or 5300 displays a control interface. The control interface can be, but not limited to, a type acquiring interface and a shaking control interface as described above. At S5410, a control unit 5240 of the end device 5200 or 5300 turns on the camera 5210 of the end device 5200 or 5300, and sets an image taken by the camera 5210 as a background of the control interface. At S5420, the end device 5200 or 5300 displays a crosshair icon on the control interface to guide the user to aim at the controlled device 5120 in conjunction with the image taken by the camera 5210. In one embodiment, the crosshair icon can be in shape of a target as shown in FIG. 31, which guides users to aim the end device 5200 or 5300 at the controlled device 5120 in conjunction with the image taken by the camera 5210.

As such, since the user can aim the end device 5200 or 5300 at the controlled device 5120 with the help of the crosshair icon and the image taken by the camera 5210 rather than experience or feeling as described in prior art, the time for the user aiming the end device 5200 or 5300 at the controlled device 5120 can be reduced and the operation is more likely to succeed.

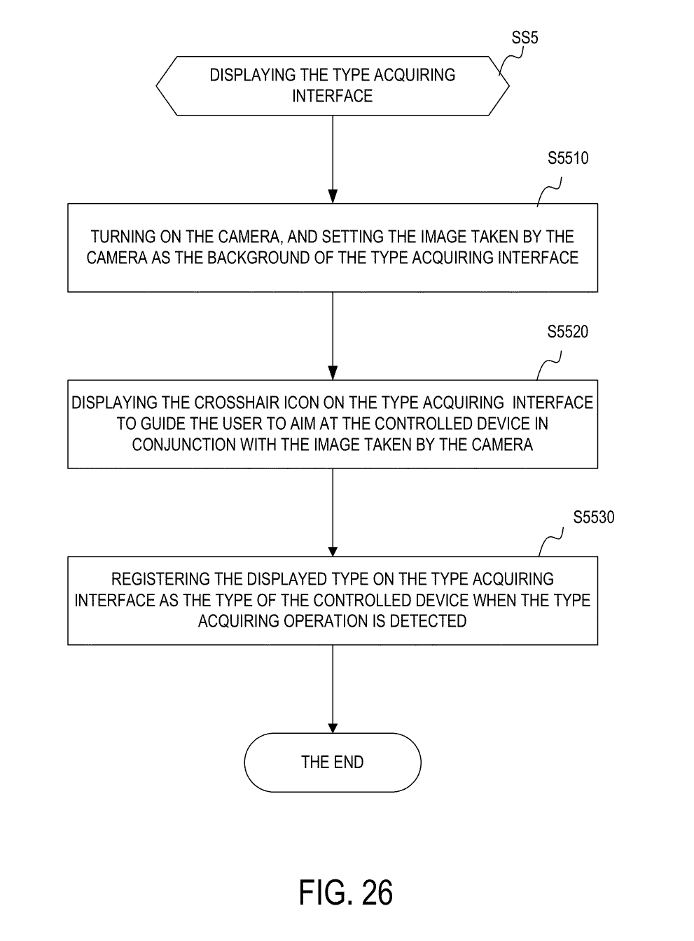

FIG. 26 is a flowchart illustrating examples of acquiring the type of a controlled device, in accordance with an embodiment of the present teaching. FIG. 26 will be described in combination with FIGS. 22-25.

The method shown in FIG. 26 may be used for the end device 5200 or 5300 to acquire the type of the controlled device 5120. A display unit 5230 in the end device 5200 or 5300 displays the type acquiring interface (at SS5). A control unit 5240 in the end device 5200 or 5300 turns on the camera 5210 and sets the image taken by the camera 5210 as the background of the type acquiring interface (at S5510). Then at 5520, the end device 5200 or 5300 displays the crosshair icon on the type acquiring interface to guide the user to aim at the controlled device 5120 in combination with the image taken by the camera 5210. In one embodiment, the crosshair icon can be in a shape of a target as shown in FIG. 31, which guides users to aim the end device 5200 or 5300 at the controlled device 5120 in combination with the image taken by the camera 5210. At S5530, the end device 5200 or 5300 registers the displayed type on the type acquiring interface as the type of the controlled device 5120 when the type acquiring operation on the type acquiring interface is detected. In one embodiment, the type acquiring operation is performed by the user to determine that the controlled device 5120 has sent responses to the control signal transmitted by the end device 5200 or 5300.

As such, since the user can aim the end device 5200 or 5300 at the controlled device 5120 with the help of crosshair icon and the image taken by the camera 5210 rather than by experience or feeling, the time for the user to aim the end device 5200 or 5300 at the controlled device 5120 can be reduced and the operation for acquiring the type of the controlled device 5120 is more likely to succeed.

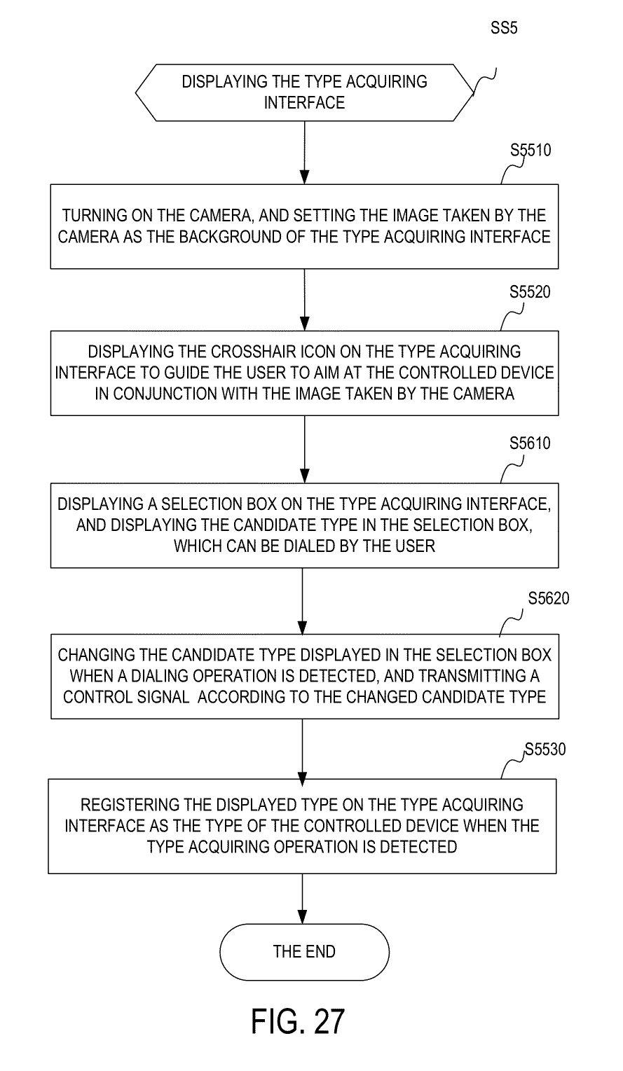

FIG. 27 is a flowchart illustrating examples of operations by an end device for controlling a controlled device, in accordance with an embodiment of the present teaching. Elements that are labeled with the same numerals in FIGS. 26-27 may have similar functions.

As shown in FIG. 27, compared to FIG. 26, the process in FIG. 27 further includes S5610 and S5620. At S5610, the end device 5200 or 5300 displays a selection box on the type acquiring interface and display the candidate type in the selection box. In one embodiment, the selection box can be a thumbwheel in which the candidate type is displayed, and the user can dial the thumbwheel. At S5620, the end device 5200 or 5300 changes the candidate type displayed in the selection box when a dialing operation is detected, and transmits a control signal to the controlled device 5120 according to the changed candidate type to test whether the changed candidate type (e.g., current displayed candidate type shown on the display unit 5230) matches the type of the controlled device 5120.

Although S5610 as shown in FIG. 27 is performed after S5520, it can be understood by a person skilled in the art that this teaching is not limited to it. The user can set the performing sequence of S5520 and S5610 according to personal preference and practical applications. For example, S5610 and S5520 can be performed simultaneously, or S5610 can be performed before S5520.

As such, since the selection box for displaying the candidate type is a thumbwheel, the user can change the candidate type through simple dialing operations. Therefore, the misoperations of acquiring the type of the controlled device become less likely, and the user's experience is improved.

In one embodiment, the user can dial the selection box to the left or to the right. When the detection unit 5250 informs the control unit 5240 of a dialing operation to the left, the control unit 5240 is configured to control the display unit 5230 to display a previous displayed candidate type in the selection box. When the detection unit 5250 informs the control unit 5240 of a dialing operation to the right, the control unit 5240 is configured to control the display unit 5230 to display a new candidate type (e.g., a candidate type that has not been displayed) in the selection box.

The selection box can be in the form of a thumbwheel which can be dialed to the left or to the right, which is convenient for the user to operate.

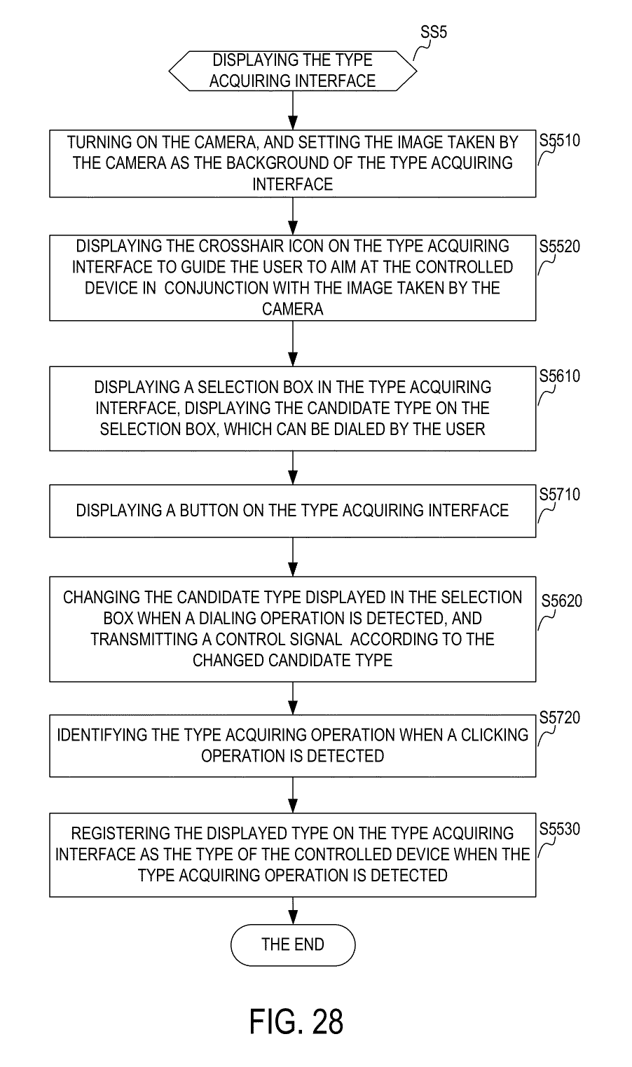

FIG. 28 is a flowchart illustrating examples of operations by an end device for controlling a controlled device, in accordance with an embodiment of the present teaching. Elements that are labeled with the same numerals in FIGS. 26-28 may have similar functions.

As shown in FIG. 28, compared to FIG. 27, the process in FIG. 28 further includes S5710 and S5720. At S5710, the end device 5200 or 5300 displays a button on the type acquiring interface, and the button can be clicked by the user. At S5720, the end device 5200 or 5300 identifies the type acquiring operation when a clicking operation is detected. Although S5710 as shown in FIG. 28 is performed after S5610, it is understood by a person skilled in the art that this teaching is not limited to that order. The user can set the performing sequence of operations S5520, S5610 and S5710 according to personal preference and practical applications.

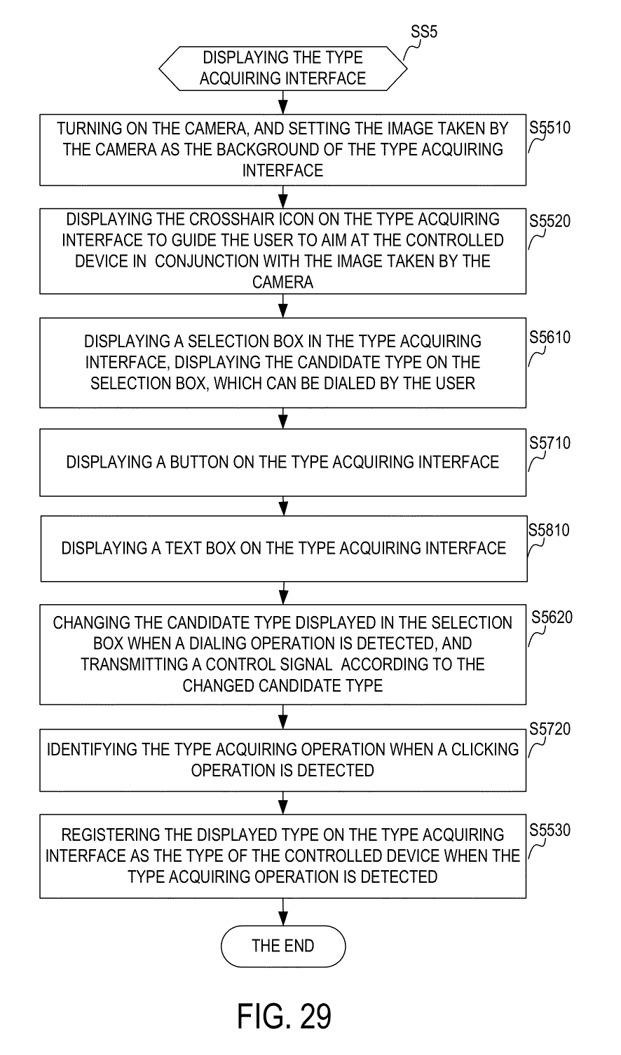

FIG. 29 is a flowchart illustrating examples of operations by an end device for controlling a controlled device, in accordance with an embodiment of the present teaching. Elements that are labeled with the same numerals in FIG. 26-FIG. 29 may have similar functions.

As shown in FIG. 29, compared to FIG. 28, FIG. 29 further includes S5810. At S5810, the end device 5200 or 5300 displays a text box on the type acquiring interface, and the text box is configured to display the using instructions for the selection box and the button as shown in FIG. 31, which improves the user's experience.

Although S5810 as shown in FIG. 29 is performed after S5710, it can be understood by a person skilled in the art that this teaching is not limited to that order. The user can set the performing sequence of operations S5520, S5610, S5710 and S5810 according to personal preference and practical applications.

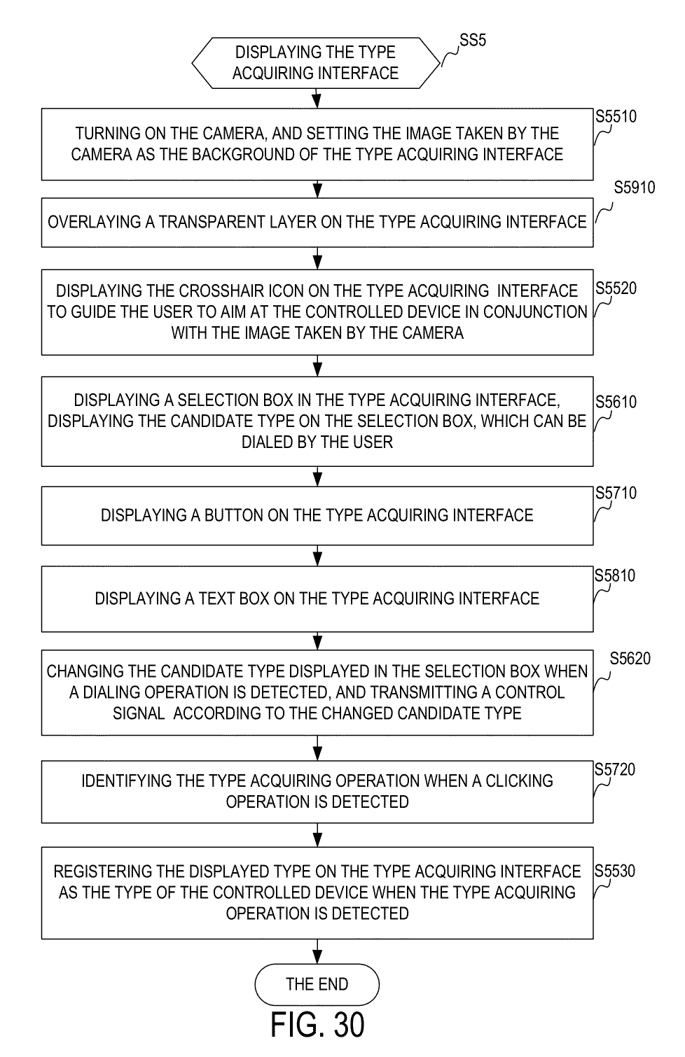

FIG. 30 is a flowchart illustrating examples of operations by an end device for controlling a controlled device, in accordance with an embodiment of the present teaching. Elements that are labeled with the same numerals in FIG. 26-FIG. 30 may have similar functions.

As shown in FIG. 30, compared to FIG. 29, FIG. 30 further includes S5910. At S5910, a transparent layer is overlaid on the type acquiring interface of the end device 5200 or 5300. The transparent layer may divide the type acquiring interface into an operation region and a non-operation region, and display the operation region of the type acquiring interface prominently. In one embodiment, the operation region includes a region for displaying selection box and button, and the non-operation region includes a region for displaying a crosshair icon.

Although S5910 as shown in FIG. 30 is performed before S5520, it is understood by a person skilled in the art that this teaching is not limited to that order. The user can set the performing sequence of operations S5520, S5610, S5710, S5810 and S5910 according to personal preference and practical applications.

FIG. 32 illustrates a block diagram of a hardware structure of an information processing device for acquiring the type of a controlled device, in accordance with an embodiment of the present teaching. In one embodiment, the hardware in FIG. 32 operates as a computer. However, it is understood by a person skilled in the art that such description is for illustrative purpose only and does not intend to limit the scope of the present teaching. It is understood that the information processing device is not limited to a computer, and can be other devices, especially portable electronic devices such as a mobile phone or a panel computer having the function of calculating and processing. Since the principle is similar, the description corresponding to these devices is omitted.

In FIG. 32, a central processing unit (CPU) 51101 operates multiple processes according to the program stored in a read-only-memory (ROM) 51102, or according to the program loaded from a memory unit 51108 to a random-access memory (RAM) 51103. The RAM 51103 further stores necessary data for processing. The CPU 51101, the ROM 51102, and the RAM 51103 are coupled to each other via a bus 51104. An input/output interface 51105 is also coupled to the bus 51104.

In one embodiment, an input unit 51106 (including, keyboard, mouse, etc.), an output unit 51107 (including, monitor, e.g., cathode-ray tube (CRT), liquid crystal display (LED), and loudspeaker, etc.), the memory unit 51108 (including hard disc, etc.), and a communication unit 51109 (including network interface card, e.g., local area network (LAN) card, modulator-demodulator, etc.) are also coupled to the input/output interface 51105. The communication unit 51109 performs communication process via the network (e.g., the Internet). In one embodiment, a driver 51110 is also coupled to the input/output interface 51105. A removable medium 51111 (e.g., magnetic disc, optical disc, magneto optical disk, semiconductor memory, etc.) can be installed on the driver 51110, in one embodiment, such that the program read from the removable medium 51111 can be stored in the storage unit 51108.

If the above-described processes are executed by software, the software programs can be installed from network such as the Internet or from memory unit such as the removable medium 51111.

However, it is understood by a person skilled in the art that the memory medium is not limited to the removable medium 51111 which stores program and provides the user with programs separately from the device, as shown in FIG. 32. The removable medium 51111 includes, but not limited to, a magnetic disc (e.g., the floppy disk), a optical disc (e.g., the CD-ROM, DVD), a magneto optical disk (e.g., MD), a semiconductor memory. Alternatively, the memory medium includes the ROM 51102, and the hard disc in the storage unit 51108, in which programs are stored and provided to the user together with the device.

Moreover, a program product which stores machine-accessible command codes can be provided according to one embodiment of the present teaching. When the command codes are read and performed by the machine, the controlling method according to one embodiment of the present teaching (or part of it) can be performed. Multiple memory media such as magnetic discs, compact discs, magneto-optical discs, and semiconductor memories used for loading the program product can also be within the scope of the present teaching.

Some embodiments according to the present teaching provide apparatus and methods for a user to use a remote controller to adjust the volume of an appliance or switch the channel of the appliance.

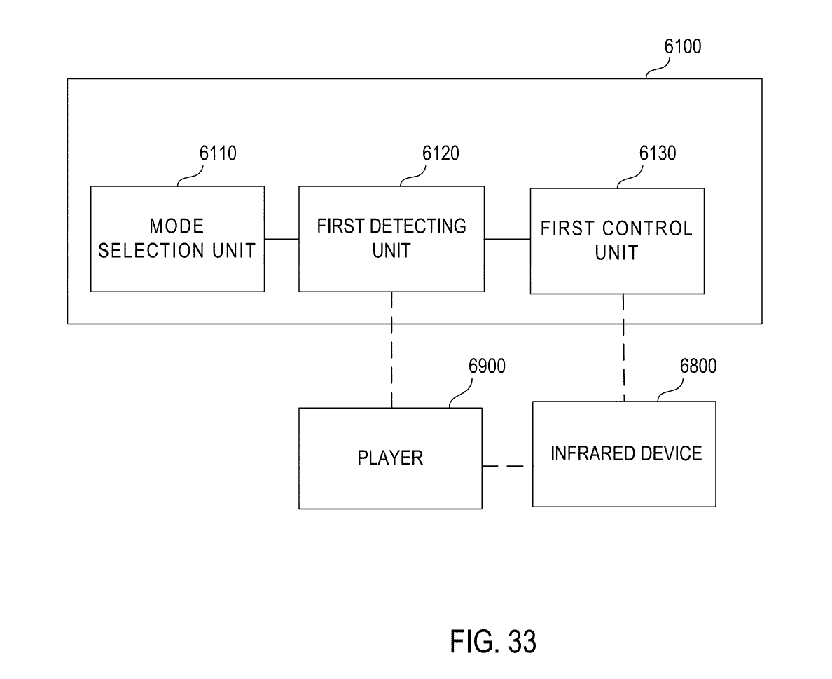

FIG. 33 illustrates an infrared emission control device 6100, in accordance with an embodiment of the present teaching. The infrared emission control device 6100 is configured to control an infrared device 6800 to remotely control a player 6900 through infrared signals. The player 6900 can be a television or any other devices having a function of infrared communication. For example, the player 6900 can be a device whose volume can be adjusted by infrared signals and/or whose channels (such as TV channels or frequency modulation broadcasting channels) can be switched by infrared signals. The infrared device 6800 can be a device with a function of emitting infrared signals, and can be coupled to the infrared emission control device 6100 in a detachable way. In the example of FIG. 33, the infrared emission control device 6100 includes a mode selection unit 6110, a first detecting unit 6120 and a first control unit 6130.

The mode selection unit 6110 is configured for selecting an operation mode for the infrared emission control device 6100 between a first mode (large range mode) and a second mode (small range mode) based on users' requirements. For example, if the user wants to browse all the channels or switch channels in a relative large range, e.g., switching from channel 1 to channel 100, the first mode may be selected. If the user wants to switch the channel in a relatively small range, e.g., switching from channel 1 to channel 10, the second mode may be selected. The first detecting unit 6120 is configured for detecting whether at least one event in a first set of predetermined events occurs during the playing of the player 6900.

The first set of predetermined events includes at least one of following events: receiving a first touch signal by the infrared emission control device 6100 (event_11), pressing down a first predetermined button of the infrared emission control device 6100 (event_12) and shaking the infrared emission control device 6100 (event_13).

For the event_11, the first touch signal can be generated by the infrared emission control device 6100 if the user touches a touch panel, a touch screen or a touching button. For the event_12, the first predetermined button can be a continuous increasing button for increasing channel number or volume level, or other buttons such as continuous decreasing button for decreasing channel number or volume level. A user can set the first predetermined button in advance. The event_13 can be detected by monitoring a motion status of the infrared emission control 6100. If the motion status of infrared emission control device 6100 satisfies any one of the following predetermined requirements which are described below, the event_13 may be determined as occurred.

As an example, the motion status of the infrared emission control device 6100 is described by two parameters including a current acceleration and a current angular velocity of the infrared emission control device 6100. For example, the current acceleration includes components of the acceleration of the infrared emission control device 6100 on three dimensions. The current angular velocity includes components of the angular velocity of the infrared emission control device 6100 on three dimensions. In this case, the predetermined requirements may include at least one of the requirements: the current acceleration of the infrared emission control device 6100 is greater than to or equal to a first predetermined threshold, or the current angular velocity of the infrared emission control device 6100 is greater than or equal to a second predetermined threshold. The first predetermined threshold and the second predetermined threshold can be set based on empirical values. Alternatively, the first predetermined threshold and the second predetermined threshold can be set based on experimental results. Moreover, the current acceleration of the infrared emission control device 6100 can be measured by an acceleration sensor. The current angular velocity of the infrared emission control device 6100 can be measured by a gyroscope.

If the first detecting unit 6120 detects that at least one event in the first set of predetermined events occurs during the playing of the player 6900, the first control unit 6130 may generate a control signal to the infrared device 6800. The first control unit 6130 may generate different control signals in different operation modes. For example, if the infrared emission control device 6100 operates in the first mode, the first control unit 6130 generates a first control signal which is configured for controlling the infrared device 6800 to keep continually emitting predetermined infrared signals. A single emission of the predetermined infrared signal can cause the channel of the player 6900 to switch once or adjust the volume of the player 6900 by one level. When the player 6900 includes many channels, the first control signal can continually switch the channels of the player 6900 in one direction or continually adjust the volume of the player 6900 in one direction (either increasing or decreasing).

If the infrared emission control device 6100 operates in the second mode, the first control unit 6130 may generate a second control signal which is configured for controlling the infrared device 6800 to successively emit a predetermined number of the predetermined infrared signals. The number of infrared signals can be set in advance by the user. For example, the predetermined number can be three. Thus, each time the first control unit 6130 generates a second control signal, the infrared device 6800 successively emits three predetermined infrared signals. In this way, the predetermined device 6800 can switch channels of the player 6900 continually for three times in one direction (either increasing or decreasing) or adjust volume of the player 6900 continually for three times in one direction in response to the second control signal. Moreover, the mode selection unit 6110 can select an operation mode of the infrared signal emission device 6110 either before or after the first detecting unit 6120 detects at least one event in a first set of predetermined events occurs.

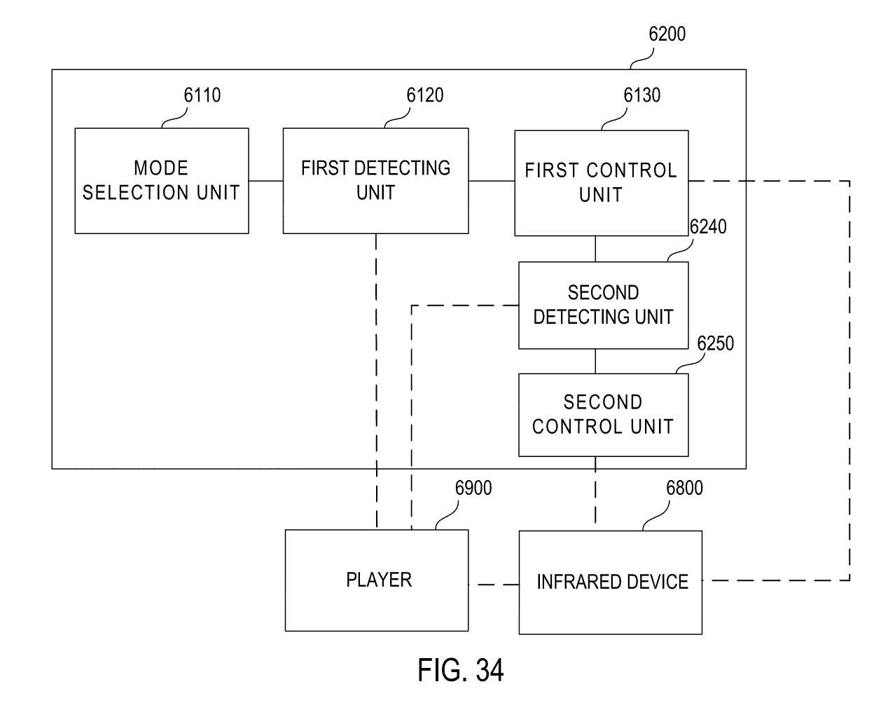

FIG. 34 illustrates an infrared emission control device 6200, in accordance with another embodiment of the present teaching. As shown in FIG. 34, the infrared emission control device 6200 further includes a second detecting unit 6240 and a second control unit 6250. Elements that are labeled with the same numerals in FIGS. 33-34 may have similar functions.

As shown in FIG. 34, the second detecting unit 6240 is configured for detecting whether at least one event in a second set of predetermined events occurs if the infrared emission control device 6200 is operating in the first mode or the second mode.

The second set of predetermined events may include at least one of following events: receiving a second touch signal by the infrared emission control device 6200 (event_21), pressing down a second predetermined button of the infrared emission control device 6200 (event_22), and shaking the infrared emission control device 6200 (event_23).

For the event_21, the second touch signal can be generated by the infrared emission if the user touches a touch panel, a touch screen or a touching button of the infrared emission control device 6200. The touch movement for generating the second touch signal can be set to be different or same as the touch movement for generating the first touch signal based on users' requirements. For example, if a user places his or her finger or a touch pen on the touch screen of the infrared emission control device 6200 and slides it to the right, the first touch signal can be generated accordingly. If the user places his or her finger or the touch pen on the touch screen of the infrared emission control device 6200 and slides it to the left, the second touch signal can be generated accordingly.

For the event_22, the second predetermined button of the infrared emission control device 6200 can be a switch stopping button for stopping increasing channel number or volume level. Moreover, if the event_12 is included in the first set of predetermined events and the continuous increasing button is pressed down, the event_22 can be the event of releasing the continuous increasing button.

In one embodiment, the event_23 can be the same as the event_13. Alternatively, the event_23 can be different from the event_13. For example, the thresholds associated with the current acceleration and a current angular velocity for determining whether the event_23 occurs can be different from the thresholds for the event_13.

If the second detecting unit 6240 detects that at least one event in the second set of predetermined events occurs, the second control unit 6250 is configured to switch the operation mode of the infrared emission control device 6200 to a third mode to stop the infrared device 6800 from sending above predetermined infrared signals. For example, the first control unit 6130 has already sent out the first control signal and the player 6900 is continually switching channels or adjusting volume in an increasing or decreasing direction. In such case, if the second detecting unit 6240 detects that at least one event in the second set of predetermined events occurs, the second controlling unit 6250 is configured to switch the operation mode of the infrared emission control device 6200 to the third mode. In the third mode, the player 6900 stops switching channels or adjusting volumes.

As described above, the user can initiate one event in the first set of predetermined events to trigger the first control unit 6130 to generate the first control signal. Accordingly, the player 6900 begins continually switching channels or adjusting volume. Then, if the channel is switched to a target channel or the volume is adjusted to a target level, the user can initiate one event in the second set of predetermined events such that the second control unit 6250 switches the operation mode of the infrared emission control device 6200 to the third mode. As a result, the player 6900 can stop at the target channel or the target volume. The target channel may be the channel desired by the user. The target level of volume may be the level of volume desired by the user.

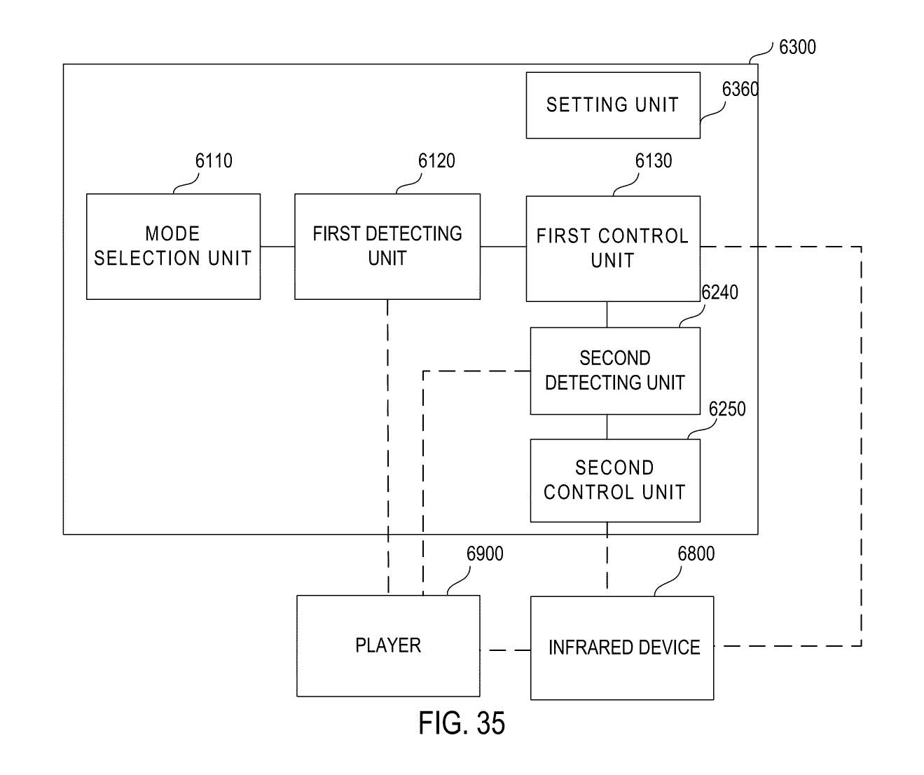

FIG. 35 illustrates an infrared emission control device 6300, in accordance with yet another embodiment of the present teaching. As shown in FIG. 35, besides of a mode section unit 6110, a first detecting unit 6120 and a first control unit 6130, a second detecting unit 6240 and a second control unit 6250, the infrared emission control device 6300 further includes a setting unit 6360. Elements that are labeled with the same numerals in FIGS. 33-35 may have similar functions.

As described in FIG. 33, the first control unit 6130 generates a second control signal which can control the infrared device 6800 to successively emit a predetermined number of the predetermined infrared signals. The predetermined number can be set in advance by the user. The setting unit 6360 in FIG. 35 is configured for determining the predetermined number of the predetermined infrared signals. In one embodiment, the setting unit 6360 sets the predetermined number based on how many times that the user shakes the infrared emission control device 6300 during a setting period. The interval between two successive shakes may be greater than or equal to a first interval and smaller than or equal to a second interval. If the interval between two successive shakes is smaller than the first interval, the two shakes can be considered as one shake. If the interval between two successive shakes is greater than the second interval, the later shake of the two successive shakes can be considered as a non-effective shake. The first interval and the second interval can be set based on empirical values or experimental results. For example, the first interval can be set as 0.1 second. The second interval can be set as 5 seconds.

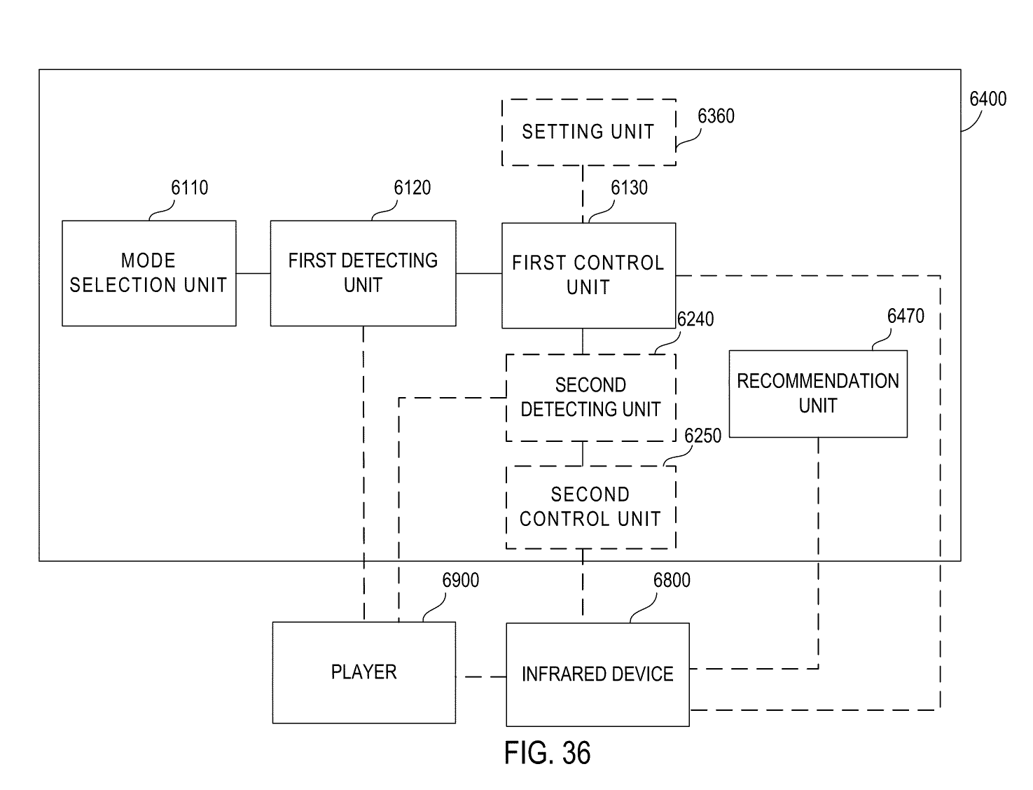

FIG. 36 illustrates an infrared emission control device 6400, in accordance with yet another embodiment of the present teaching. As shown in FIG. 36, besides of a mode section unit 6110, a first detecting unit 6120 and a first control unit 6130, a second detecting unit 6240, a second control unit 6250 and a setting unit 6360, the infrared emission control device 6400 further includes a recommendation unit 6470. Elements that are labeled with the same numerals in FIGS. 33-36 may have similar functions.

As shown in FIG. 36, the recommendation unit 6470 is configured for determining one or more recommended channels. For example, the recommendation unit 6470 analyzes each channel which can be received by the player 6900, acquires knowledge of how long each channel is watched (total playing time length) and how many times each channel is selected during a predetermined time period (playing times), and determines a score associated with a popularity of each channel based on the playing times and the total playing time length. The predetermined time period may be one month, for example. Then the recommendation unit 6470 ranks all the channels by the scores and selects a predetermined number of channels (e.g., a top 10 channels with the highest ranks) as the recommended channels. For example, the playing time length of a channel for one watching time can be an interval from the time when the player 6900 switches to the channel to the time when the player 6900 switches from the channel to another channel. The scores may be determined just based on the total playing time length during the predetermined time period (e.g., a past one month). Alternatively, the scores may be determined based both on the total playing time length and the playing times. For example, the scores may be determined as a product of the total playing time length and the playing time of a channel in the past one month.

Moreover, the player 6900 can play one of the recommended channels that are determined by the recommendation unit 6470 directly after restarting. In another example, after the player 6900 restarts, a list composed by all the recommended channels can be shown on a screen of the infrared emission control device 6400 or on a screen of the player 6900 for a user to make a quick choice. For yet another example, after the predetermine player 6900 restarts, the list composed by all the recommended channels determined by the recommendation unit 6470 can be set as a predetermined list of the player 6900. Thus, when the first control unit 6430 generates the first control signal or the second control signal, the first control signal or the second control signal may be configured to control the infrared device 6800 to emit predetermined infrared signals. The predetermined infrared signals can switch channels of the player 6900 within the predetermined list composed by the above recommended channels.

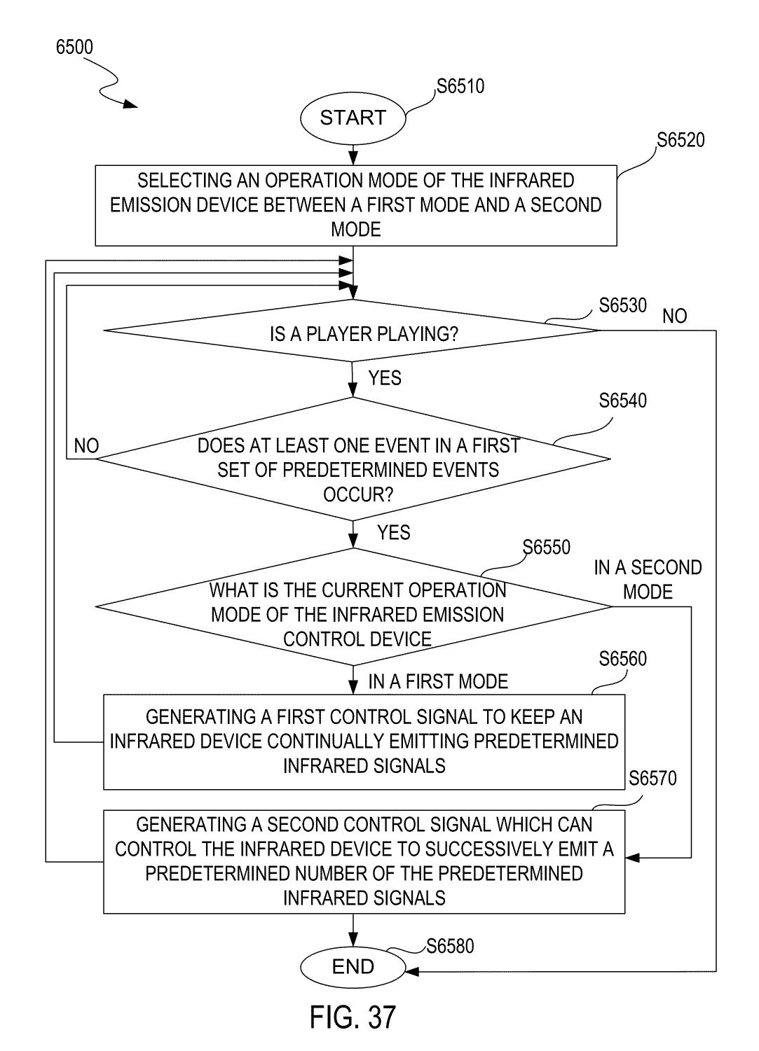

FIG. 37 is a flowchart 6500 illustrating a method for controlling an infrared emission control device 6100, in accordance with an embodiment of the present teaching. FIG. 37 may be described in combination with FIG. 33.

The process begins from S6510. At S6520, a mode selection unit 6110 of an infrared emission device 6100 selects an operation mode of the infrared emission device 6100 between a first mode and a second mode. At S6530, the infrared emission device 6100 checks whether a player 6900 is playing. If the player 6900 is not playing, the process goes to S6580. The process ends at S6580. If the player 900 is playing, a first detecting unit 6120 detects, at S6540, whether at least one event in a first set of predetermined events occurs. If no event in the first set of predetermined events occurs during the playing of the player 6900, the process goes back to S6530. If at least one event in the first set of predetermined events occurs during the playing of the player 6900, the infrared emission control device 6100 checks, at S6550, the current operation mode of the infrared emission control device 6100. If the infrared emission control device 6100 operates in the first mode, a first control unit 6130 in the infrared emission control device 6100 generates, at S6560, a first control signal which can control an infrared device 6800 to keep continually emitting predetermined infrared signals. Then the process goes to S6530. If the infrared emission control device 6100 operates in the second mode, the first control unit 6130 generates, at S6570, a second control signal which can control the infrared device 6800 to successively emit a predetermined number of the predetermined infrared signals. Then the process goes to S6530. The predetermined infrared signals can switch channels in a predetermined list of the player 6900 or adjust the volume of the player 6900.

In another embodiment, the S6520 can be executed between S6530 and S6540.

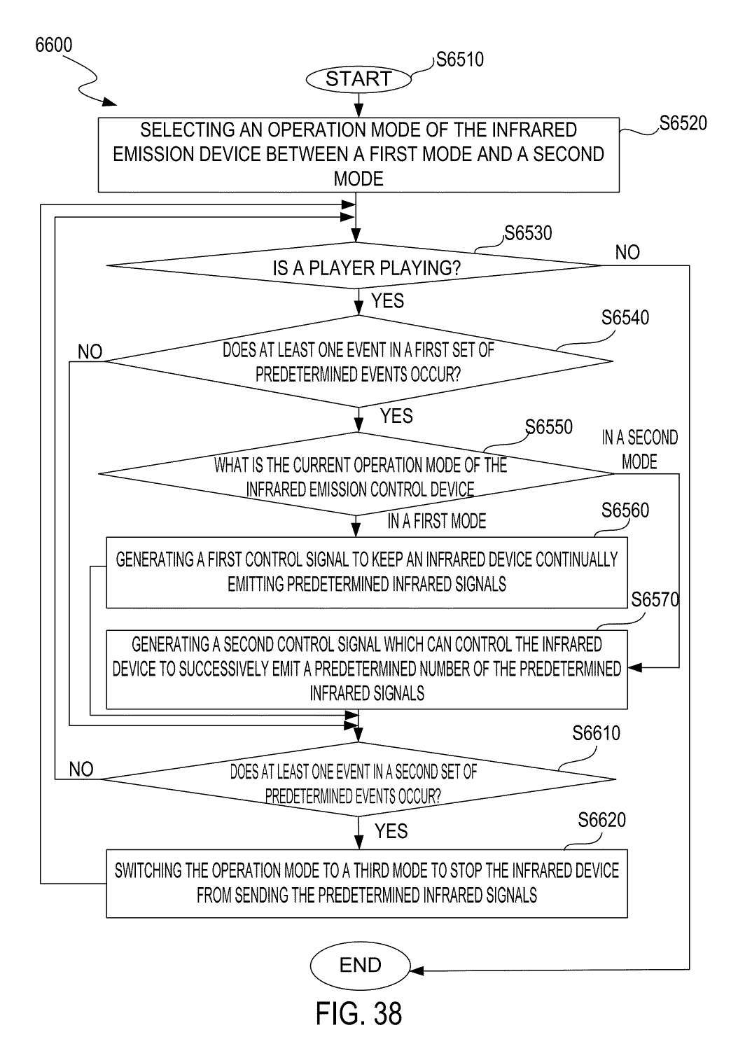

FIG. 38 is a flowchart 6600 illustrating a method for controlling an infrared emission control device 6200, in accordance with another embodiment of the present teaching.

In addition to S6500 to S6580 described in FIG. 37, the flowchart 6600 further includes S6610 and S6620. In FIG. 38, after executing S6560 or S6570, the process goes to S6610. At S6610, a second detecting unit 6240 in the infrared emission control device 6200 detects whether at least one event in a second set of predetermined events occurs during the infrared emission control device 6200 operating in the first mode or in the second mode. For example, if the process goes from S6560 to S6610, the infrared emission control device 6200 operates in the first mode. If the process goes from S6570 to S6610, the infrared emission control device 6200 operates in the second mode. If the second detecting unit 6240 detects that at least one event in the second set of predetermined events occurs, a second controlling unit 6250 in the infrared emission control device 6200 switches, at S6620, the operation mode of the infrared emission control device 6200 to a third mode to stop the infrared device 6800 from sending above predetermined infrared signals. Then the process goes back to S6530. If no event in the second set of predetermined events occurs, the process also goes to S6530. Moreover, after executing S6540, if no event in the first set of predetermined events occurs, the process goes to S6610 to re-check whether at least one event in the second set of predetermined event occurs.

In addition, before executing the S6550, such as between S6510 and S6520, or between S6520 and S6530, or between S6530 and S6540, or between S6540 and S6550, the flowchart 6500 can further include an operation that a setting unit 6360 determines the predetermined number of the predetermined infrared signals based on times of effective shakes of the infrared emission control device 6200. Alternatively, the predetermined number of the predetermined infrared signals can be set by the infrared emission control device 6200 through receiving an input instruction from the user directly.

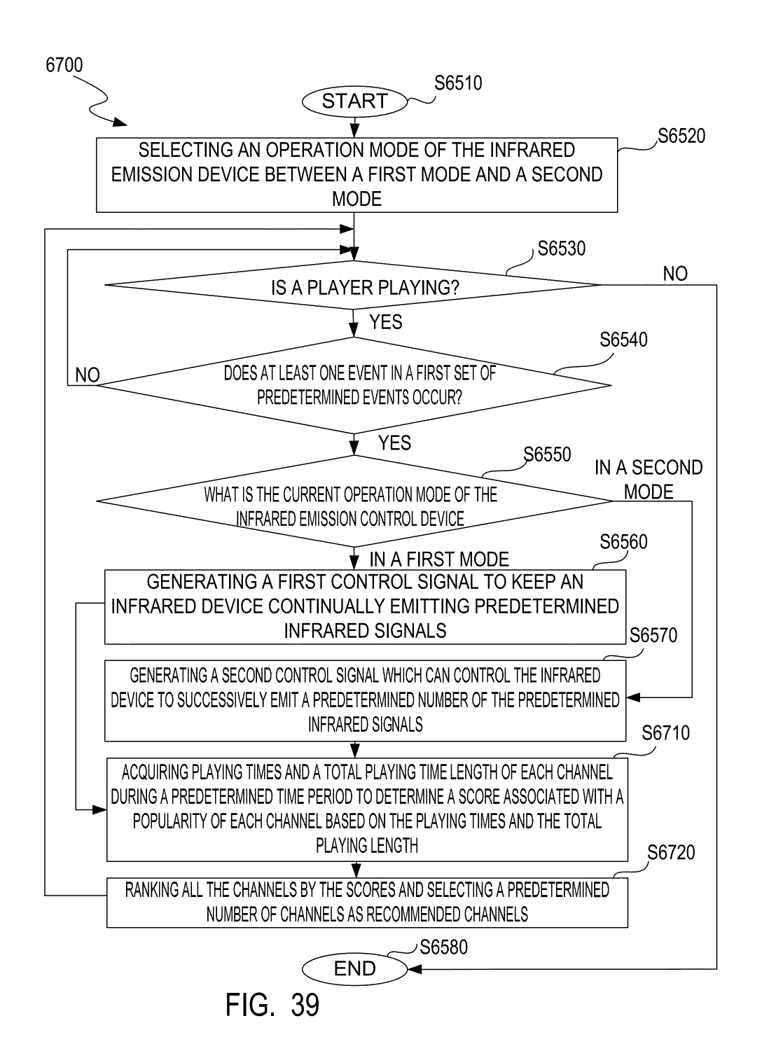

FIG. 39 is a flowchart 6700 illustrating a method for controlling an infrared emission control device 6400, in accordance with another embodiment of the present teaching.

In addition to S6500 to S6580 described in FIG. 37, the method 6700 further includes operations S6710 and S6720, and may optionally include the operations S6610 and S6620 and/or the setting operation described in FIG. 38.

After executing the operations S6570 or S6560, the process goes to the S6710. If the method includes S6610 and S6620, after executing the S6620, the process goes to S6710.

At S6710, a recommendation unit 6470 in the infrared emission control device 6400 analyzes each channel which can be received by the player 6900 to acquire playing times and a total playing time length of each channel during a predetermined time period to determine a score associated with a popularity of each channel based on the playing times and the total playing time length. Then the process goes to S6720. At S6720, the recommendation unit 6470 ranks all the channels by the scores and selects a predetermined number of channels (e.g., a top 10 channels with the highest ranks) as the recommended channels. Then the process goes to S6530.

After S6710 and S6720, the method 6700 may further include any one of the following: choosing one of the recommended channels to play after restarting the player 6900; displaying a list composed by all the recommended channels determined at S6720 on a screen of the infrared emission control device 6400 or a screen of the player 6900 after restarting the player 6900; setting the list composed by all the recommended channels determined at S6720 as a predetermined list after restarting the player 6900.

Accordingly, the present teaching may provide an infrared emission control device. The infrared emission control device can be configured to switch multiple channels or adjust multiple levels of volume by a single operation. Compared to traditional infrared remote controllers which need the user to press button one by one if they want to browse channels or adjust volume, the present teaching can save operation time of users.

The infrared emission control device of the present teaching can be used by various kinds of electric devices including, but not limit to, a mobile phone, a person digital assistant (PDA), a table PC, a multimedia player, a computer, a video game player, an E-reader, etc.

Those skilled in the art will recognize that the embodiments of the present teaching are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as firmware, a firmware/software combination, a firmware/hardware combination, or a hardware/firmware/software combination.

Some embodiments according to the present teaching provide systems and methods for a user to remotely control a device. In accordance with some embodiments, the device is a television and the user does not have to remember which channel of the television provides the user's desired programs.

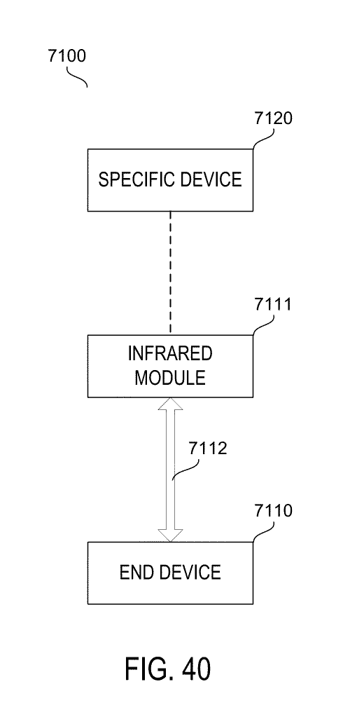

FIG. 40 illustrates a structure diagram of a remote control system 7100 using an end device 7110 to control a specific device 7120 at certain times, in accordance with an embodiment of the present teaching.

As shown in FIG. 40, the end device 7110, as a remote controlling subject, includes, but not limited to, an intelligent mobile phone, a personal digital assistant (PDA), or a panel computer. The specific device 7120, as a remote controlling object for the end device 7110, includes, but not limited to, a television, an air-conditioner, a DVD player, a set-top box, a projector or one of other household appliances.

In the remote control system 7100, the end device 7110 establishes a signal connection with the specific module 7120 via an infrared module 7111, and sends an infrared signal as a command to the controlled specific device 7120, as shown in FIG. 40. In one embodiment, the infrared module 7111 can be implemented as a component of the end device 7110. That is, the end device 7110 includes the infrared module 7111. In another embodiment, the infrared module 7111 can be a separate device installed on the end device 7110. That is, the end device 7110 and the infrared module 7111 are two separate devices.

In one embodiment, the end device 7110 includes an audio channel, e.g., a headphone jack, and the infrared module 7111 can be connected to the headphone jack of the end device 7110 so as to establish signal connection with the end device 7110 via an audio channel 7112. Thus, the infrared module 7111 converts a control signal, in the form of an analog signal transferred by the audio channel 7112, to an infrared signal. The infrared module 7111 then sends the converted infrared signal to the controlled specific device 7120. However, it is understood by a person skilled in the art that such description of the infrared module 7111 connecting to the headphone jack of the end device 7110 is for illustrative purpose only and does not intend to limit the scope of the present teaching. It is understood that the infrared module 7111 may be connected to other components of the end device 7110 which can be used to transfer the analog signal in the present teaching, such as but not limited to, a charging jack.

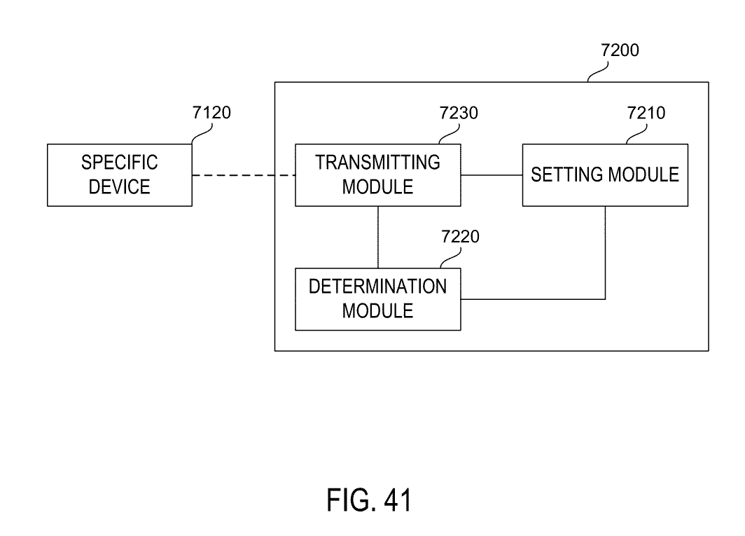

FIG. 41 illustrates a block diagram of an end device 7200, in accordance with an embodiment of the present teaching. The end device 7200 may be a portable end device, e.g., an intelligent mobile phone or a panel computer. As shown in FIG. 41, the end device 7200 includes a setting module 7210, a determination module 7220, and a transmitting module 7230 coupled to each other. The setting module 7210 operates to receive an input from a user. The input may specify a first time and a first mode (first operation mode). The first time may be associated with activating a device. In one embodiment, the first time is an ON time when the specific device 7120 is turned on. The first mode may be associated with any operation at the specific device 7120. In one embodiment, the specific device 7120 is a television and the first mode is indicative of a channel associated with the television. The determination module 7220 is configured to determine whether the system time of the end device 7200 has reached the ON time. The transmitting module 7230 is configured to remotely send a first command to the specific device 7120 when the determination module 7220 determines that the system time of the end device 7200 has reached the ON time, so as to turn on the specific device 7120 at the ON time and make the specific device 7120 work in the first mode (first operation mode).

For example, the specific device 7120 is a television. In this case, the user inputs “7:00 am” as the ON time and inputs the “news channel” as the first mode so as to use the end device 7200 to turn on the television 7120 at 7:00 am automatically and to wake him/her up when the news channel plays the morning news. Here, the “news channel” may be a desired channel of the user at the ON time. Since the user can set the ON time and/or the desired channel at any time, even when the television is turned off, the end device 7200 according to one embodiment of the present teaching can make it easier and simpler for the user to control the television, and provide a possibility of extending more functions for the television.

In one embodiment, the setting module 7210 further receives a second input from the user specifying a second time and a second mode (second operation mode). In one embodiment, the second time is a SWITCH time when the specific device 7120 switches to operate in the second mode (second operation mode). The second mode may be associated with any operation at the specific device 7120. Referring to the above example when the specific device 7120 is a television, the second mode (second operation mode) is indicative of a channel associated with the television. The determination module 7220 further determines whether the system time of the end device 7200 has reached the SWITCH time. The transmitting module 7230 remotely sends a second command to the specific device 7120 when the system time of the end device 7200 has reached the SWITCH time, so as to make the specific device 7120 switch from the first mode to the second mode.

For example, when the specific device 7120 is a television, the user inputs “7:30 am” as the SWITCH time and inputs the “entertainment channel” as the second mode so as to use the end device 7200 to switch the television 7120 to the entertainment channel at the SWITCH time automatically. Here, the “entertainment channel” may be a desired channel of the user at the SWITCH time. Since the user can set the SWITCH time and the desired channel at any time, the end device 7200 according to one embodiment of the present teaching can make it even simpler for the user to control the television.

In one embodiment, the setting module 7210 further receives a third input from the user specifying a third time. The third time may be associated with deactivating the specific device 7120. In one embodiment, the third time is an OFF time when the specific device 7120 is turned off. The determination module 7220 further determines whether the system time of the end device 7200 has reached the OFF time. The transmitting module 7230 remotely sends a third command to the specific device 7120 when the system time of the end device 7200 has reached the OFF time, so as to turn off the specific device 7120 at the OFF time.

Referring to the above example when the specific device 7120 is a television, the user inputs “8:00 am” as the OFF time, for example, to use the end device 7200 to turn off the television 7120 at the OFF time automatically and to remind him/her to go to work. Since the user can set the OFF time at any time, the end device 7200 according to one embodiment of the present teaching can make it even easier for the user to control the television and provide a possibility of extending more functions for the television.

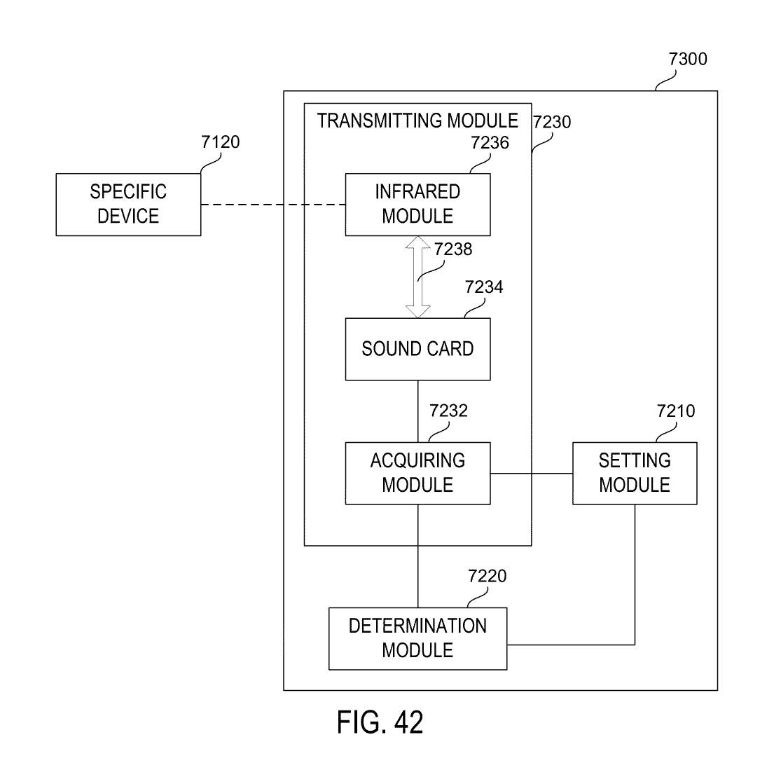

FIG. 42 illustrates a block diagram of an end device 7300, in accordance with another embodiment of the present teaching. Elements that are labeled with the same numerals in FIGS. 41-42 may have similar functions.

In one embodiment, the end device 7300 includes an audio channel, e.g., a headphone jack, and the audio channel can be used to remotely transmit a command to the specific device 7120.

As shown in FIG. 42, the transmitting module 7230 of the end device 7300 includes an acquiring module 7232, a sound card 7234, an infrared module 7236, and a headphone jack 7238. The acquiring module 7232, coupled to the setting module 7210 and the determination module 7220, is configured for acquiring digital audio signals corresponding to the above-mentioned first command, the second command, and/or the third command. In one embodiment, the digital audio signals are stored in a built-in memory of the end device 7300. The acquiring module 7232 acquires the digital audio signals by accessing the built-in memory. In another embodiment, the digital audio signals are stored in a server. The acquiring module 7232 acquires the digital audio signals via communication network from the server. The sound card 7234, coupled between the acquiring module 7232 and the infrared module 7236, is configured for converting a digital audio signal to an analog signal which is used as the control signal, and for sending the control signal to the headphone jack 7238 of the end device 7300. The infrared module 7236, coupled to the headphone jack 7238 of the end device 7300, is configured for converting the control signal to an infrared signal, and for transmitting the infrared signal to the specific device 7120.

Because the audio channel and the sound card of the end device 7300 of this embodiment are utilized, the cost of implementing the end device 7300 for controlling the specific device 7120 can be reduced.

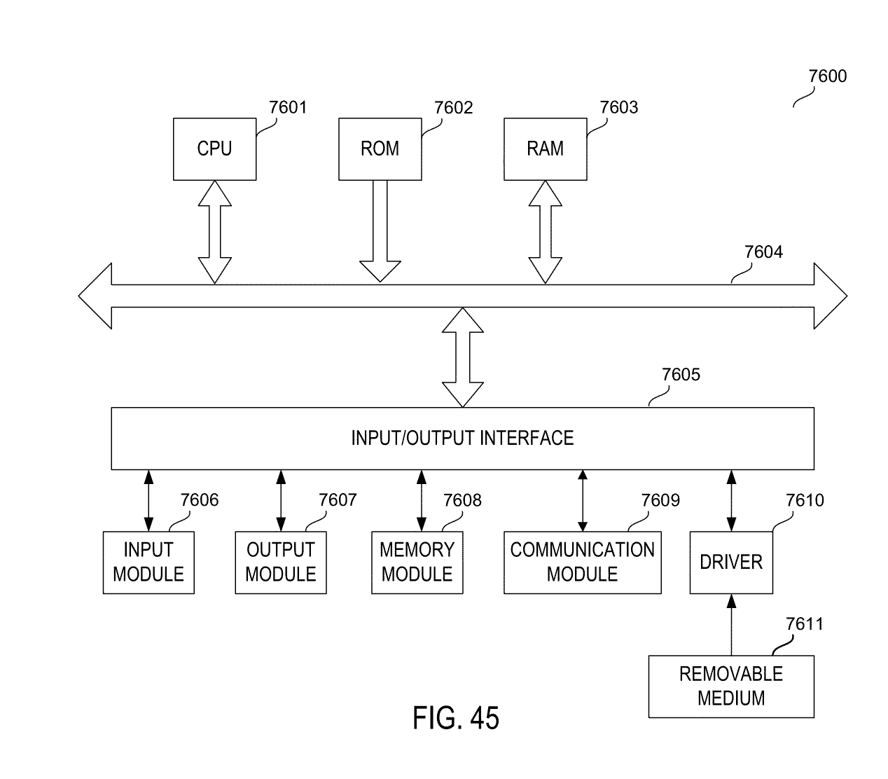

It is understood that, the functional modules such as the setting module 7210, the determination module 7220, the transmitting module 7230, the acquiring module 7232, and the infrared module 7236 in the end device 7200 or 7300 can be realized by software, firmware, or any combination thereof. To realize by software or firmware, a program composing the software or firmware is installed, from a storage medium or internet, on a machine having specific hardware structure (e.g., a general machine 7600 as shown in FIG. 45). Thus, the machine installed with multiple programs can execute multiple functions of the above-mentioned modules and sub-modules.

Furthermore, the functions of modules disclosed in the present teaching can be implemented by existing functional modules in the end device 7200 or 7300. For example, an existing sound card in the end device 7300 can be used to implement the function of the sound card 7234 in the transmitting module 7230, and an existing processor in the end device 7300 can be used to implement the functions of the setting module 7210 and the determination module 7220. If the digital audio signals corresponding to the commands are stored in the server, the existing network communication module in the end device 7300 is used to implement the function of the acquiring module 7232 in the transmitting module 7230.

In one embodiment, the infrared module 7236 operates as a component of the end device 7300. That is, the end device 7300 includes the infrared module 7236. In another embodiment, the infrared module 7236 can be a separate device installed on the end device 7300. That is, the end device 7300 and the infrared module 7236 are two separate devices.

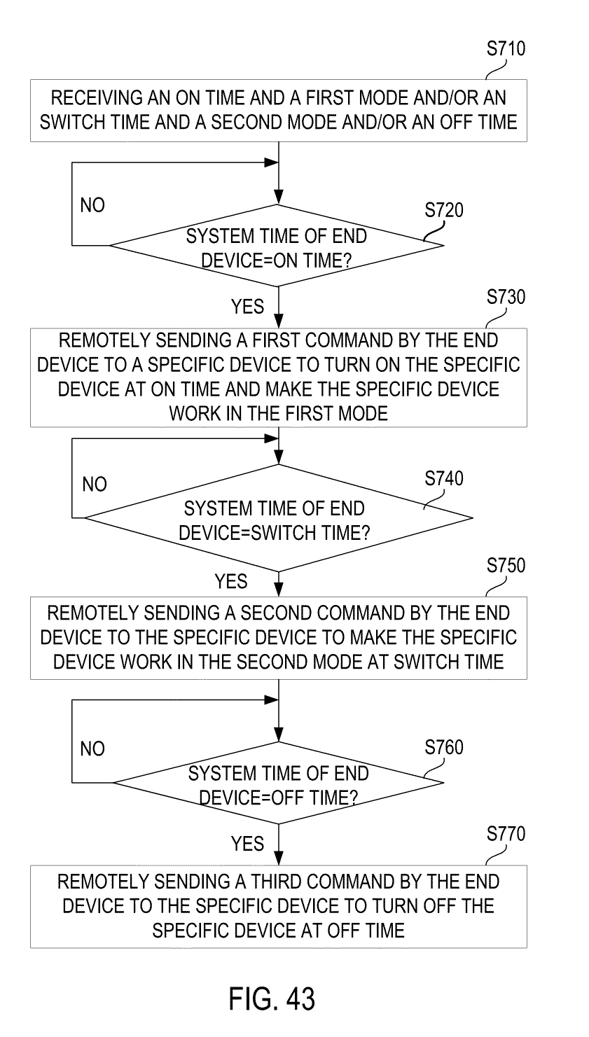

FIG. 43 is a flowchart illustrating examples of operations performed by an end device for controlling the specific device 7120 at certain times, in accordance with an embodiment of the present teaching. FIG. 43 may be described in combination with FIG. 40 to FIG. 42. Although specific operations are disclosed in FIG. 43, such operations are examples. That is, the present teaching is well suited to performing various other operations or variations of the operations recited in FIG. 43.

As shown in FIG. 43, the controlling method at certain times includes: an ON time and a first mode input by the user are received at S710. In one embodiment, the ON time is a time when the specific device 7120 is turned on. The end device can be, but not limited to, the end device 7100, 7200 or 7300 as shown in FIG. 40 to FIG. 42.

At S720, whether the system time of the end device has reached the ON time is determined. The process goes to S730 if the system time of the end device has reached the ON time. At S730, a first command is remotely sent by the end device to a specific device, e.g., the specific device 7120, so as to turn on the specific device at the ON time and make the specific device work in the first mode.

In one embodiment, the specific device 7120 includes a television, and the first mode includes, but not limited to, information of a desired channel for the user. For example, the user inputs “7:00 am” as the ON time and inputs the “news channel” as the first mode so as to turn on the television at 7:00 am automatically and to wake him/her up when the news channel plays the morning news. The user can set the ON time and/or the desired channel at any time, even when the television is turned off, according to one embodiment of the present teaching.

In one embodiment, as shown in FIG. 43, a SWITCH time and a second mode are input by the user at S710. In one embodiment, the SWITCH time is a time when the specific device 7120 is switched to operate in the second mode. Under this circumstance, the controlling method further includes the following S740 and S750.

At S740, whether the system time of the end device has reached the SWITCH time input by the user is determined. The process goes to S750 if the system time of the end device has reached the SWITCH time. At S750, a second command is remotely sent by the end device to the specific device 7120 to make the specific device 7120 switch from the first mode to the second mode at the SWITCH time.

When the specific device 7120 is a television, the second mode may include, but not limited to, information of a desired channel for the user. For example, the user inputs “7:30 am” as the SWITCH time and inputs the “entertainment channel” as the second mode so as to switch the television to the entertainment channel at the SWITCH time automatically. The user can set the SWITCH time and the desired channel at any time, according to one embodiment of the present teaching.

In one embodiment, as shown in FIG. 43, an OFF time is input by the user at S710. In one embodiment, The OFF time is the time when the specific device 7120 is turned off. Under this circumstance, the method further may include the following S760 and S770.

At S760, whether the system time of the end device has reached the OFF time input by the user can be determined. The process goes to S770 if the system time of the end device has reached the OFF time. At S770, a third command is remotely sent by the end device to the specific device 7120 to turn off the specific device 7120 at the OFF time.

When the specific device 7120 is a television, the user may input “8:00 am” as the OFF time, for example, to turn off the television at the OFF time automatically and to remind him/her to go to work. The user can set the OFF time at any time, according to one embodiment of the present teaching.

As shown in FIG. 43, inputting information of the ON time and the first mode, the SWITCH time and the second mode, and the OFF time is all performed at S710. However, it can be understood by a person skilled in the art that such description is for illustrative purpose only and does not intend to limit the scope of the present teaching. It can be understood that the information can be input by the user at any time, as long as the operations S720-S730, the operations S740-S750, the operations S760-S770, or any combination thereof are selectively performed based on information input by the user.

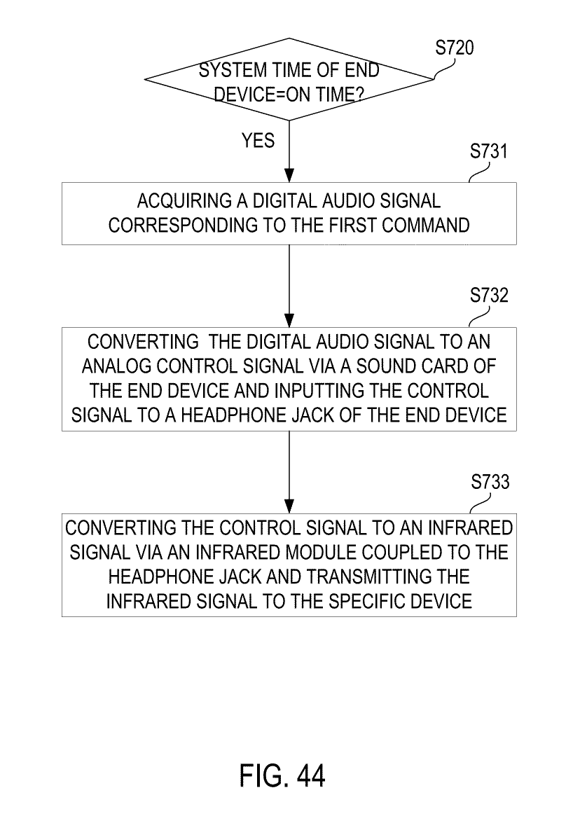

FIG. 44 is a flowchart illustrating examples of operations by an end device for sending a command to the specific device 7120, in accordance with an embodiment of the present teaching. Operations labeled the same as in FIG. 43 operate similarly. Although specific operations are disclosed in FIG. 44, such operations are examples. That is, the present teaching is well suited to performing various other operations or variations of the operations recited in FIG. 44.

For the controlling method according to one embodiment of the present teaching, the end device includes an audio channel such as a headphone jack, and the audio channel can be used for transmitting the command to the specific device 7120.

The S730 shown in FIG. 43 of sending the first command will be taken as an example to explain in detail how the command is remotely sent to the specific device 7120 via the audio channel of the end device, e.g., the audio channel 7112 shown in FIG. 40. As shown in FIG. 44, the S730 includes the following S731, S732 and S733.

At S731, a digital audio signal corresponding to the first command is acquired. At S732, the digital audio signal is converted to an analog control signal via a sound card of the end device, e.g., the sound card 7234 shown in FIG. 42, and the control signal is input to the headphone jack of the end device, e.g., the headphone jack 7238 shown in FIG. 42. At S733, the control signal is converted to an infrared signal via an infrared module coupled to the headphone jack, e.g., the infrared module 7111 or 7236, and the infrared signal is transmitted to the specific device 7120.

For the operation S731, in one embodiment, the digital signal is stored in a built-in memory of the end device, and is acquired by accessing the built-in memory. In another embodiment, the digital audio signal is stored in a specific server, and is acquired by communicating network with the server.

Since the audio channel and the sound card of the end device are utilized, the controlling method according to an embodiment of the present teaching can effectively reduce the cost of implementing the remote controlling of the specific device 7120 by the end device.

FIG. 45 illustrates a diagram of a hardware structure of an information processing device, in accordance with an embodiment of the present teaching. The hardware in FIG. 45 operates as a computer. However, it is understood by a person skilled in the art that such description is for illustrative purpose only and does not intend to limit the scope of the present teaching. It is understood that the information processing device is not limited to a computer, and can be other devices, especially portable electronic devices such as a mobile phone or a panel computer having the function of calculating and processing. Since the principle is similar, the description corresponding to these devices is skipped.

In FIG. 45, a central processing unit (CPU) 7601 performs multiple processing according to programs stored in a read-only memory (ROM) 7602, or according to programs loaded from a memory module 7608 to a random-access memory (RAM) 7603. The RAM 7603 further stores data needed when the CPU 7601 performs multiple processing. The CPU 7601, the ROM 7602, and the RAM 7603 are coupled together via a bus 7604. An input/output interface 7605 is also coupled to the bus 7604.

In one embodiment, an input module 7606, an output module 7607, the memory module 7608, and a communication module 7609 are also coupled to the input/output interface 7605. In one embodiment, the input module 7606 includes, but not limited to, a keyboard and a mouse. The output module 7607 includes, but not limited to, a display such as a cathode ray tube (CRT), a liquid crystal display (LCD), and a speaker. The memory module 7608 includes but not limited to a hard disk. The communication module 7609 includes, but not limited to, a network interface card such as a local area network (LAN) card and a modulator-demodulator. The communication module 7609 performs communication processing via the network, e.g., Internet. In one embodiment, a driver 7610 is further coupled to the input/output interface 7605. A removable medium 7611, such as a magnetic disk, a compact disk, a magneto-optical disk and a semiconductor memory, can be installed on the driver 7610, in one embodiment, such that the programs read from the removable medium 7611 are installed in the memory module 7608.

When realizing the processing by software, the software programs can be installed from network such as Internet, or from memory medium such as the removable medium 7611.

However, it is understood by a person skilled in the art that the memory medium is not limited to the removable medium 7611 which stores programs and provides the user with programs separately from the device, as shown in FIG. 45. The removable medium 7611 includes, but not limited to, a magnetic disk (a floppy disk included), a compact disk (a compact disk read-only memory (CD-ROM) and a digital versatile disk (DVD) included), a magneto-optical disk (mini disk (MD) included), and a semiconductor memory. Alternatively, the memory medium includes hard disks in the ROM 7602 and the memory module 7608 in which programs are stored and provided to the user together with the device.

Furthermore, a program product which stores machine-accessible command codes is provided according to one embodiment of the present teaching. When the command codes are read and performed by the machine, the controlling method according to one embodiment of the present teaching (or part of it) is performed. Multiple memory mediums such as magnetic disks, compact disks, magneto-optical disks, and semiconductor memories used for loading the program product is also within the scope of the present teaching.

Some embodiments according to the present teaching provide apparatus and methods for a user to remotely control a device. In one embodiment, the device is a television, and one or more programs are recommended to the user such that the user does not need to memorize information associated with the programs that the user is likely interested in (e.g., times and channels of the programs).

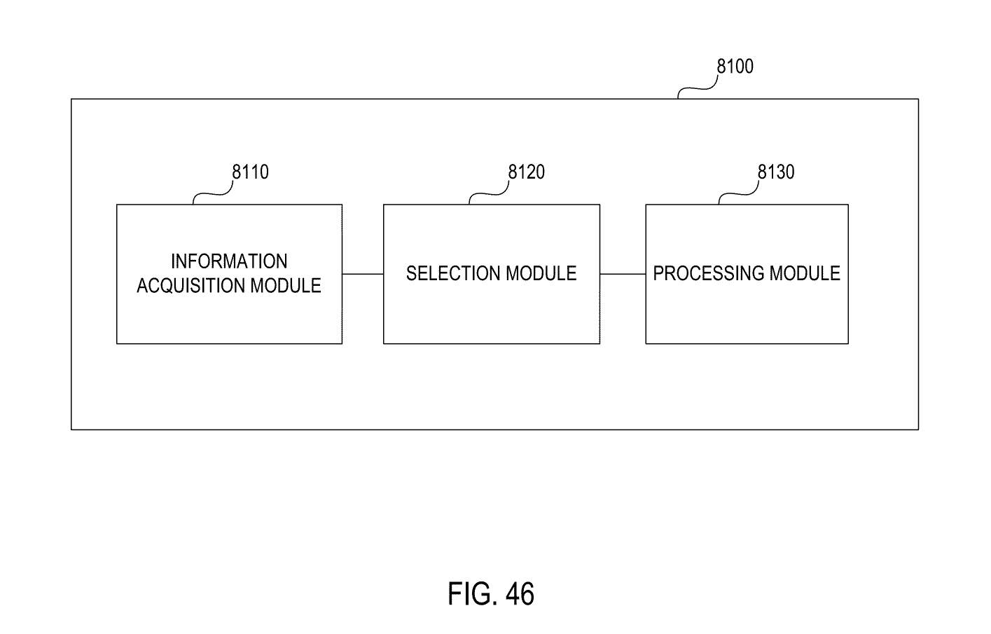

FIG. 46 illustrates a block diagram of a timing control device 8100, in accordance with an embodiment of the present teaching. As shown in FIG. 46, the timing control device 8100 includes an information acquisition module 8110, a selection module 8120 and a processing module 8130.

The information acquisition module 8110 is configured for receiving interest information which indicates preferred program contents of users. The information acquisition module 8110 is further configured for acquiring at least one program and associated TV channel as well as playing time of at least one program based on the received interest information. The selection module 8120 is configured for determining one or more programs among the at least one program which is acquired by the information acquisition module 8110 as selected programs to play. The processing module 8130 is configured for performing corresponding processes during each playing time of the selected programs.

For example, the interest information may be inputted by a user or may be received from other external devices. The timing control device 8100 may be integrated in equipment such as a mobile phone, a notebook computer or a tablet computer. The interest information can be images and texts inputted via buttons, a touch screen or a mouse, or audio information inputted via microphone integrated in the equipment. Alternatively, the interest information may be a combination of images, texts and/or audio information. In addition, the interest information may be program name or information which contains one or more key words or key phrases such as “Olympic Games,” “weather forecast,” “dating show” or “XX team; XX team; football game.”

The information acquisition module 8110 may acquire at least one program and associated TV channels and playing time of the at least one program through internet. For example, the information acquisition module 8110 may access websites which contain schedules of TV programs and acquire at least one program which is related to the received interest information and further obtain associated TV channel and playing time of the at least one program. The playing time of a program at least includes the beginning time of the program and optionally includes ending time or duration of the program. In addition, the information acquisition module 8110 may optionally obtain latest audience rating or online score of the at least one program through internet.

For example, if the interest information inputted by the user is “weather forecast”, the information acquisition module 8110 accesses a website and acquires following program information: “program name: A1; TV channel: B1; playing time: 17:30˜17:40”, “program name: A2; TV channel: B2; playing time: 19:30˜19:40”, “program name: A3; TV channel: B3; playing time: 22:00˜22:15”. Then the information acquisition module 8110 transmits the acquired program information to a display module to show to the user. Alternatively, the information acquisition module 8110 may reserve the program information for following processes by other components without transmitting it to the display module.

For example, the selection module 8120 receives instructions from the user and determines one or more programs as selected programs based on the received instructions. For example, if the timing control device 8100 is integrated in a mobile phone, the program information of the at least one program acquired by the information acquisition module 8110 may be displayed on the screen of the mobile phone. The user can choose one or more programs that he/she is interested in. The selection module 8120 can determine those one or more programs as selected programs to play based on the instructions from the user.

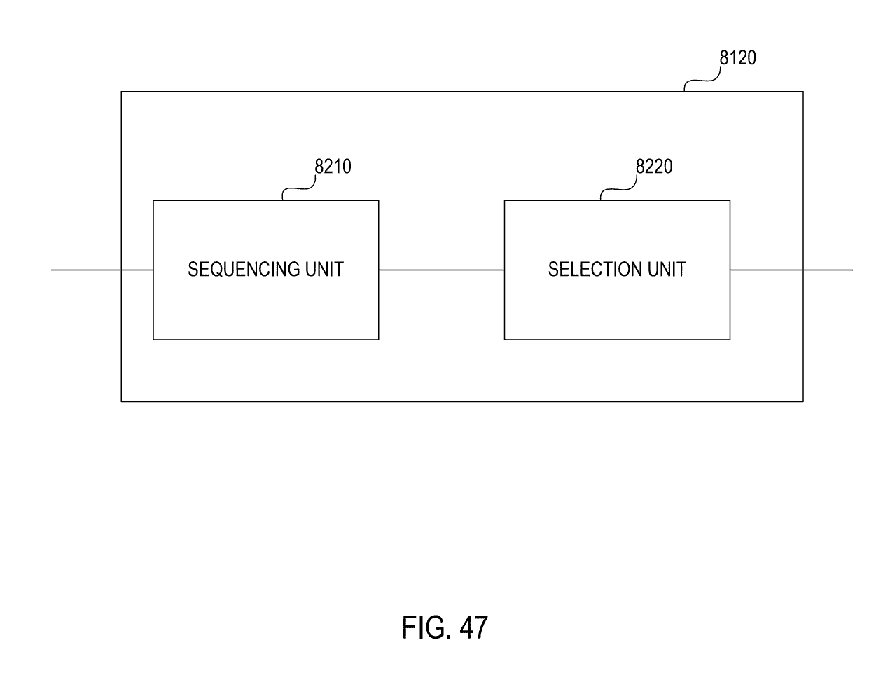

FIG. 47 illustrates en exemplary block diagram of a selection module 8120 in FIG. 46, in accordance with an embodiment of the present teaching. As shown in FIG. 47, the selection module 8120 includes a sequencing unit 8210 and a selection unit 8220.

The sequencing unit 8210 is configured for sequencing the at least one program acquired by the information acquisition module 8110. To be specific, for example, the sequencing unit 8210 can determine a sequence of the at least one program based on similarity between received interest information and relevant program information. The similarity is referred to as a first piece of information. The relevant program information may include information of the program name, playing time, associated TV channel, brief descriptions, and online tags of a program. The relevant program information may further include key words abstracted from the above information. The sequencing unit 8210 computes the similarity between the interest information and the relevant program information of each of the at least one program, e.g., by computing the similarity between a character string composed of the relevant program information and a character string composed of the interest information. Then the sequencing unit 8210 determines a sequence of the at least one program by the first piece of information (e.g., similarity in a descending order).

For another example, the sequencing unit 8210 can determine a sequence of the at least one program based on latest audience rating and/or online score of each of the at least one program. The latest audience rating and/or online score of each program are referred to as a second piece of information. In an embodiment, the sequencing unit 8210 can assign weights for the latest audience and the online score. In this embodiment, the sequencing unit 8210 can determine a sequence of the programs with the consideration of both the latest audience rating and the online score of each program. The latest audience rating and online score of each program can be acquired either by the information acquisition module 8110 or by the sequencing unit 8210.

In another example, the sequencing unit 8210 can determine a sequence of the at least one program based on historic playing times of the at least one program. The historic playing times of each of the at least one program is referred to as a third piece of information. The playing times of each program may be associated with the identity of a current user. For example, the sequencing unit 8210 records the playing history of the current user, calculates a total playing times of each program and determines a sequence of the programs by the total playing times of each program, e.g., in a descending order.

In yet another example, the sequencing unit 8210 can determine a sequence of the at least one program based on a difference between playing time of a program and watching time predetermined by a user, e.g., in an ascending order. The difference is referred to as a fourth piece of information. The difference may be measured between a beginning time of a program and a beginning watching time predetermined by the user, or between an ending time of a program and an ending watching time predetermined by the user, or between a duration of a program and a duration of the watching time predetermined by the user. The difference may be measured based on an overlapping time of the program and the watching time predetermined by the user.

In addition, the sequencing unit 8210 may determine a sequence of the at least one program based on two or more pieces of information. For example, the sequencing unit 8210 can determine a sequence of the at least one program based on both the first piece of information and the second piece of information.

After the sequencing unit 8210 determines the sequence of the at least one program, the selection unit 8220 selects a predetermined number of programs (e.g., top 10 programs in the sequence) as selected programs to play. Then the processing module 8130 performs corresponding processes during playing time of each selected program.

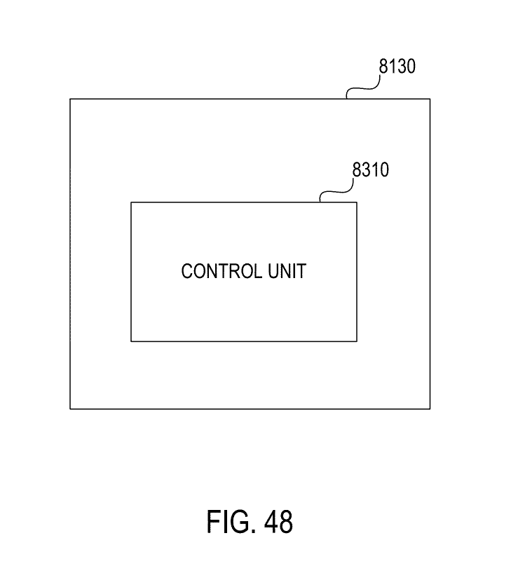

FIG. 48 illustrates an exemplary block diagram of a processing module 8130 in FIG. 46, in accordance with an embodiment of the present teaching. As shown in FIG. 48, the processing module 8130 includes a control unit 8310. The control unit 8310 is configured for performing a playing-control process that includes controlling a television to switch to a corresponding TV channel and playing a selected program during playing time of the selected program. For example, if the beginning time of a selected program is reached, the control unit 8310 turns on the television and switches to the corresponding TV channel automatically without extra instructions or confirmations of a user. In the following descriptions, two kinds of televisions will be taken as examples to illustrate the corresponding processes of the processing module 8130.

If the television is a smart TV with an operating system that can communicate with other devices or if the television is equipped with a set top box (STB) that can communicate with other devices, when it reaches the beginning time of a selected program, the processing module 8130 turns on the television by transmitting a control instruction to the smart TV or to the STB of the television (e.g., via Wi-Fi) and switches to the TV channel in which the selected is played.

If the television is not a smart TV and is not equipped with a STB, a signal transceiving device can be installed near the television, e.g., an infrared transceiving device. The infrared transceiving device can be made at a low cost and may look like a charger of a mobile phone. The transceiving device can communicate with the television via Wi-Fi, infrared signals, or via wired connection if a television has a communication port. If the beginning time of a selected program is reached, the processing module 8130 turns on the television by transmitting a control instruction to the signal transceiving device and switches to the TV channel in which the selected program is played.

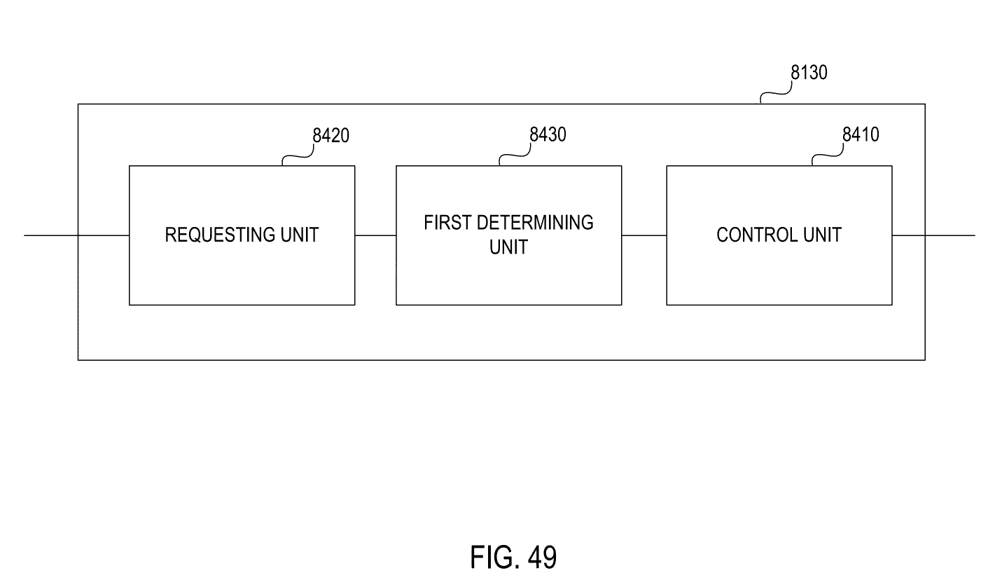

FIG. 49 illustrates an exemplary block diagram of a processing module 8130 in FIG. 46, in accordance with an embodiment of the present teaching. As shown in FIG. 49, the processing module 8130 includes a control unit 8410, a requesting unit 8420 and a first determining unit 8430. The control unit 8410 is configured for performing a playing-control process includes controlling a television to switch to a TV channel and playing a selected program during playing time of the selected program. Compared to the control unit 8310 in FIG. 48, the control unit 8410 needs a confirmation of a user to perform the playing-control process.

If it reaches the beginning time of a selected program, the requesting unit 8420 generates a request for playing the selected program. To be specific, if the timing control device 8100 is integrated in equipment such as a mobile phone, the requesting unit 8420 may transmit the request to a display module to show the request on the screen of the mobile phone. After receiving such request, the user may choose either to confirm or to cancel the playing. Such request may be displayed on the screen of the mobile phone once at a predetermined time before the beginning time of the selected program, e.g., 10 minutes before the beginning time of the selected program. Alternatively, the request may be displayed every 10 minutes during a predetermined time period before the beginning time of the selected program, e.g., 1 hour before the beginning time of the selected program.

If an instruction for confirmation of playing is received in a predetermined time, the first determining unit 8430 causes the control unit 8410 to perform the playing-control process. As a result, the control unit 8410 may be configured to control a television to switch to a TV channel that is associated with a selected program during the playing time of the selected program, to play the selected program. If an instruction for cancellation of playing is received in the predetermined time, the first determining unit 8430 stops the control unit 8410 from performing the playing-control process. If no instruction (neither an instruction for confirmation nor an instruction for cancellation) is received in the predetermined time, the first determining unit 8430 may still stop the control unit 8410 from performing the playing-control process.

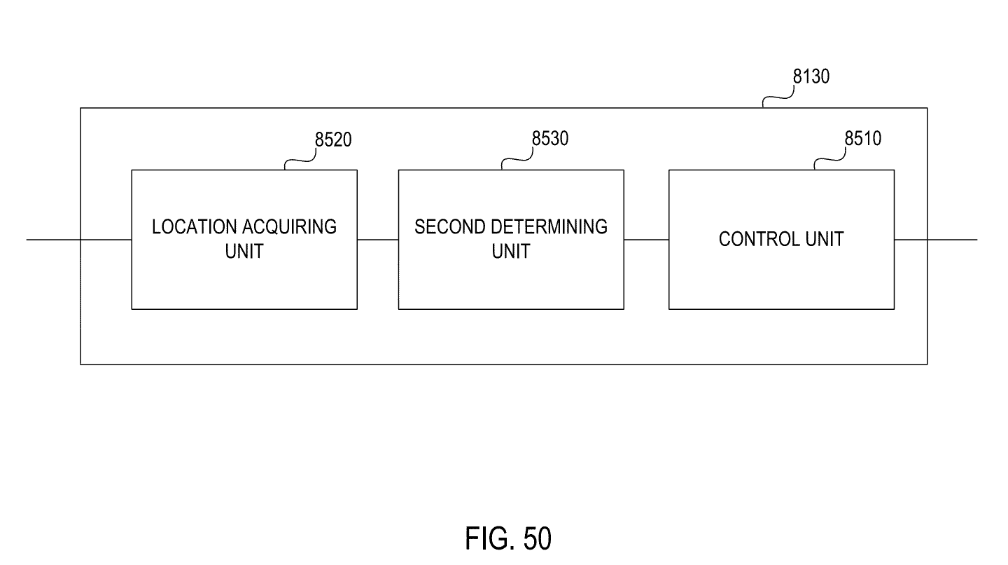

FIG. 50 illustrates an exemplary block diagram of a processing module 8130 in FIG. 46, in accordance with an embodiment of the present teaching. As shown in FIG. 50, the processing module 8130 includes a control unit 8510, a location acquisition unit 8520 and a second determining unit 8530. The control unit 8510 is configured for performing a playing-control process that includes controlling a television to play in a TV channel and playing a selected program during playing time of the selected program. Compared to the control unit 8310 in FIG. 48, the control unit 8510 needs extra requirements to perform the playing-control process.

The location acquisition unit 8520 is configured for acquiring a current location of the timing control device 8100. In one embodiment, the location acquisition unit 8520 may be a Global Positioning System (GPS) receiver. Alternatively, if the timing control device 8100 is integrated in a device such as a mobile phone, the location acquisition unit 8520 may acquire the location of the timing control device 8100 (also the location of the mobile phone) by built-in locating module of the mobile phone.

After locating the timing control device 8100, the second determining unit 8530 determines whether the timing control device 8100 locates within a predetermined area. For example, the predetermined area may be an area with the television at the center. If the timing control device 8100 is within the predetermined area, the second determining unit 8530 may cause the control unit 8510 to perform the playing-control process. It means that the control unit 8510 is configured to control a television to switch to a TV channel which is associated with a selected program during the playing time of the selected program and to play the selected program. If the timing control device 8100 is outside the predetermined area, the second determining unit 8530 may stop the control unit 8510 from performing the playing-control process.

It is understood that the desire of a user to watch a television program may be relatively low if the user is not near the television when the program is playing. Thus, with the processing module 8130 in FIG. 50, the television may be controlled to play only when timing control device 8100 is in a predetermined area near the television.

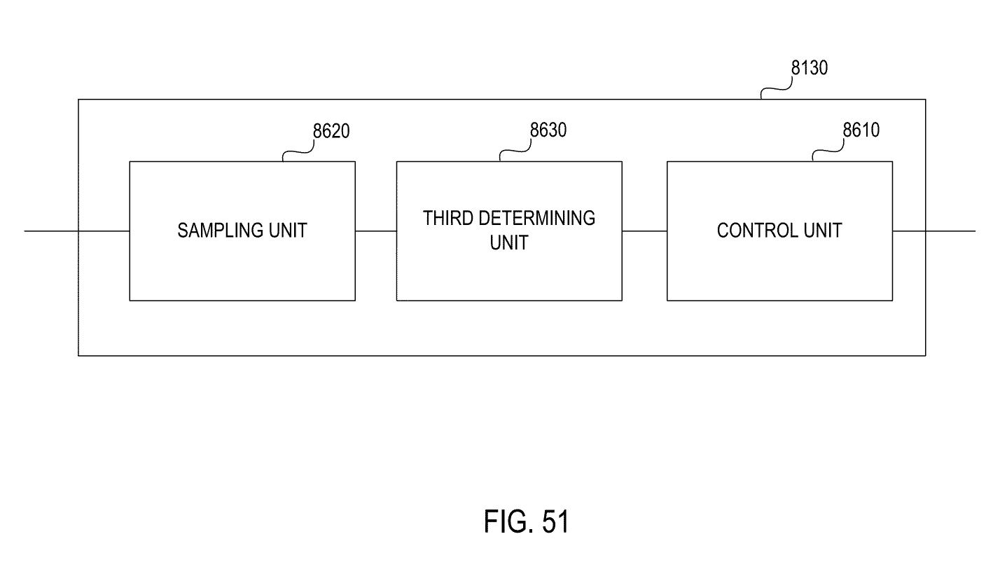

FIG. 51 illustrates an exemplary block diagram of a processing module 8130 in FIG. 46, in accordance with an embodiment of the present teaching. As shown in FIG. 51, the processing module 8130 includes a control unit 8610, a sampling unit 8620 and a third determining unit 8630. The control unit 8610 is configured for performing a playing-control process that includes controlling a television to play in a TV channel and playing a selected program during playing time of the selected program. Compared to the control unit 8510 in FIG. 50, the control unit 8610 needs different requirements to perform the playing-control process.

The sampling unit 8620 is configured for acquiring personal information of audiences during a predetermined time period before the beginning of a selected program. The third determining unit 8630 is configured for calculating similarity of the acquired personal information of each audience with stored sample information and for determining whether the similarity is greater than a threshold. If the similarity is greater than the threshold, the third determining unit 8630 causes the control unit 8610 to perform the playing-control process. If the similarity is less than the threshold, the third determining unit 8630 stops the control unit 8610 from performing the playing-control process. Some examples are given below for illustrations of the function of the sampling unit 8620.

For one example, the sampling unit 8620 may obtain personal information at a predetermined time before the beginning time of a selected program, e.g., one minute before the beginning time of the selected program. The third determining unit 8630 then compares the personal information of audiences with the stored sample information to determine whether the television is allowed to play program.

In another example, a signal transceiving device, e.g., an infrared transceiving device, may be installed near the television. The signal transceiving device can obtain the status of the television, e.g., power on/off. If the television is turned on, for example, by a family member, the signal transceiving device coupled to the television may detect the event that the television is turned on. Then the signal transceiving device transmits signals to the timing control device 8100 to inform the timing control device 8100 of this event. After receiving the signals, the timing control device 8100 may further determine whether the television is allowed to turn on at this time. For example, the sampling unit 8620 in the timing control device 8100 may acquire personal information of audiences. The third determining unit 8630 then compares the acquired personal information of audiences with the stored sample information to make a determination that whether the television is allowed to play programs.

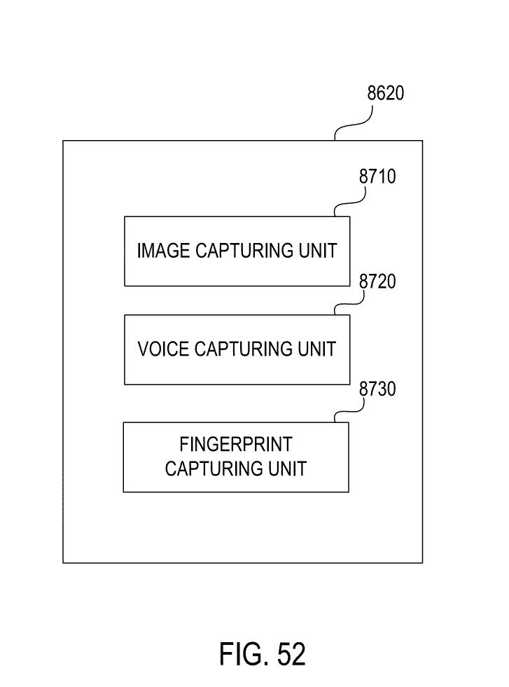

FIG. 52 illustrates an exemplary block diagram of a sampling unit 8620 in FIG. 51, in accordance with an embodiment of the present teaching. The sampling unit 8620 may be, but not limited to, an image capturing unit 8710, a voice capturing unit 8720 or a fingerprint capturing unit 8730. Alternatively, the sampling unit 8620 may be a combination of above two or more units.

For example, the sampling unit 8620 may include the image capturing unit 8710. The image capturing unit 8710 is configured for capturing images of audiences in a predetermined area in front of the television (e.g., a rectangular area in front of the television). The stored sample information may include users' pictures. The third determining unit 8630 compares images acquired by the image capturing unit 8710 and the stored users' pictures to determine whether the audience is allowed to watch television. If the similarity between the acquired image and the stored users' pictures is greater than a first threshold (e.g., 80 percent), it can be determined that the user is allowed to watch television. The third determining unit 8630 enables the control unit 8610 to send out a signal to the signal transceiving device which indicates that the television is allowed to play the program. Otherwise, if the similarity is less than the first threshold, the third determining unit 8630 stops the control unit 8610 from performing the playing-control process, and it can be determined that the television is not allowed to play the program.

The stored users' pictures may be body pictures or facial images of users. If the stored users' pictures are body pictures, the sampling unit 8620 may extract the body image of each audience from the acquired pictures directly and compare the extracted body image with the stored users' pictures. If the stored users' pictures are facial images, the sampling unit 8620 may perform face recognition process by extracting the facial image of each audience from the acquired images and comparing the facial image of each audience with the stored users' pictures.

In another example, the sampling unit 8620 includes the voice capturing unit 8720. The voice capturing unit 8720 is configured for capturing voice of the audiences as personal information of audiences. The stored sample information may include previously recorded voice information of users. For example, the voice capturing unit 8720 captures voice of the audiences during a predetermine time and performs voice signal processing such as filtering. The third determining unit 8630 then compares filtered voice signal with the stored voice information of audiences. If similarity between the filtered voice signal and the stored voice information is greater than a second threshold (e.g., 80 percent), the third determining unit 8630 is configured for allowing the television to play program. Otherwise, the third determining unit 8630 may stop the control unit 8610 from performing the playing-control process, and it can be determined that the television is not allowed to play the program.

In yet another example, the sampling unit 8620 includes the fingerprint capturing unit 8730. The fingerprint capturing unit 8730 is configured for acquiring fingerprints of audiences as personal information of audiences. The stored sample information may include previously recorded fingerprints of users. The third determining unit 8730 compares the acquired fingerprints with the stored fingerprints. If similarity between the acquired fingerprints and the stored fingerprints is greater than a third threshold (e.g., 90 percent), the third determining unit 8630 is configured for allowing the television to play the program. Otherwise, the television may be stopped from playing the program by the third determining unit 8630.

In one example, a child is allowed by the parents to only watch a program broadcasted on channel P from 15:30 to 16:30, and the parents cannot come back home before 16:30. In such case, the sampling unit 8620 takes pictures in front of the television, for example, at 15:29 and extracts facial images from the pictures. The third determining unit 8630 then compares the facial image with stored users' pictures, which include pictures of the child. If the similarity between the facial image and the stored users' pictures is greater than a threshold, e.g., 80 percent, it may indicate that the child is sitting in front of the television. The third determining unit 8630 then determines that the child is allowed to watch the television now and thus, controls the control unit 8610 to turn on the television and to switch to channel P at 15:30. The operations are similar if the sampling unit 8620 is implemented as the voice capturing unit 8720 or fingerprint capturing unit 8730.

The signal transceiving device near the television is configured for detecting the event that the television is turned on by a child at a time not within the time period from 15:30 to 16:30. The signal transceiving device then sends a message indicating that the television has been turned on to the timing control device 8100 (e.g., in the mobile phone of the parents). Alternatively, the timing control device 8100 may request the signal transceiving device to update the status of the television periodically. For example, the timing control device 8100 sends an inquiry to the signal transceiving device for checking the status of the television. The signal transceiving device then detects the status of the television after receiving the inquiry and reply with a message indicating the status of the television to the timing control device 8100. The parents can choose either to confirm the playing of the program or forbid the playing after receiving the message. For example, if the child is allowed to watch television only from 15:30 to 16:30, after receiving the message, the parents can forbid the playing of the television through the control unit 8610 in the timing control device 8100, which may be integrated in their mobile phones. Accordingly, parents can monitor and control the programs their children watch on television through the signal transceiving device.

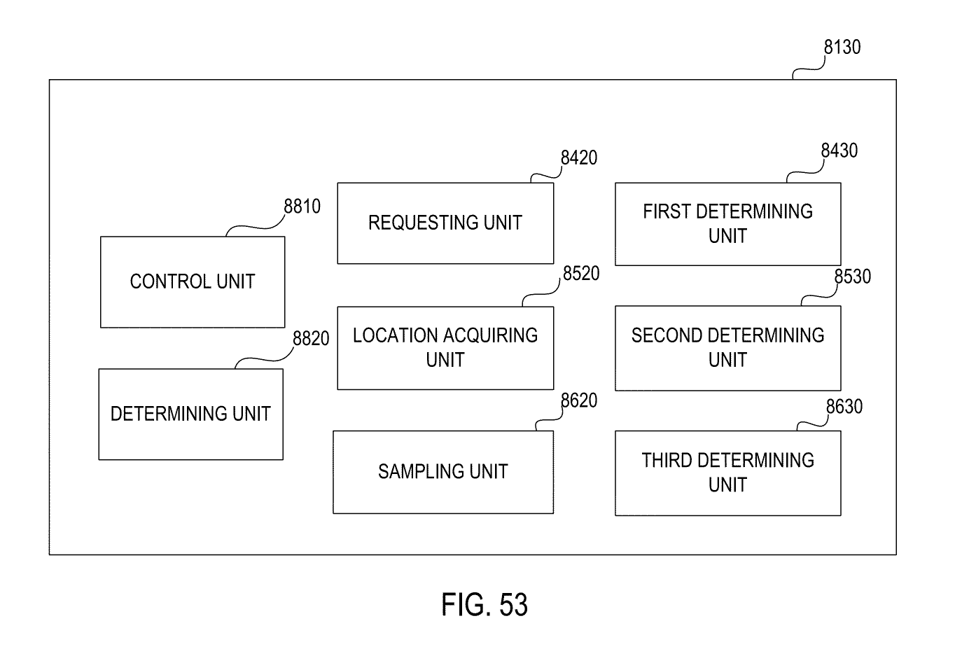

FIG. 53 illustrates an exemplary block diagram of a processing module 8130 in FIG. 46, in accordance with an embodiment of the present teaching. As shown in FIG. 53, the processing module 8130 includes a control unit 8810 and a determining unit 8820. The control unit 8810 is configured for controlling a television to switch to a TV channel and playing a selected program during playing time of the selected program. Compared to the control unit 8310 in FIG. 48, the control unit 8810 needs a confirmation from the determining unit 8820 to perform the playing-control process.

If there are at least two selected programs playing at a same moment, the determining unit 8820 can determine one selected program to play. The control unit 8810 then switches to the associated TV channel of the selected program to play at that moment.

In one example, two selected programs playing at the same time are two programs having the same beginning times. For example, there are two selected programs which begin at 20:00. Alternatively, two selected programs playing at the same time are two programs having playing times that overlap with each other. For example, the playing time of one selected program is from 19:00 to 20:00, while the playing time of another selected program is from 19:15 to 20:00. In such case, there are two selected programs playing at 19:15.

The determining unit 8820 may determine one selected program to play based on at least one of the following information: the first piece of information (the similarity between received interest information and relevant information of a program), the second piece of information (the latest audience rating and/or online score of a program), the third piece of information (the historic playing times of a program), the fourth piece of information (the difference between playing time of a program and watching time predetermined by a user) and priority levels of users associated with programs. The determination process performed by the determining unit 8820 may be similar to that performed by the sequencing unit 8210. The determining unit 8820 may determine a sequence of the at least two programs which play at the same time based on one or more pieces of information and select the top one to play. The user associated with a program may be the user whose interest information is received by the acquisition module 8110 and serves as key words for acquiring the program.

For example, there may be multiple users sitting in front of a television and each audience is equipped with a timing control device (e.g., equipped with a mobile phone in which the timing control device 8100 is embedded). Each user may be given a priority level in advance. The priority level of the mobile phone of each user is set correspondingly to the priority level of the audience. If the time of playing program P1 selected by a user A is overlapped with the time of playing program P2 selected by a user B, the determining unit 8820 determines to play program P1 if the user A is given a higher priority.

In addition, the processing module 8130 may optionally include a requesting unit 8420 and a first determining unit 8430 as shown in FIG. 49, a location acquisition unit 8520 and a second determining unit 8530 as shown in FIG. 50, or a sampling unit 8620 and a third determining unit 8630 as shown in FIG. 51.

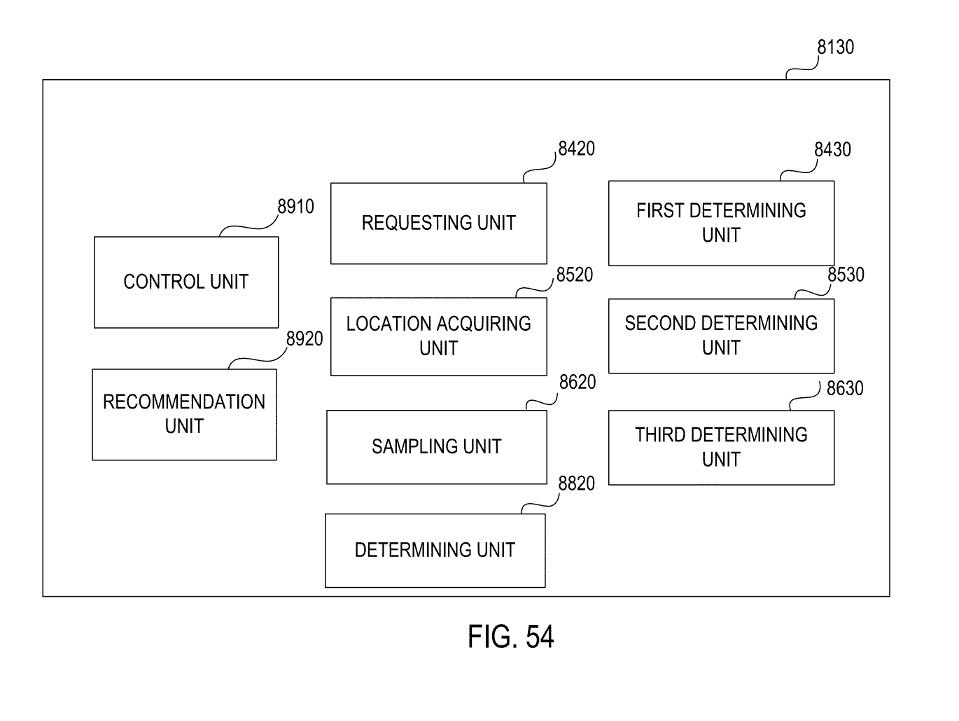

FIG. 54 illustrates an exemplary block diagram of a processing module 8130 in FIG. 46, in accordance with an embodiment of the present teaching. As shown in FIG. 54, the processing module 8130 includes a control unit 8910 and a recommendation unit 8920. The control unit 8910 is configured for performing a playing-control process that includes controlling a television to switch to a TV channel and playing a selected program. Compared to the control unit 8310 in FIG. 48, in addition to the selected programs determined by the selection module 8120, the control unit 8910 may be further configured for controlling the television to play recommended programs determined by the recommendation unit 8920.

The recommendation unit 8920 is configured for determining recommended programs based on historic playing times of each program and generating a request to play before each recommended program. The historic playing times of each program may indicate the preferences of a user. Thus with the consideration of the playing times of each program, the recommendation unit 8920 may recommend some programs which the user is likely interested in. The historic playing times of each program may be acquired in a way similar to the process performed by the sequencing unit 8120. For example, the recommendation unit 8920 may determine a predetermined number of programs (e.g., top 3 programs which are played most frequently by the user) as recommended programs and show them to the user, e.g., by displaying the recommended programs on the screen of a mobile phone. The user may be offered, per the request generated by the recommendation unit 8920, to choose one or more of the recommended programs to play. Then the control unit 8910 plays the selected recommended programs. The user may choose not to play any of the recommended programs. Alternatively, the recommendation unit 8920 may request the user to confirm whether each of the recommended programs shall be played.

In addition, the processing module 8130 may optionally include a requesting unit 8420 and a first determining unit 8430 as shown in FIG. 49, a location acquisition unit 8520 and a second determining unit 8530 as shown in FIG. 50, a sampling unit 8620 and a third determining unit 8630 as shown in FIG. 51 or a determining unit 8820 as shown in FIG. 53.

Accordingly, the timing control device 8100 of the present teaching can receive interest information from users or other devices and acquire programs which the users may be interested in based on the received interest information. After determining one or more programs to play, the timing control device 8100 may perform corresponding processes when each selected program is playing. With the timing control device described in the present teaching, users no longer need to memorize all the playing time and associated TV channels of their favorite programs.

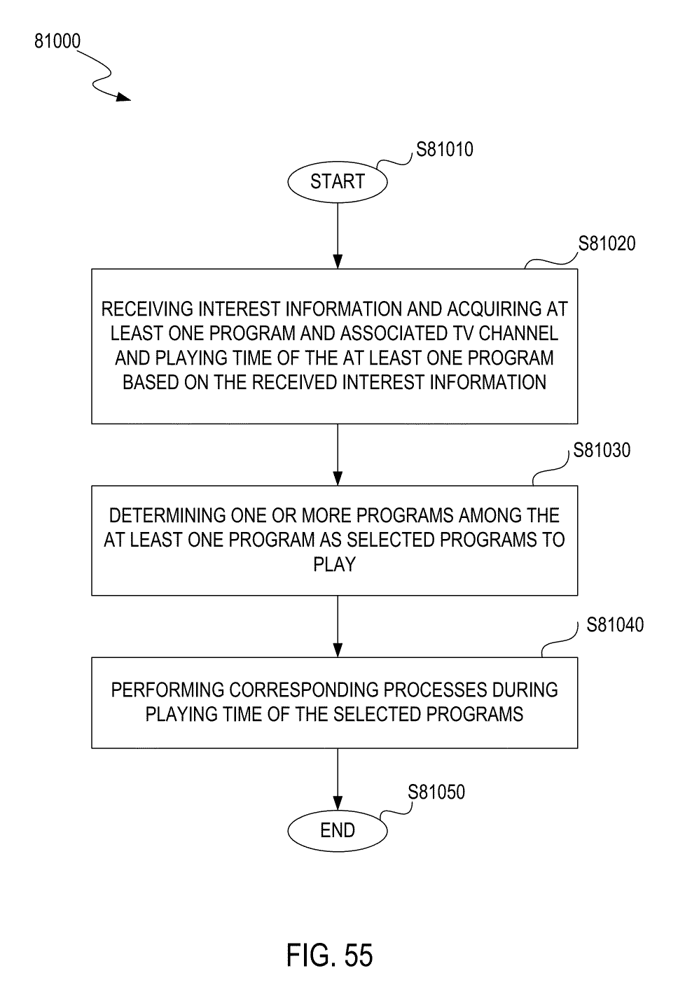

FIG. 55 is a flowchart illustrating a method for timing control, in accordance an embodiment of the present teaching. As shown in FIG. 55, the process begins from S81010, and then goes to S81020. At S81020, interest information is received from users or other devices, for example, by an information acquisition module 8110. At least one program and associated TV channels as well as playing time of the at least one program may be acquired based on the received interest information by the information acquisition module 8110. At S81030, one or more programs are determined as the selected programs to play, for example, by a selection module 8120. The determination may be made based on instructions received from a user. At S81040, corresponding processes are performed during playing time of each selected program, for example, by a processing module 8130.

In one example, the corresponding processes may be the processes described in FIG. 48 and performed by the processing module 8130, which includes a control module 8310. In another example, the corresponding processes may be the processes described in FIG. 49 and performed by the processing module 8130, which includes a control unit 8410, a requesting unit 8420 and a first determining unit 8430. In another example, the corresponding processes may be the processes described in FIG. 50 and performed by the processing module 8130, which includes a control unit 8510, a location acquisition unit 8520 and a second determining unit 8530.

In another example, the corresponding processes may be the processes described in FIG. 51 and performed by the processing module 8130, which includes a control unit 8610, a sampling unit 8620 and a third determining unit 8630.

In another example, the corresponding processes may be the processes described in FIG. 53 and performed by the processing module 8130, which includes a control unit 8810 and a determining unit 8820. In yet another example, the corresponding processes may be the processes described in FIG. 54 and performed by the processing module 8130, which includes a control unit 8910 and a recommendation unit 8920. The process ends at S81050.

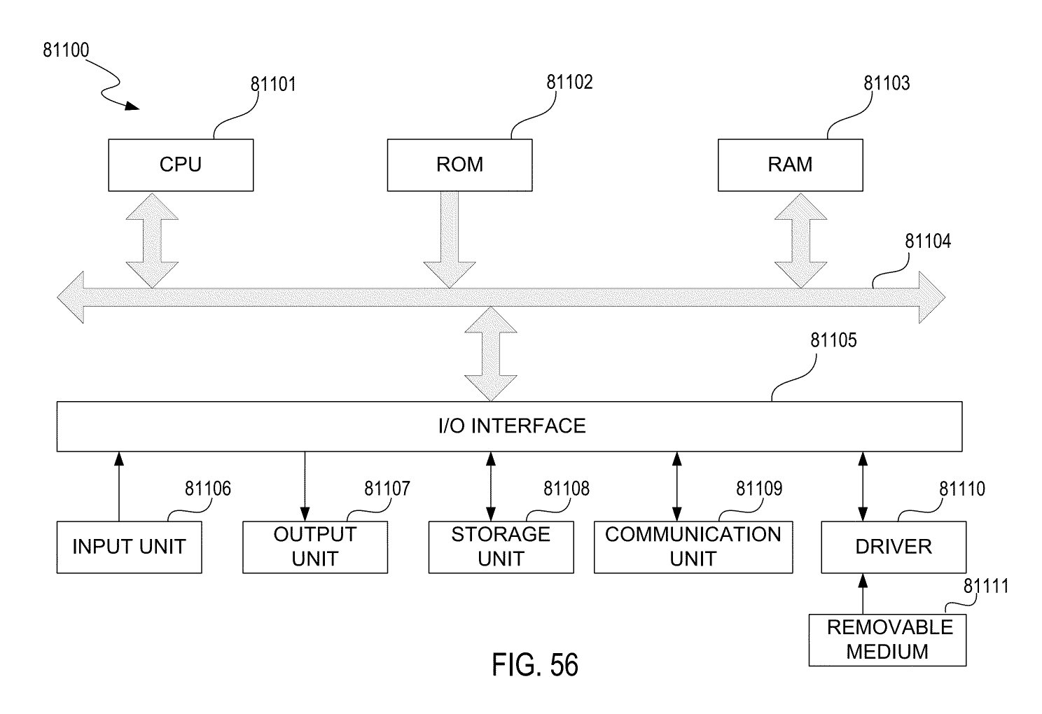

FIG. 56 depicts a general computer architecture 81100 on which the embodiments described herein can be implemented and has a functional block diagram illustration of a computer hardware platform which includes user interface elements. The computer may be a general purpose computer or a special purpose computer. Although only one such computer is shown, for convenience, the computer functions relating to remotely controlling of electronic devices may be implemented in a distributed fashion on a number of similar platforms, to distribute the processing load. However, it is understood by a person skilled in the art that such description is for illustrative purpose only and does not intend to limit the scope of the present teaching. It is understood that the information processing device is not limited to a computer, and can be other devices, such as a mobile phone or a tablet computer having the function of calculating and processing.

The computer 81100, for example, includes a communication unit 81109 (e.g., a local area network card or a modulator-demodulator) connected to and from a network connected thereto to facilitate data communications. The computer 81100 also includes a central processing unit (CPU) 81101, in the form of one or more processors, for executing program instructions. The exemplary computer platform includes an internal communication bus 81104, program storage and data storage of different forms, e.g., storage unit 81108, removable medium 81111 which is driven by a driver 81110, read only memory (ROM) 81102, or random access memory (RAM) 81103, for various data files to be processed and/or communicated by the computer, as well as possibly program instructions to be executed by the CPU. For example the removable medium 81111 can be a magnetic disc, an optical disc, a magneto optical disk, a semiconductor memory, etc. The computer 81100 also includes an I/O interface 81105, supporting input/output flows between the computer and other components therein such as an input unit 81106 (e.g., a keyboard or a mouse) and an output unit 81107 (e.g., a cathode-ray tube display, a liquid crystal display or a loudspeaker. The computer 81100 may also receive programming and data via network communications.

Moreover, a program product which stores machine-accessible command codes is provided according to one embodiment of the present teaching. When the command codes are read and performed by the machine, the controlling method according to one embodiment of the present teaching (or part of it) is performed. Multiple memory mediums such as magnetic discs, compact discs, magneto-optical discs, and semiconductor memories used for loading the program product is also within the scope of the present teaching.

Hence, aspects of the methods of remotely controlling electronic devices, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated schedules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a server or host computer into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media includes dynamic memory, such as a main memory of such a computer platform. Tangible transmission media includes coaxial cables, copper wire, and fiber optics, including wires that form a bus within a computer system. Carrier-wave transmission media can take the form of electric or electromagnetic signals, or acoustic or light waves such as those generated during radio frequency (RF) and infrared (IR) data communications. Common forms of machine-readable media therefore include for example: a floppy disk, a flexible disk, hard disk, magnetic take, any other magnetic medium, a CD-ROM, DVD or DVD-ROM, any other optical media, punch card paper tapes, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of machine readable media may be involved in carrying one or more sequences of one or more instructions to a processor for execution.

Those skilled in the art will recognize that the embodiments of the present teaching are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as firmware, a firmware/software combination, a firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. A method for remotely controlling a device, comprising:
receiving, at a portable device, a first input from a user specifying a first time and a first mode associated with the device; and
sending, remotely from the portable device, a first command to the device at the first time to activate the device in the first mode.

2. The method of claim 1, wherein the device includes one of a television, a DVD player, a set-top box, an air conditioner, and a projector.

3. The method of claim 2, wherein when the device is a television, the first mode is indicative of a channel associated with the television.

4. The method of claim 1, further comprising:
receiving, at the portable device, a second input from the user specifying a second time and a second mode associated with the device; and
sending, remotely from the portable device, a second command to the device at the second time.

5. The method of claim 4, wherein
the second time is later in time as compared with the first time; and
the second command controls the device to switch from the first mode to the second mode at the second time.

6. The method of claim 5, wherein when the device is a television, the second mode is indicative of a channel associated with the television.

7. The method of claim 1, further comprising:
receiving, at the portable device, a third input from the user specifying a third time; and
sending, remotely from the portable device, a third command to the device at the third time to deactivate the device.

8. The method of claim 1, 4, or 7, wherein the sending of the first, second, and third commands comprises:
converting the command into an infrared signal; and
transmitting the infrared signal to the device.

9. The method of claim 8, wherein the infrared signal is converted by:
generating a digital audio signal based on the command;
converting the digital audio signal to an analog control signal via a sound card of the portable device; and
obtaining the infrared signal by converting the analog control signal to the infrared signal via an infrared module coupled with a headphone jack of the portable device.

10. A portable device for remotely controlling a device, comprising:
a setting module configured to receive a first input from a user specifying a first time and a first mode associated with the device; and
a transmitting module coupled with the setting module and configured to send remotely a first command to the device at the first time to activate the device in the first mode.

11. The portable device of claim 10, wherein the device includes one of a television, a DVD player, a set-top box, an air conditioner, and a projector.

12. The portable device of claim 10, wherein when the device is a television, the first mode is indicative of a channel associated with the television.

13. The portable device of claim 10, wherein
the setting module is further configured to receive a second input from the user specifying a second time and a second mode associated with the device; and
the transmitting module is further configured to send remotely a second command to the device at the second time.

14. The portable device of claim 13, wherein
the second time is later in time as compared with the first time; and
the second command controls the device to switch from the first mode to the second mode at the second time.

15. The portable device of claim 14, wherein when the device is a television, the second mode is indicative of a channel associated with the television.

16. The portable device of claim 10, wherein
the setting module is further configured to receive a third input from the user specifying a third time; and
the transmitting module is further configured to send remotely a third command to the device at the third time to deactivate the device.

17. The portable device of claim 10, 13, or 16, wherein the transmitting module comprises an infrared module configured to:
convert the command into an infrared signal; and
transmit the infrared signal to the device.

18. The portable device of claim 17, wherein the transmitting module further comprises:
an acquiring module configured to generate a digital audio signal based on the command;
a sound card coupled with the acquiring module and configured to convert the digital audio signal to an analog control signal and provide the analog control signal to a headphone jack of the portable device; and
the infrared module coupled with the headphone jack and configured to obtain the infrared signal by converting the analog control signal to the infrared signal.

19. A machine-readable tangible and non-transitory medium having information for controlling a device, wherein the information, when read by a portable device, causes the portable device to perform the following:
receiving a first input from a user specifying a first time and a first mode associated with the device; and
sending remotely a first command to the device at the first time to activate the device in the first mode.

20. The medium of claim 19, wherein the device includes one of a television, a DVD player, a set-top box, an air conditioner, and a projector.

21. The medium of claim 20, wherein when the device is a television, the first mode is indicative of a channel associated with the television.

22. The medium of claim 19, further comprising:
receiving, at the portable device, a second input from the user specifying a second time and a second mode associated with the device; and
sending, remotely from the portable device, a second command to the device at the second time.

23. The medium of claim 22, wherein
the second time is later in time as compared with the first time; and
the second command controls the device to switch from the first mode to the second mode at the second time.

24. The medium of claim 23, wherein when the device is a television, the second mode is indicative of a channel associated with the television.

25. The medium of claim 19, further comprising:
receiving, at the portable device, a third input from the user specifying a third time; and
sending, remotely from the portable device, a third command to the device at the third time to deactivate the device.

26. The medium of claim 19, 22, or 25, wherein the sending of the first, second, and third commands comprises:
converting the command into an infrared signal; and
transmitting the infrared signal to the device.

27. The medium of claim 26, wherein the infrared signal is converted by:
generating a digital audio signal based on the command;
converting the digital audio signal to an analog control signal via a sound card of the portable device; and
obtaining the infrared signal by converting the analog control signal to the infrared signal via an infrared module coupled with a headphone jack of the portable device.
